(19) United States
(12) Patent Application Publication
(10) Pub. No.: US 2022/0268904 A1
(43) Pub. Date: Aug. 25, 2022

(54) STATE DETECTION DEVICE FOR LIDAR, LIDAR, AND STATE DETECTION METHOD

(71) Applicant: Hesai Technology Co., Ltd., Shanghai (CN)

(72) Inventors: Xin ZHAO, Shanghai (CN); Shaoqing XIANG, Shanghai (CN); Qingguo YU, Shanghai (CN); Yuntian BI, Shanghai (CN); Song YANG, Shanghai (CN); Liwei WANG, Shanghai (CN)

(21) Appl. No.: 17/738,236

(22) Filed: May 6, 2022

Related U.S. Application Data
(63) Continuation of application No. PCT/CN2020/084031, filed on Apr. 9, 2020.

(30) Foreign Application Priority Data
Nov. 7, 2019 (CN) 201911083826.8
Nov. 7, 2019 (CN) 201911084281.2
Nov. 7, 2019 (CN) 201911084360.3
Nov. 7, 2019 (CN) 201911084372.6
Nov. 15, 2019 (CN) 201911121480.6
Dec. 9, 2019 (CN) 201911250924.6

(51) Int. Cl. G01S 7/497; G01S 7/481; G01S 17/89; G01S 17/931

(52) U.S. Cl. CPC G01S 7/497; G01S 17/931; G01S 17/89; G01S 7/4814

(57) ABSTRACT

A state detection device for a LIDAR is provided. The state detection device includes: a fault diagnostic unit, configured to perform a fault diagnosis on a component of the LIDAR, and when a fault is diagnosed, output a fault diagnosis signal; and a diagnostic management unit, communicating with the fault diagnostic unit to receive the fault diagnosis signal, and configured to determine a state of the LIDAR according to the fault diagnosis signal. The present disclosure also provides a LIDAR and a state detection method for a LIDAR.

### CROSS-REFERENCE TO RELATED APPLICATIONS

This application is a continuation of International Patent Application No. PCT/CN2020/084031, filed on Apr. 9, 2020, which claims priority to and the benefit of Chinese Patent Application No. 201911250924.6, filed on Dec. 9, 2019, Chinese Patent Application No. 201911121480.6, filed on Nov. 15, 2019, Chinese Patent Application No. 201911084372.6, filed on Nov. 7, 2019, Chinese Patent Application No. 201911084360.3, filed on Nov. 7, 2019, Chinese Patent Application No. 201911084281.2, filed on Nov. 7, 2019, and Chinese Patent Application No. 201911083826.8, filed on Nov. 7, 2019, which are incorporated herein by reference in its entirety.

### TECHNICAL FIELD

Embodiments of the present disclosure relate to the field of optoelectronic technology, and particularly to a state detection device for a LIDAR, a LIDAR including the state detection device, and a state detection method for a LIDAR.

### BACKGROUND

LIDAR is a common term of active detection sensor devices by means of laser light. An operating principle of a LIDAR is generally described as follows: an emitter of the LIDAR emits a laser beam, and the laser beam returns to a laser receiver due to diffuse reflection after encountering an object, a radar module can calculate a distance between the emitter and the object by multiplying a time interval between emitting and receiving the signals and the speed of light and then dividing the product by 2. According to the number of laser beams emitted by the LIDAR, there are usually single-line LIDAR, 4-line LIDAR, 8/16/32/64-line LIDAR, etc. One or more laser beams are emitted at different angles in the vertical direction and scanned in the horizontal direction to realize the detection of a three-dimensional contour of a target area. Multiple measurement channels (lines) correspond to scanning planes with multiple tilt angles, so a greater number of laser beams emitted in the vertical field of view indicates a higher angular resolution in the vertical direction and a higher density of the laser point cloud.

An assembled LIDAR product includes optical, mechanical, and electronic components, as well as software algorithms. A fault may occur in any of these parts. When a fault occurs in a LIDAR, it is usually difficult to determine the cause of the fault. The cause may be a fault of a device itself (e.g., an electrical component burns out under high voltage), or a mismatch of devices (e.g., component a and component b deform at high temperature and can no longer be locked together). In the conventional technologies, the LIDAR is used as an eye for unmanned driving and a sensor for active real-time detection. If it cannot be detected and confirmed in time whether the LIDAR is faulty or is operating normally, the vehicle cannot be controlled to execute a corresponding driving operation to cope with the possible faulty or anomaly, resulting in many safety risks. In addition, after the LIDAR is found to be faulty, the LIDAR needs to be disassembled or inspected to check the possible causes of the fault one by one. The inspection process is, cumbersome, time-consuming and labor-intensive.

The content of the background section is merely technologies known to the inventors of the present disclosure, and does not necessarily represent conventional technologies in the field.

### SUMMARY

In view of at least one problem of the conventional technologies, the present disclosure provides a state detection device for a LIDAR, a LIDAR including the state detection device, and a state detection method for a LIDAR.

According to one aspect of the present disclosure, a state detection device for a LIDAR is provided, including:

a fault diagnostic unit, configured to perform a fault diagnosis on a component of the LIDAR, and when a fault is diagnosed, output a fault diagnosis signal; and

a diagnostic management unit, communicating with the fault diagnostic unit to receive the fault diagnosis signal, and configured to determine a state of the LIDAR according to the fault diagnosis signal.

According to one aspect of the present disclosure, the LIDAR includes an upper circuit board and a lower circuit board, and the fault diagnostic unit includes:

a first fault diagnostic unit, configured to perform a fault diagnosis on a component of the LIDAR installed on or connected to the upper circuit board, and when a fault is diagnosed, output a first fault diagnosis signal; and

a second fault diagnostic unit, configured to perform a fault diagnosis on a component of the LIDAR installed on or connected to the lower circuit board, and when a fault is diagnosed, output a second fault diagnosis signal; and

the diagnostic management unit communicates with the first fault diagnostic unit and the second fault diagnostic unit to receive the first fault diagnosis signal and the second fault diagnosis signal, and is configured to determine the state of the LIDAR according to the first fault diagnosis signal and the second fault diagnosis signal.

According to one aspect of the present disclosure, the LIDAR includes an emitting unit, a receiving unit, and a point cloud generating unit arranged on the upper circuit board, where the emitting unit is configured to emit a detection laser beam to outside of the LIDAR, the receiving unit is configured to receive an echo of the detection laser beam reflected on a target object and convert the echo into an electrical signal, and the point cloud generating unit is configured to generate point cloud data of the LIDAR based on the electrical signal; and where the diagnostic management unit is coupled to the point cloud generating unit, and is configured to receive point cloud data corresponding to the first fault diagnosis signal when the first fault diagnosis signal is received.

According to one aspect of the present disclosure, the LIDAR includes a motor, a power supply, an encoding device, and a communication component arranged on the lower circuit board, and the states of the LIDAR include: an initialization state, a normal state, a deterioration state, and a shutdown state,

where, in the initialization state, the LIDAR performs a self-diagnosis operation and a motor startup operation;

in the normal state, the first fault diagnostic unit and the second fault diagnostic unit perform periodic diagnosis;

in the deterioration state, the first fault diagnostic unit and the second fault diagnostic unit perform periodic diagnosis, and at least part of data of the LIDAR is recorded; and

in the shutdown state, the LIDAR is powered off, and at least part of data of the LIDAR is recorded.

According to one aspect of the present disclosure, the faults of the LIDAR include a pre-set first-tier fault and a pre-set second-tier fault, where, when the first fault diagnostic unit or the second fault diagnostic unit detects the first-tier fault, the diagnostic management unit switches the state of the LIDAR to the deterioration state; and when the first fault diagnostic unit or the second fault diagnostic unit detects the second-tier fault, the diagnostic management unit switches the state of the LIDAR to the shutdown state.

According to one aspect of the present disclosure, when the first fault diagnostic unit and the second fault diagnostic unit detect that no fault occurs in the deterioration state, the diagnostic management unit switches the state of the LIDAR from the deterioration state to the normal state.

According to one aspect of the present disclosure, the self-diagnosis operation includes: self-diagnosis of the power supply and a clock of the LIDAR; self-diagnosis of the upper circuit board and the lower circuit board; self-diagnosis of internal power supply; and self-diagnosis of the emitting unit and the receiving unit;

where, when the self-diagnosis operation is successful, the motor startup operation is performed; and

where, when the self-diagnosis operation in the initialization state is successful and the motor is successfully started, the diagnostic management unit switches the state of the LIDAR from the initialization state to the normal state;

when the self-diagnosis of the power supply and the clock fails or the self-diagnosis of the upper circuit board and the lower circuit board fails, the diagnostic management unit switches the state of the LIDAR from the initialization state to the shutdown state; and

when the motor startup operation fails, the diagnostic management unit switches the state of the LIDAR from the initialization state to the shutdown state.

According to one aspect of the present disclosure, the state detection device further includes a first buffer, a second buffer, and a fault memory, where the first fault diagnostic unit triggers to buffer fault data to the first buffer when a fault is diagnosed;

the second fault diagnostic unit triggers to buffer fault data to the second buffer when a fault is diagnosed; and

the fault memory is coupled to the first buffer and the second buffer, and is configured to receive the fault data.

According to one aspect of the present disclosure, the diagnostic management unit communicates with the fault memory, and is configured to output fault data stored in the fault memory according to an external request.

According to one aspect of the present disclosure, the state detection device further includes a point cloud diagnosis unit for determining reasonableness of the point cloud, the point cloud diagnosis unit being configured to receive the point cloud data and output determination information indicating whether the point cloud data is reasonable, where the diagnostic management unit communicates with the point cloud diagnosis unit and is configured to receive the determination information indicating whether the point cloud data is reasonable from the point cloud reasonableness diagnosis unit.

The present disclosure also relates to a LIDAR, including: the state detection device described above.

According to one aspect of the present disclosure, the LIDAR further includes an upper circuit board and a lower circuit board, where components of the LIDAR are respectively installed on or connected to the upper circuit board and the lower circuit board, and the upper circuit board and the lower circuit board are each implemented by a field-programmable gate array (FPGA) and/or a microcontroller.

The present disclosure also relates to a state detection method for a LIDAR, including:

performing, by a fault diagnostic unit, a fault diagnosis on a component of the LIDAR, and when a fault is diagnosed, outputting a fault diagnosis signal; and

receiving, by a diagnostic management unit, the fault diagnosis signal, and determining a state of the LIDAR according to the fault diagnosis signal.

According to one aspect of the present disclosure, the LIDAR includes an upper circuit board and a lower circuit board, and the fault diagnostic unit includes a first fault diagnostic unit and a second fault diagnostic unit; the step of performing, by a fault diagnostic unit, a fault diagnosis on a component of the LIDAR, and when a fault is diagnosed, outputting a fault diagnosis signal includes:

performing, by the first fault diagnostic unit, a fault diagnosis on a component of the LIDAR installed on or connected to the upper circuit board, and when a fault is diagnosed, outputting a first fault diagnosis signal; and

performing, by the second fault diagnostic unit, a fault diagnosis on a component of the LIDAR installed on or connected to the lower circuit board, and when a fault is diagnosed, outputting a second fault diagnosis signal; and

the step of receiving, by a diagnostic management unit, the fault diagnosis signal, and determining a state of the LIDAR according to the fault diagnosis signal includes: receiving, by the diagnostic management unit, the first fault diagnosis signal and the second fault diagnosis signal, and determining the state of the LIDAR according to the first fault diagnosis signal and the second fault diagnosis signal.

According to one aspect of the present disclosure, the LIDAR includes an emitting unit, a receiving unit, and a point cloud generating unit arranged on the upper circuit board, where the emitting unit is configured to emit a detection laser beam to outside of the LIDAR, the receiving unit is configured to receive an echo of the detection laser beam reflected on a target object and convert the echo into an electrical signal, and the point cloud generating unit is configured to generate point cloud data of the LIDAR based on the electrical signal; and the state detection method further includes: receiving point cloud data corresponding to the first fault diagnosis signal when the first fault diagnosis signal is received.

According to one aspect of the present disclosure, the LIDAR includes a motor, a power supply, an encoding device, and a communication component arranged on the lower circuit board, and the states of the LIDAR include: an initialization state, a normal state, a deterioration state, and a shutdown state, and the state detection method includes:

performing a self-diagnosis operation and a motor startup operation for the LIDAR in the initialization state;

performing, by the first fault diagnostic unit and the second fault diagnostic unit, periodic diagnosis in the normal state;

performing, by the first fault diagnostic unit and the second fault diagnostic unit, periodic diagnosis in the deterioration state, and recording at least part of data of the LIDAR; and

powering off the LIDAR in the shutdown state, and recording at least part of data of the LIDAR.

According to one aspect of the present disclosure, the faults of the LIDAR include a first-tier fault and a second-tier fault; and the state detection method further includes:

switching, by the diagnostic management unit, the state of the LIDAR to the deterioration state when the first fault diagnostic unit or the second fault diagnostic unit detects the first-tier fault; and

switching, by the diagnostic management unit, the state of the LIDAR to the shutdown state when the first fault diagnostic unit or the second fault diagnostic unit detects the second-tier fault.

According to one aspect of the present disclosure, the state detection method further includes: switching, by the diagnostic management unit, the state of the LIDAR from the deterioration state to the normal state when the first fault diagnostic unit and the second fault diagnostic unit detect that no fault occurs in the deterioration state.

According to one aspect of the present disclosure, the self-diagnosis operation includes: self-diagnosis of the power supply and a clock of the LIDAR; self-diagnosis of the upper circuit board and the lower circuit board; self-diagnosis of internal power supply; and self-diagnosis of the emitting unit and the receiving unit; where, when the self-diagnosis operation is successful, the motor startup operation is performed; and

where the state detection method further includes:

switching, by the diagnostic management unit, the state of the LIDAR from the initialization state to the normal state when the self-diagnosis operation in the initialization state is successful and the motor is successfully started;

switching, by the diagnostic management unit, the state of the LIDAR from the initialization state to the shutdown state when the self-diagnosis of the power supply and the clock fails or the self-diagnosis of the upper circuit board and the lower circuit board fails; and

switching, by the diagnostic management unit, the state of the LIDAR from the initialization state to the shutdown state when the motor startup operation fails.

According to one aspect of the present disclosure, the state detection method further includes: buffering fault data to the first buffer when the first fault diagnostic unit determines a fault;

buffering fault data to the second buffer when the second fault diagnostic unit determines a fault; and

receiving, by a fault memory, the fault data from the first buffer and the second buffer.

According to one aspect of the present disclosure, the state detection method further includes: outputting, by the diagnostic management unit, fault data stored in the fault memory when an external request is received.

According to one aspect of the present disclosure, the state detection method further includes: determining, by a point cloud reasonableness diagnosis unit, whether the point cloud data is reasonable and outputting determination information indicating whether the point cloud data is reasonable; and

receiving, by the diagnostic management unit, the determination information indicating whether the point cloud data is reasonable from the point cloud reasonableness diagnosis unit.

### BRIEF DESCRIPTION OF THE DRAWINGS

The drawings forming a part of the present disclosure are used to provide further understandings of the present disclosure, and the exemplary embodiments and description of the present disclosure are used to explain the present disclosure but do not constitute an improper limitation on the present disclosure. In the drawings,

FIG. 1A is a schematic diagram of a state detection device according to an embodiment of the present disclosure;

FIG. 1B is a schematic diagram of a state detection device according to an exemplary embodiment of the present disclosure;

FIG. 1C is a schematic diagram of a LIDAR according to an embodiment of the present disclosure, in which the state detection device shown in FIG. 1A is integrated;

FIG. 2A illustrates multiple states of a LIDAR according to an embodiment of the present disclosure;

FIG. 2B illustrates multiple states of a LIDAR according to an exemplary embodiment of the present disclosure;

FIG. 2C illustrates an operation mode of a power supply of a LIDAR when switched to shutdown according to an exemplary embodiment of the present disclosure;

FIG. 3 illustrates an initialization phase of a LIDAR according to an embodiment of the present disclosure;

FIG. 4 illustrates a mode of interaction between upper circuit board and the lower circuit board according to an embodiment of the present disclosure;

FIG. 5 is a schematic diagram of a LIDAR according to embodiment of the present disclosure;

FIG. 6 illustrates a state detection method according to an embodiment of the present disclosure;

FIG. 7 illustrates an example of a LIDAR;

FIG. 8 is a schematic structural diagram of interior of a LIDAR;

FIG. 9 is a schematic diagram of an emitting unit of a LIDAR according to an embodiment of the present disclosure;

FIG. 10 is a schematic diagram of a detection circuit according to an embodiment of the present disclosure;

FIG. 11 illustrates an arrangement mode of a photodetector according to another embodiment of the present disclosure;

FIG. 12 is a detection method of an emitting unit of a LIDAR according to an embodiment of the present disclosure;

FIG. 13 is a schematic diagram of an emitting end assembly of a LIDAR according to an embodiment of the present disclosure;

FIG. 14 is a schematic diagram of an exemplary circuit structure of an emitting end assembly of the LIDAR shown in FIG. 1;

FIG. 15 illustrates a fault diagnosis method according to an embodiment of the present disclosure;

FIGS. 16A-16E respectively illustrate pre-established waveforms for a range of faults according to an embodiment of the present disclosure;

FIG. 17 illustrates components of an emitting end of a LIDAR according to an embodiment of the present disclosure;

FIG. 18 illustrates a LIDAR according to an embodiment of the present disclosure;

FIG. 19 is an exploded view of a receiving unit of a LIDAR according to an embodiment of the present disclosure;

FIG. 20 is a schematic diagram of a light-emitting diode (LED) light source according to an embodiment of the present disclosure;

FIG. 21 is a schematic diagram of testing according to an embodiment of the present disclosure;

FIG. 22 illustrates a control method of a LIDAR according to an embodiment of the present disclosure;

FIG. 23 is a schematic diagram of a receiving end assembly of a LIDAR;

FIG. 24 illustrates a fault diagnosis method for a receiving end of a LIDAR according to an embodiment of the present disclosure;

FIG. 25 is a schematic diagram of testing according to an embodiment of the present disclosure;

FIG. 26 illustrates a waveform of a test signal and a waveform of an output signal according to an embodiment of the present disclosure;

FIG. 27 illustrates an embodiment of a receiving end of a LIDAR;

FIG. 28 illustrates a receiving end assembly of a LIDAR according to an embodiment of the present disclosure;

FIG. 29 illustrates a receiving end assembly of a LIDAR according to an embodiment of the present disclosure;

FIG. 30 illustrates a method for diagnosis of reasonableness of a point cloud for a LIDAR according to an embodiment of the present disclosure;

FIG. 31 illustrates a LIDAR according to an embodiment of the present disclosure;

FIG. 32 illustrates a power supply abnormality monitoring system for a LIDAR according to an embodiment of the present disclosure;

FIG. 33 illustrates a LIDAR system according to an embodiment of the present disclosure;

FIG. 34 illustrates a power supply abnormality monitoring method for a LIDAR according to an embodiment of the present disclosure;

FIG. 35 illustrates an encoder in the conventional technologies;

FIG. 36 is a schematic diagram of an encoder according to an embodiment of the present disclosure;

FIG. 37 is a schematic diagram of a pulse at a first zero-degree position;

FIG. 38 is a schematic diagram of a pulse at a second zero-degree position;

FIG. 39 is a schematic diagram of an encoder according to another embodiment of the present disclosure;

FIG. 40 is a schematic diagram of an optoelectronic encoder according to an embodiment of the present disclosure;

FIG. 41 is a schematic diagram of an optoelectronic encoder according to an embodiment of the present disclosure;

FIG. 42 is a schematic diagram of a LIDAR according to an embodiment of the present disclosure; and

FIG. 43 illustrates a method of angular orientation using an encoder of the present disclosure.

### DETAILED DESCRIPTION

Only some exemplary embodiments are briefly described below. As those skilled in the art can realize, the described embodiments may be modified in various different ways without departing from the spirit or the scope of the present disclosure. Therefore, the accompanying drawings and the description are to be considered as illustrative in nature but not restrictive.

In the description of the present disclosure, it is understood that orientation or position relationships indicated by terms such as “center”, “longitudinal”, “transverse”, “length”, “width”, “thickness”, “upper”, “lower”, “front”, “rear”, “left”, “right”, “vertical”, “horizontal”, “top”, “bottom”, “interior”, “exterior”, “clockwise”, and “counterclockwise” are based on orientation or position relationships shown in the accompanying drawings, are merely to facilitate the description of the present disclosure and simplify the description, instead of indicating or implying that the indicated apparatus or element needs to have particular orientations or be constructed and operated in particular orientations, and therefore cannot be construed as a limitation on the present disclosure. In addition, terms “first” and “second” are used merely for the purpose of description, and shall not be construed as indicating or implying relative importance or implying a quantity of indicated technical features. Thus, features defined by “first” and “second” may explicitly or implicitly include one or more of the features. In the description of the present disclosure, the meaning of “plurality” is two or more unless specifically defined otherwise.

In the descriptions of the present disclosure, it should be noted that, unless otherwise specified or defined, the terms such as “mount”, “connect”, and “connection” should be understood in a broad sense, for example, the connection may be a fixed connection, a detachable connection, or an integral connection; or the connection may be a mechanical connection, or may be an electrical connection or communication with each other; a direct connection, an indirect connection through an intermediate, or internal communication between two elements or an interaction relationship between two elements. The specific meanings of the above terms in the present disclosure may be understood according to specific circumstances for those ordinary skill in the art.

In the present disclosure, unless otherwise explicitly specified and defined, a first feature being “over” or “below” a second feature may mean that the first feature and the second feature are in direct contact, or the first feature and the second feature are not in direct contact but are in contact through another feature therebetween. In addition, that the first feature is “on”, “above”, or “over” the second feature includes that the first feature is right above and diagonally above the second feature or merely indicates that a level of the first feature is higher than that of the second feature. That the first feature is “below”, “under”, or “beneath” the second feature includes that the first feature is right below and diagonally below the second feature or merely indicates that a level of the first feature is lower than that of the second feature.

The following disclosure provides many different embodiments or examples for achieving different structures of the present disclosure. In order to simplify the disclosure of the present disclosure, components and settings of specific examples are described below. Certainly, they are merely examples, and are not intended to limit the present disclosure. In addition, the present disclosure may repeat reference numerals and/or reference letters in different examples. The repetition is for the purpose of simplification and clarity, but does not indicate a relationship between the various embodiments and/or settings discussed. In addition, the present disclosure provides examples of various specific processes and materials, but those of ordinary skill in the art may be aware of the application of other processes and/or use of other materials.

Preferred embodiments of the present disclosure are described below with reference to the drawings. It should be understood that the preferred embodiments described herein are merely used to illustrate and explain the present disclosure, and are not used to limit the present disclosure.

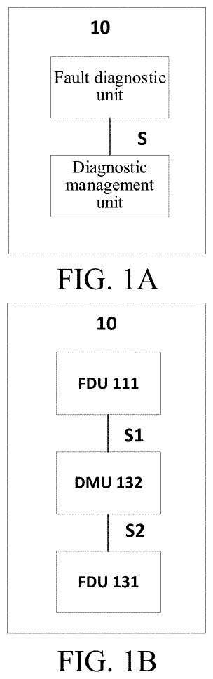

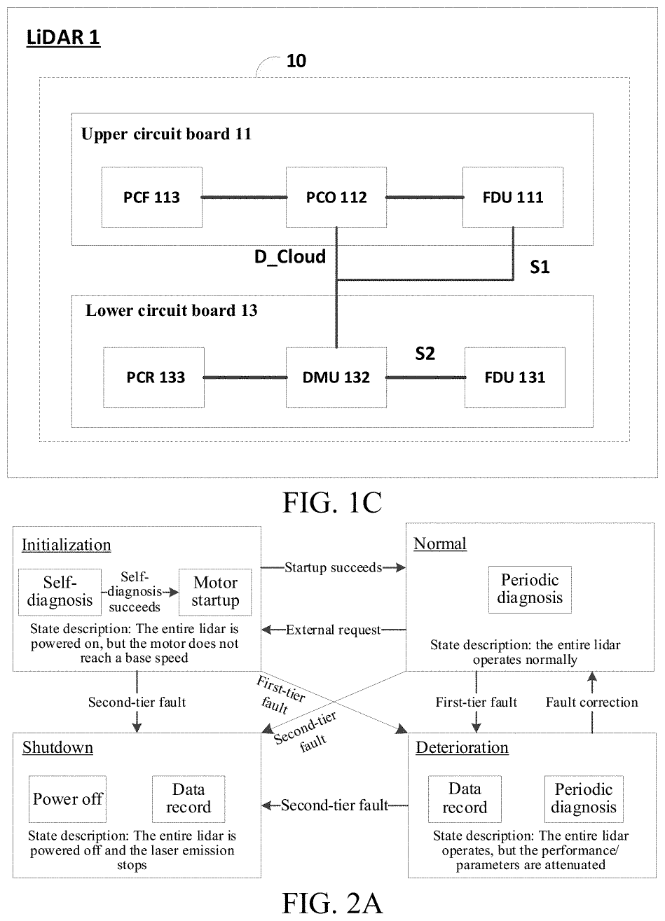

FIG. 1A illustrates a state detection device 10 for a LIDAR according to an embodiment of the present disclosure, including a fault diagnostic unit and a diagnostic management unit. The fault diagnostic unit is configured to perform a fault diagnosis on a component of the LIDAR, and output a fault diagnosis signal when the fault is determined. The diagnostic management unit communicates with the fault diagnostic unit to receive the fault diagnosis signal, and is configured to determine a state of the LIDAR according to the fault diagnosis signal. Components of the LIDAR include, but are not limited to, an emitting unit, a receiving unit, a point cloud generating unit, a motor, a power supply, an encoding device, a communication component, etc. of the LIDAR. The fault diagnostic unit may monitor states of one or more components, and when an anomaly is detected, output a diagnosis signal S to the diagnostic management unit, and the diagnostic management unit determines the state of the LIDAR according to the diagnosis signal S.

The LIDAR integrates a number of electronic, mechanical, and optical devices, which can be grouped, according to functionalities, into a power supply module, control units (e.g., an upper circuit board and a lower circuit board), the emitting unit, the receiving unit, a storage unit, a communication unit, etc. In the present disclosure, the fault diagnostic unit and the diagnostic management unit are additionally provided. Each functional module of the LIDAR may include, for example, a controller (e.g., an integrated circuit board) and a controlled device. The controlled device is controlled by the controller to execute a predetermined function. For one or more of the functional modules (or for each functional module), a corresponding fault diagnostic unit is respectively configured to perform a fault diagnosis of the functional module. Those skilled in the art can easily understand that the fault diagnostic unit may be separate from the controller, or may be integrated in the controller, as long as the preset diagnosis function can be achieved. By using such a systematic architecture, a corresponding fault diagnostic unit can be additionally included along with the addition of functional modules of LIDAR such that simultaneous expansions are achieved.

The fault detection device of the present disclosure may operate independently from other functional modules of the LIDAR, and the diagnosis timing and period of the fault detection device are determined according to a specific situation of an object being diagnosed. When the LIDAR starts, if the diagnosis system does not start normally, a corresponding indication signal may be output to a perception system in a timely manner. In addition, the state detection device of the present disclosure has universal applicability, and can be added to an existing LIDAR as an independent system.

FIGS. 1B and 1C illustrate a state detection device 10 according to an exemplary embodiment of the present disclosure. The state detection device 10 is installed in a LIDAR 1 for example, and is configured to detect an operating status of the LIDAR 1. A detailed description will be given below with reference to the accompanying drawings.

The LIDAR 1 includes an upper circuit board 11 and a lower circuit board 13. The upper circuit board 11 and the lower circuit board 13 may be circuit boards, for example. The upper circuit board 11 may be implemented by a field-programmable gate array (FPGA), and the lower circuit board 13 may be implemented partly by an FPGA and partly by a core of a central processing unit (CPU) (e.g., a microprocessor or microcontroller). Alternatively, the upper circuit board 11 and the lower circuit board 13 may also be implemented by a digital signal processor (DSP) or an FPGA with a CPU. As the brain of the LIDAR, the upper circuit board 11 and the lower circuit board 13 may be connected with a plurality of optical, electronic, and mechanical components of the LIDAR to provide corresponding circuit connection control and/or mechanical support. In a housing of the LIDAR, relatively speaking, the upper circuit board 11 may be installed above the lower circuit board 13. According to an embodiment of the present disclosure, the emitting unit, the receiving unit, and the point cloud generating unit of the LIDAR may be connected with the upper circuit board 11, for example, attached to an upper surface or a lower surface of the upper circuit board 11. The emitting unit includes one or more laser emitters, laser-driven circuits, and optical components such as lenses, and is configured to emit a detection laser beam to outside of the LIDAR. The receiving unit includes photodetectors such as an avalanche photodiode (APD), a silicon photomultiplier (SiPM), a single photon avalanche diode (SPAD), etc., and is configured to receive an echo of the detection laser beam reflected on a target object, and convert the echo into an electrical signal. The point cloud generating unit is configured to calculate a time of flight of the detection laser beam according to the electrical signal, obtain related information including a distance to the target object and a reflectivity of the target object, and generate point cloud data of the LIDAR. Details will be described below. The motor, the power supply, the encoding device, and the communication component of the LIDAR may be connected with the lower circuit board 13 of the LIDAR 1. Taking a mechanical LIDAR as an example, it usually includes a rotating platform for optical and mechanical components (where the emitting unit and the receiving unit are usually located in the rotating platform for optical and mechanical components to transmit the detection laser beam in different directions and receive the echoes). The motor provides power required for the rotation of the rotating platform for optical and mechanical components of the LIDAR, so that the rotating platform for optical and mechanical components can rotate at a preset rotational speed and a rotation frequency of, for example, 10 Hz or 20 Hz. The LIDAR usually is not equipped with an independent power supply therein, but obtains a power input from the outside, for example, from an in-vehicle power supply. The power supply module of the LIDAR usually includes a boost circuit and a power management module. The boost circuit is configured to boost an input voltage (usually 5 V or 15 V) to an operating voltage required by the LIDAR (e.g., 60 V). The power management module is configured to distribute power to the components of the LIDAR that need power. The encoding device and an encoder are usually used to encode and measure a rotation of the rotating platform for optical and mechanical components of the LIDAR, so as to obtain a rotational speed and a current angular orientation of the rotating platform for optical and mechanical components of the LIDAR. The communication component is configured for communication between a stationary part and a rotary part inside the LIDAR and communication between the LIDAR and an external perception system.

As shown in FIG. 1B, the state detection device 10 includes a first fault diagnostic unit (FDU) 111, a second FDU 131, and a diagnostic management unit (DMU) 132. The first FDU 111 is configured to perform a fault diagnosis on the components of the LIDAR 1 installed on or connected to the upper circuit board 11, and, output a first fault diagnosis signal S1 when a fault is determined. The second FDU 131 is configured to perform a fault diagnosis on a component of the LIDAR 1 installed on or connected to the lower circuit board 13, and output a second fault diagnosis signal S2 when a fault is determined. Those skilled in the art can easily understand that the first fault diagnosis signal S1 and the second fault diagnosis signal S2 may include information related to one or more of a fault type, a name or serial number of a faulty component, detailed fault information, etc. The DMU 132 communicates with the first FDU 111 and the second FDU 131 to receive the first fault diagnosis signal S1 and the second fault diagnosis signal S2, and is configured to determine the state of the LIDAR according to the first fault diagnosis signal S1 and the second fault diagnosis signal S2. In a concrete implementation, based on the consideration of engineering implementation, in order to transmit point cloud data with priority, after the first fault diagnosis signal S1 is generated, the first fault diagnosis signal S1 may be temporarily stored in a random access memory arranged on the upper circuit board 11, and transmitted to a random access memory of the lower circuit board 13 at a certain occasion through wireless communication; and after the second fault diagnosis signal S2 is generated, the second fault diagnosis signal S2 may be stored in a memory. For the LIDAR, an external perception system or diagnosis device may request all or part of fault data stored. Details will be described below.

According to an embodiment of the present disclosure, the DMU 132 is coupled to the point cloud generating unit (PCO) 112 and is configured to receive point cloud data (D_Cloud) corresponding to the first fault diagnosis signal when the first fault diagnosis signal S1 is received, that is, the point cloud data at the time of failure is transmitted to the diagnostic management unit. For example, when a fault occurs in one or two laser emitters or detectors, point cloud data corresponding to the laser emitter or detector is erroneous data, which may be removed later as required.

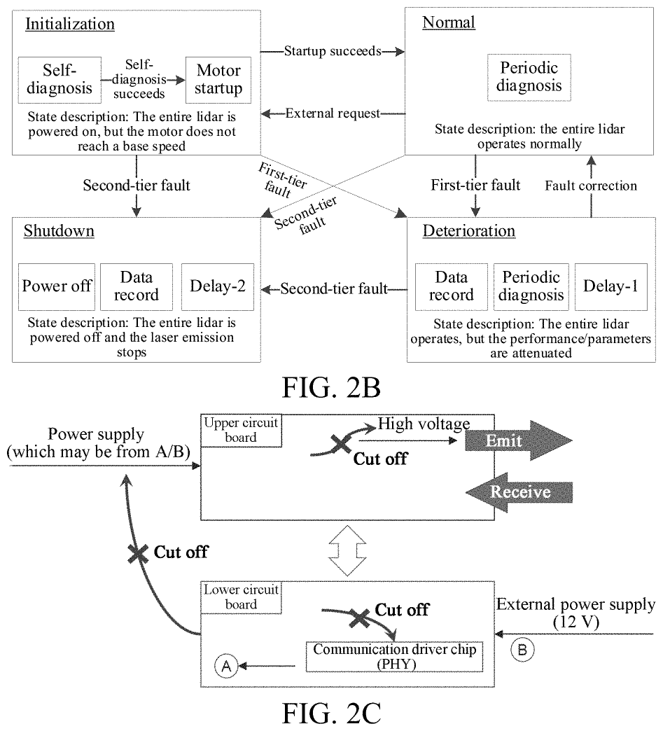

The diagnosis system of the present disclosure may perform corresponding detection on a radar system according to an operating status of the radar system. The content, method, parameters, and algorithm of diagnosis may be adjusted according to the operating status. According to an embodiment of the present disclosure, as shown in FIG. 2A, the states of the LIDAR include: an initialization state, a normal state, a deterioration state, and a shutdown state. In the initialization state, the LIDAR performs a self-diagnosis operation and a motor startup operation. Usually, the LIDAR is in an initialization phase when the LIDAR is just powered on and the motor has not reached a base speed (for example, one or more rotational speeds of the rotating platform for optical and mechanical components when the LIDAR is operating normally, which may be in units of frequency, such as 10 Hz or 20 Hz). Alternatively, in the normal operating process of the LIDAR, initialization may also be proactively triggered again, or according to an external request received, the LIDAR is caused to experience the initialization state again to perform the self-diagnosis operation and the motor startup operation. In addition, the self-diagnosis operation may be started or triggered in various ways. For example, the self-diagnosis operation may be triggered by an external (relative to the LIDAR itself) perception system. To be specific, the external perception system may send an external signal to request the LIDAR to perform the self-diagnosis operation. Additionally or alternatively, the self-diagnosis operation may be triggered internally (by the LIDAR itself), that is, the self-diagnosis operation is triggered when the LIDAR meets a certain condition (e.g., at intervals of a certain period of time or the LIDAR is in a certain operating status). Another example of the self-diagnosis operation is to conduct maintenance self-diagnosis, which is carried out using a diagnostic tool (device/program) in the after-sales service of the LIDAR. The content of the self-diagnosis detection may include, but is not limited to, one or a combination of more than one of the following diagnoses: emitting end fault diagnosis, receiving end fault diagnosis, diagnosis of voltage status (which may include high voltage and/or low voltage), diagnosis of communication status (including internal communication between the upper circuit board and the lower circuit board and/or communication between the LIDAR and the external perception system), diagnosis of clock status, determination of reasonableness of point cloud, diagnosis of abnormality of power supply, diagnosis of control chip, status diagnosis of the motor or other rotary parts, and fault diagnosis of optical/mechanical devices.

In addition, those skilled in the art can understand that the self-diagnosis operation may also be independent of the initialization state, and constitute a self-diagnosis state independently. In this case, the states of the LIDAR include: the initialization state, the self-diagnosis state, the normal state, the deterioration state, and the shutdown state.

The normal state indicates that the LIDAR is in a normal operating state, no fault of a component of the LIDAR is detected, and the LIDAR operates in a highest performance or preset performance mode. In the normal state, the first FDU 111 and the second FDU 131 may perform periodic fault detection on the components of the LIDAR. The periodic fault detection is a device state diagnosis operation performed at intervals of a fixed time period. In this case, the LIDAR is in the normal operating state, and the execution of the periodic fault detection operation does not affect the normal operation of the LIDAR, for example, does not affect the output of a point cloud of the LIDAR, the rotation of the motor, etc. Specifically, the content of the periodic fault detection may include, but is not limited to, one or a combination of more than one of the following diagnoses: emitting end fault diagnosis, receiving end fault diagnosis, diagnosis of voltage status (which may include high voltage and/or low voltage), diagnosis of communication status (including internal communication between the upper circuit board and the lower circuit board and/or communication between the LIDAR and the external perception system), diagnosis of clock status, determination of reasonableness of point cloud, diagnosis of abnormality of power supply, using an additionally provided LED to detect whether the photodetector operates normally, using an additionally provided photodetector to detect whether a laser emitter operates normally, diagnosis of control chip, status diagnosis of the motor or other rotary parts, and fault diagnosis of optical/mechanical devices.

The deterioration state generally indicates that the entire LIDAR may still be operating continuously, where some performance or parameters are worsened, but still within an acceptable range. In the deterioration state, the first FDU 111 and the second FDU 131 perform periodic fault detection on the LIDAR, and record at least part of data of the LIDAR. For example, a status of a faulty component may be continuously monitored and recorded. In the shutdown state, the LIDAR shall be powered off to stop operating, and at least part of data of the LIDAR is recorded. For example, when the LIDAR is shut down due to insufficient power supply or forced power off, information related to components that have suffered serious fault is recorded. In addition, preferably, as shown in FIG. 2B, a delay time of a certain time length is set before the LIDAR stops operating due to power off, as shown by Delay-2 in FIG. 2B. In this delay time, a corresponding operation is performed, for example, the vehicle may start other sensors such as a camera, or alert the operator that the LIDAR is about to be powered off and shut down, and require the operator to take over and control the vehicle in time. Likewise, a delay time of a certain time length may also be set before the LIDAR enters the deterioration state and operates with reduced performance or parameters, as shown by Delay-1 in FIG. 2B. In this delay time, a corresponding operation may be performed, for example, the vehicle may start other sensors such as a camera, or alert the operator that the LIDAR is about to enter the deterioration state, so that the operator may choose to take over and control the vehicle in time.

According to an exemplary embodiment of the present disclosure, the diagnosis system may classify commonly known faults of the LIDAR in advance, and divide the faults into first-tier faults and second-tier faults according to the severity and consequences, and may provide different responsive options for different types of faults. For example, for certain faults with a low degree of impact, when such a fault exists, the entire LIDAR can still operate, the performance/parameters are worsened to a certain extent, but such worsening is still within an acceptable range. Such faults may be classified as first-tier faults, and correspondingly, the LIDAR is in the deterioration state. According to a non-limiting embodiment of the present disclosure, the first-tier faults include, but are not limited to, the following types of faults. For a multi-line (e.g., 64-line) LIDAR, in a case that a small number of laser emitters and/or receivers cannot operate normally, for example, 4 laser emitters and/or receivers cannot operate normally, the remaining 60 laser emitters and receivers of the LIDAR can still operate normally, and the density and number of point clouds generated are decreased to a certain extent, which, however, is within an acceptable range. For certain faults with a high degree of impact, when such a fault occurs, either the LIDAR cannot operate, or the worsening of performance/parameters exceeds the acceptable range. Such faults may be classified as second-tier faults, and correspondingly, the LIDAR is in the shutdown state. When a second-tier fault occurs, the LIDAR needs to be powered off and shut down, and at the same time, related data when the fault occurs in the LIDAR is recorded. The related data includes but is not limited to the technical parameters of the LIDAR when the fault occurs. According to a non-limiting embodiment of the present disclosure, the second-tier fault is, for example, failure to start the motor during the initialization phase of the LIDAR (for example, the motor is not started at all, or the motor is started but the rotational speed of the motor does not reach the base speed), or that a considerable number of laser emitters and/or receivers (for example, 10, 20, or more laser emitters or receivers) in the multi-line LIDAR cannot operate normally, etc.

According to an embodiment of the present disclosure, the first FDU 111 may implement the following detection and diagnosis processes: emitting end fault diagnosis; receiving end fault diagnosis; using an additionally provided LED to inspect the photodetector; and using an additionally provided photodetector to detect inspect a light source. The second FDU 131 may implement the following detection and diagnosis processes: determination of reasonableness of point cloud; diagnosis of abnormality of power supply; and diagnosis of abnormality of motor abnormality. According to an exemplary embodiment of the present disclosure, the emitting unit and the receiving unit of the LIDAR are attached to the upper circuit board 11 or connected to the upper circuit board 11, so the first FDU 111 is configured to perform emitting end fault diagnosis, receiving end fault diagnosis, using an additionally provided LED to perform a photodetector diagnosis, and using an additionally provided photodetector to perform a light source diagnosis. The power supply of the LIDAR is attached to the lower circuit board 13 or connected to the lower circuit board 13, so the second FDU 131 is configured to perform diagnosis of abnormality of power supply and determination of reasonableness of point cloud. A detailed procedure of each diagnostic process will be described in detail below.

As shown in FIG. 2A, when the first FDU 111 or the second FDU 131 detects a first-tier fault, the DMU 132 switches the state of the LIDAR to the deterioration state; and when the first FDU 111 or the second FDU 131 detects a second-tier fault, the DMU 132 switches the state of the LIDAR to the shutdown state. According to an embodiment of the present disclosure, when switched to the shutdown state, a communication function between an upper circuit board and a lower circuit board of the LIDAR may be disabled, and/or the supply of power to laser emitters of the upper circuit board may be cut off. By cutting off the supply of power to the upper circuit board of the LIDAR, it can be ensured that the laser emitters stop emitting light, avoiding causing safety problems to human eyes. The supply of power to the upper circuit board may be directly from an external power supply or may be from a driver chip of the lower circuit board of the LIDAR, because when the power supply of the upper circuit board is cut off, a power supply link between the driver chip and the upper circuit board may be cut off, or an external power supply circuit may be cut off. The point cloud transmission can be stopped by disabling the communication function between the upper circuit board and the lower circuit board.

As shown in FIG. 2C, according to an embodiment of the present disclosure, when switched to the shutdown state, the supply of power to the communication driver chip is cut off to disable the communication function, and the supply of power to the upper circuit board is also cut off. The supply of power to the upper circuit board may be from the lower circuit board, or may be directly from an external power supply. By cutting off the supply of power to the upper circuit board, the supply of power to the laser emitters can be cut off, thereby ensuring that the laser emitters do not emit light to cause safety problems on human eyes.

According to an exemplary embodiment of the present disclosure, when the FDU 111 and the second FDU 131 detect that no fault occurs in the deterioration state, the DMU 132 switches the state of the LIDAR from the deterioration state back to the normal state. In some cases, the first FDU 111 and the second FDU 131 may mistakenly detect certain faults, or certain faults may be automatically eliminated after a period of time. Therefore, after a period of time, if no fault is detected, the state of the LIDAR may be switched back to the normal state. For example, when a detector of the LIDAR is detected to be unable to output a normal electrical signal, the state of the LIDAR may be switched to the deterioration state. In practice, there is such a possibility that the detector is not faulty but fails to output a normal signal due to ambient light. In the next detection period, the ambient light becomes normal, then the detector shows the ability to operate normally, and the faulty state is eliminated. In this case, the state of the LIDAR may be switched back to the normal state.

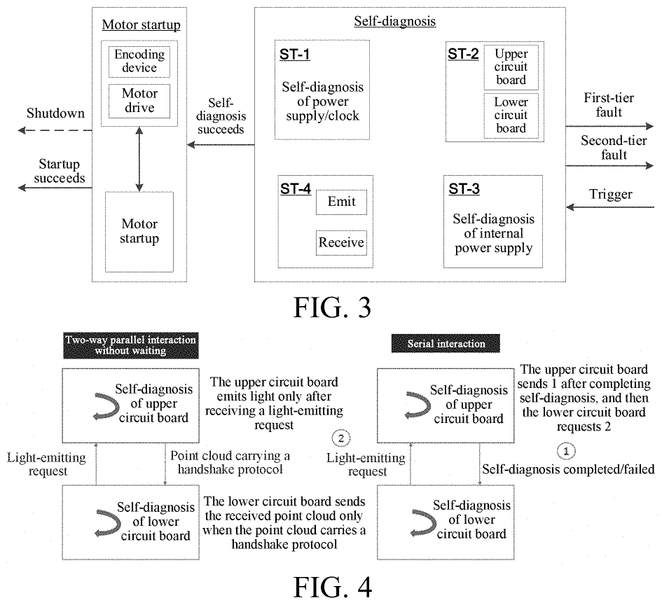

As shown in FIG. 3, according to an exemplary embodiment of the present disclosure, the self-diagnosis operation may include, but is not limited to: self-diagnosis of the power supply and a clock of the LIDAR; self-diagnosis of the upper circuit board and the lower circuit board; self-diagnosis of internal power supply; self-diagnosis of the emitting unit and the receiving unit; voltage diagnosis (including low voltage and high voltage); communication diagnosis (including internal communication and external communication); and diagnosis of control chip. The self-diagnosis of the power supply and the clock includes, for example, detecting whether the power supply module of the LIDAR can output a specified power supply and/or voltage and/or power, and whether a clock circuit can output a stable clock pulse. The self-diagnosis of the upper circuit board and the lower circuit board includes, for example, self-diagnosis of power supply statuses of circuit boards of the upper circuit board and the lower circuit board. The self-diagnosis of internal power supply includes detecting whether the power supply module of the LIDAR can supply power to various components inside the LIDAR, including but not limited to the laser emitters, the detectors, the motor, and laser-driven circuit modules. The self-diagnosis of the emitting unit and the receiving unit includes detecting whether the emitting unit such as the laser emitters and the receiving unit such as SiPM and Spad(s) can normally emit a detection laser beam and receive an echoed beam. A detailed description will be given below.

According to an exemplary embodiment of the present disclosure, the self-diagnosis operation may be performed in the following order: self-diagnosis of the power supply and a clock of the LIDAR (ST-1); self-diagnosis of the lower circuit board and the upper circuit board (ST-2); self-diagnosis of internal power supply (ST-3); and self-diagnosis of the emitting unit and the receiving unit (ST-4). Specifically, for the self-diagnosis operation, since the power supply and clock synchronization are prerequisites for orderly processing, in a first step, the self-diagnosis of the power supply/clock may be performed to determine whether the power supply is low or insufficient and whether the timing of the clock is consistent with an expectation. For example, assuming that an expected power supply voltage is 60 V, when a current power supply voltage is 50 V, it can be understood that the power supply voltage is low; when the current power supply voltage is 2 V or even 0 V, it can be understood that the power supply is insufficient. When the self-diagnosis of the power supply/clock in the first step is passed, a second step is performed, i.e., the self-diagnosis of the upper circuit board and the lower circuit board is performed. To be specific, since the lower circuit board is generally a circuit board connected to an external power supply and the lower circuit board affects the operation of the upper circuit board at least to a certain extent, the lower circuit board may be checked first. After it is determined that the lower circuit board operates normally, the upper circuit board is further checked. When it is determined that the upper circuit board operates normally, a third step may be performed. In the third step, the self-diagnosis of internal power supply is performed, to detect whether the supply of power by the upper circuit board and the lower circuit board to other components inside the LIDAR is normal. The components include but are not limited to the motor, a light source drive circuit, an echo processing circuit, etc. After it is determined that the result of the self-diagnosis in the third step is normal, a fourth step may be performed. In the fourth step, checking of functions of devices of the emitting end and devices of the receiving end is performed. In sequence, the checking of the devices of the emitting end may be performed first, followed by the checking of the devices of the receiving end. The devices of the emitting end include but are not limited to the light source and the light source drive circuit. The devices of the receiving end include, but are not limited to, photodetection devices such as an APD, an SPAD, or an SiPM, a device for processing an echo electrical signal, etc. Of course, the above sequence is only an example, but not a limitation. Those skilled in the art can adjust the steps specifically executed in the self-diagnosis operation as required in practice.

According to an implementation of the present disclosure, as shown in FIG. 4, bidirectional parallel interaction or serial interaction may be adopted between the upper circuit board and the lower circuit board of the LIDAR. The left side of FIG. 4 shows a bidirectional parallel interaction mode between the upper circuit board and the lower circuit board of the LIDAR. The upper circuit board and the lower circuit board perform self-diagnosis independently. After receiving a light-emitting request from the lower circuit board, the upper circuit board starts the self-diagnosis, and the laser emitters emit light and perform detect. After the self-diagnosis is complete, the upper circuit board does not need to report the result of the self-diagnosis to the lower circuit board. If the self-diagnosis is successful, the point cloud data (D_Cloud) sent by the upper circuit board to the lower circuit board carries a handshake protocol or data indicating a successful handshake. On the contrary, if the self-diagnosis fails or a fault occurs, the point cloud data sent by the upper circuit board to the lower circuit board does not carry a handshake protocol or carries data indicating a failed handshake. After receiving the point cloud data, the lower circuit board may determine that the point cloud data is erroneous when the point cloud data does not carry a handshake protocol or carries data indicating a failed handshake.

The right side of FIG. 4 shows a serial interaction mode between the upper circuit board and the lower circuit board of the LIDAR. After the self-diagnosis of the upper circuit board of the LIDAR is complete, the upper circuit board sends self-diagnosis determination information, including self-diagnosis success or failure information, to the lower circuit board. Only when the self-diagnosis is successful, the lower circuit board sends a light-emitting request to the upper circuit board, and the laser emitters of the upper circuit board emit light and perform detection.

As shown in FIG. 3, when the self-diagnosis operation is successful, the motor startup operation may be performed. The motor startup operation includes startup of a motor drive circuit, startup of the motor, and startup of the encoding device (and the encoder). During the startup process of the encoding device (and the encoder), a fault diagnosis is performed on the encoding device and the encoder by, for example, the second FDU 131. According to an embodiment of the present disclosure, a double-zero encoder is used in the LIDAR (see the description of “Fifth Aspect”). For the encoding device and the encoder, the diagnosis is performed according to pulse information. For example, the encoder is rotated at a certain angle, a detection pulse of the encoding device is output, and the detection pulse is compared with a preset template. If the detection pulse matches the preset template, it indicates that the encoding device and the encoder operate normally. Otherwise, it indicates that the encoding device and the encoder are abnormal. The checking of the encoding device (and the encoder) may be performed during the self-diagnosis process or the periodic diagnosis process of the LIDAR.

After the motor is started and reaches a preset rotational speed, the DMU 132 switches the state of the LIDAR 1 from the initialization state to the normal state. If the self-diagnosis operation and/or the motor startup operation fails, and the LIDAR cannot operate or the operational performance of the LIDAR is degraded to an unacceptable level (which is related to the current usage scenario, where the unacceptable level means that the current performance of the LIDAR affects the realization of the function of the current usage scenario, for example, the unacceptable level means that the current performance of the LIDAR applied to unmanned driving cannot assist to ensure safe unmanned driving, or the current performance of the LIDAR applied to a logistics trolley cannot support the correct delivery of goods to a shopper), the diagnostic management unit switches the state of the LIDAR from the initialization state to the shutdown state. If a fault occurring in the self-diagnosis operation is a first-tier fault, the diagnostic management unit switches the state of the LIDAR from the initialization state to the deterioration state. If a fault occurring in the self-diagnosis operation is a second-tier fault, the diagnostic management unit switches the state of the LIDAR from the initialization state to the shutdown state.

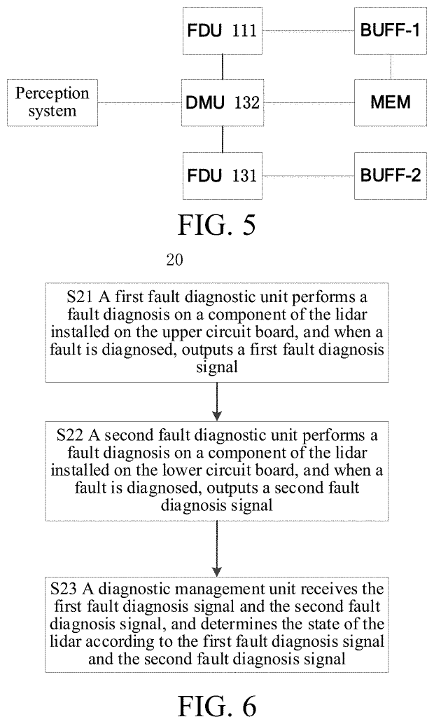

According to an exemplary embodiment of the present disclosure, as shown in FIG. 5, the state detection device 10 further includes a first buffer BUFF-1, a second buffer BUFF-2, and a fault memory MEM. The first FDU 111 triggers to buffer fault data to the first buffer BUFF-1 when a fault is determined. The second FDU 131 triggers to buffer fault data to the second buffer BUFF-2 when a fault is determined. The fault memory MEM is coupled to the first buffer BUFF-1 and is configured to receive the fault data. The DMU 132 may receive, from the second buffer BUFF-2, fault data stored in the second buffer BUFF-2 through the second fault diagnostic unit FDU 131, and optionally store the fault data in the fault memory MEM. In addition, optionally, the second buffer BUFF-2 may be coupled to the fault memory MEM, to directly send fault data stored therein to the fault memory MEM. The first buffer BUFF-1 and the second buffer BUFF-2 may be volatile memories, and are configured only to temporarily buffer fault data during the operation of the LIDAR. The fault memory MEM is a non-volatile memory. Fault data in the fault memory MEM is valid even in the case of power off. According to an embodiment of the present disclosure, the first buffer BUFF-1 is arranged on or connected with the upper circuit board 11, and the second buffer BUFF-2 and the fault memory MEM are arranged on or connected with the lower circuit board 13. The fault memory MEM may be various types of memories, including but not limited to an embedded multimedia card (EMMC) or an electrically erasable programmable read-only memory (EEPROM).

According to an exemplary embodiment of the present disclosure, the DMU 132 communicates with the fault memory MEM, and is configured to correspondingly output all or part of fault data stored in the fault memory MEM according to an external request. For example, when an external perception system of a vehicle sends a request to the DMU 132, the DMU 132 may retrieve part of the fault data and send part of the fault data to the external perception system. For example, when a radar failure analyst sends a request to the DMU 132, the DMU 132 may retrieve all the fault data and send all the fault data to the radar failure analyst.

In addition, when the DMU 132 learns that the LIDAR is faulty, the DMU 132 may proactively send the fault information to the perception system. For example, the fault information may be sent in the form of a fault message, or presented in the form of a fault. As described above, when a first-tier fault occurs, the DMU 132 switches the state of the LIDAR to the deterioration state, and when a second-tier fault is detected, the DMU 132 switches the state of the LIDAR to the shutdown state. Preferably, as shown in FIG. 2B, a certain delay time may be set before the above state switching is performed, as shown by Delay-1 and Delay-2 in FIG. 2B. The delay time may be sent to the perception system and presented to a user of the vehicle for processing as soon as possible to determine a subsequent vehicle operation. For example, the vehicle may choose a sensor transition (e.g., switch to a camera, or a millimeter wave radar, etc.), or the vehicle may choose to drive to a safe area. In a concrete implementation, information exchanged between the LIDAR and the external perception system may include, but is not limited to: an operating status of the LIDAR and a transition between states, a fault type of the LIDAR, and health/confidence degree of each channel of the LIDAR. This information may correspond to different trigger periods and presentation forms. The health/confidence degree of each channel of the LIDAR is information for evaluating an operating status of each channel of the LIDAR. For example, the LIDAR has 32 lines, a preset optical power of a laser emitter of the second channel is 5 W, and an actual diagnosis result shows that the laser emitter of the second channel can emit light, but has an optical power of only 4 W. Assuming that a perfect score for the health/confidence degree is 10 points, the current optical power may be scored as 7 points, indicating that the laser emitter of the second channel can operate, but the confidence degree does not reach the perfect score. Alternatively, the health degree and the confidence degree may be expressed by percentage, or the health degree and the confidence degree may include only two states “normal” and “abnormal”, which are all within the protected scope of the present disclosure.

As shown in FIG. 2A, when the first FDU 111 or the second FDU 131 detects a first-tier fault, the DMU 132 switches the state of the LIDAR to the deterioration state; and when the first FDU 111 or the second FDU 131 detects a second-tier fault, the DMU 132 switches the state of the LIDAR to the shutdown state.

According to an exemplary embodiment of the present disclosure, the state detection device further includes a point cloud reasonableness diagnosis unit PCR 133, for example, arranged on or connected with the lower circuit board 13, as shown in FIG. 1C. The point cloud reasonableness diagnosis unit PCR 133 is configured to receive the point cloud data (D_Cloud) and output determination information indicating whether the point cloud data is reasonable. The DMU 132 communicates with the point cloud reasonableness diagnosis unit PCR 133 and receives the determination information indicating whether the point cloud data is reasonable from the point cloud reasonableness diagnosis unit PCR 133. The point cloud reasonableness diagnosis unit PCR 133 will be described in detail below.

The above description is given using a mechanical LIDAR including an upper circuit board and a lower circuit board as an example. Those skilled in the art can easily understand that the present disclosure is not limited thereto, and can also be applied to other types of LIDARs, such as solid-state LIDARs.

The present disclosure also relates to a LIDAR, including the state detection device described above.

The LIDAR further includes an upper circuit board and a lower circuit board, where components of the LIDAR are respectively installed on or connected to the upper circuit board and the lower circuit board. The upper circuit board and the lower circuit board are implemented by an FPGA and/or a microcontroller.

The present disclosure also provides a state detection method for a LIDAR, including:

performing, by a fault diagnostic unit, a fault diagnosis on a component of the LIDAR, and when a fault is diagnosed, outputting a fault diagnosis signal; and

receiving, by a diagnostic management unit, the fault diagnosis signal, and determining a state of the LIDAR according to the fault diagnosis signal.

FIG. 6 illustrates a state detection method 20 for a LIDAR according to an exemplary embodiment of the present disclosure. The LIDAR includes an upper circuit board and a lower circuit board, and the state detection method includes the following steps:

Step S21: A first fault diagnostic unit performs a fault diagnosis on a component of the LIDAR installed on or connected to the upper circuit board, and when a fault is diagnosed, outputs a first fault diagnosis signal.

Step S22: A second fault diagnostic unit performs a fault diagnosis on a component of the LIDAR installed on or connected to the lower circuit board, and when a fault is diagnosed, outputs a second fault diagnosis signal.

Step S23: A diagnostic management unit receives the first fault diagnosis signal and the second fault diagnosis signal, and determines the state of the LIDAR according to the first fault diagnosis signal and the second fault diagnosis signal.

According to an exemplary embodiment of the present disclosure, the LIDAR includes an emitting unit, a receiving unit, and a point cloud generating unit arranged on the upper circuit board, where the emitting unit is configured to emit a detection laser beam to outside of the LIDAR, the receiving unit is configured to receive an echo of the detection laser beam reflected on a target object and convert the echo into an electrical signal, and the point cloud generating unit is configured to generate point cloud data of the LIDAR based on the electrical signal; and the state detection method further includes: receiving point cloud data corresponding to the first fault diagnosis signal when the first fault diagnosis signal is received, that is, transmitting the point cloud data at the time of failure to the diagnostic management unit.

According to an exemplary embodiment of the present disclosure, the LIDAR includes a motor, a power supply, an encoding device, and a communication component arranged on the lower circuit board, and the states of the LIDAR include: an initialization state, a normal state, a deterioration state, and a shutdown state, and the state detection method includes:

performing a self-diagnosis operation and a motor startup operation for the LIDAR in the initialization state;

performing, by the first fault diagnostic unit and the second fault diagnostic unit, periodic diagnosis in the normal state;

performing, by the first fault diagnostic unit and the second fault diagnostic unit, periodic diagnosis in the deterioration state, and recording at least part of data of the LIDAR; and

powering off the LIDAR in the shutdown state, and recording at least part of data of the LIDAR.

As described above, the faults of the LIDAR include a first-tier fault and a second-tier fault, and the state detection method further includes:

switching, by the diagnostic management unit, the state of the LIDAR to the deterioration state when the first fault diagnostic unit or the second fault diagnostic unit detects a first-tier fault; and

switching, by the diagnostic management unit, the state of the LIDAR to the shutdown state when the first fault diagnostic unit or the second fault diagnostic unit detects a second-tier fault.

According to an exemplary embodiment of the present disclosure, the state detection method 20 further includes: switching, by the diagnostic management unit, the state of the LIDAR from the deterioration state to the normal state when the first fault diagnostic unit and the second fault diagnostic unit detect that no fault occurs in the deterioration state.

According to an exemplary embodiment of the present disclosure, the self-diagnosis operation includes: self-diagnosis of the power supply and a clock of the LIDAR; self-diagnosis of the upper circuit board and the lower circuit board; self-diagnosis of internal power supply; and self-diagnosis of the emitting unit and the receiving unit; when the self-diagnosis operation is successful, the motor startup operation is performed; and

the state detection method further includes:

switching, by the diagnostic management unit, the state of the LIDAR from the initialization state to the normal state when the self-diagnosis operation in the initialization state is successful and the motor is successfully started;

switching, by the diagnostic management unit, the state of the LIDAR from the initialization state to the shutdown state when the self-diagnosis of the power supply and the clock fails or the self-diagnosis of the upper circuit board and the lower circuit board fails; and

switching, by the diagnostic management unit, the state of the LIDAR from the initialization state to the shutdown state when the motor startup operation fails.

According to an exemplary embodiment of the present disclosure, the state detection method 20 further includes: buffering fault data to the first buffer when the first fault diagnostic unit determines a fault;

buffering fault data to the second buffer when the second fault diagnostic unit determines a fault; and

receiving, by a fault memory, the fault data from the first buffer and the second buffer.

According to an exemplary embodiment of the present disclosure, the state detection method 20 further includes: outputting, by the diagnostic management unit, fault data stored in the fault memory when an external request is received.

According to an exemplary embodiment of the present disclosure, the state detection method 20 further includes: determining, by a point cloud reasonableness diagnosis unit, whether the point cloud data is reasonable and outputting determination information indicating whether the point cloud data is reasonable; and

receiving, by the diagnostic management unit, the determination information indicating whether the point cloud data is reasonable from the point cloud reasonableness diagnosis unit.

Those skilled in the art can easily understand that the features described above with reference to FIG. 1B-FIG. 6 can also be combined and applied in the technical solution of FIG. 1A, and the details will not be repeated herein.

First Aspect: Emitting Terminal Fault Diagnosis

The inventors of the present disclosure have conceived that, in order to detect a fault of the emitting end of the LIDAR in a timely manner, one or more photoelectric sensors may be added to the emitting unit of the LIDAR, or electrical signals at nodes in the emitting unit may be acquired, to determine whether a fault exists at the emitting end of the LIDAR and optionally determine a type of the fault. A detailed description will be given below.

### Embodiment 1: Photon Detection (PD) Plate

The detection of the emitting unit in this embodiment may constitute a part of the periodic fault detection and initialization self-diagnosis described above.

The inventors have conceived that a photoelectric sensor for detection may be arranged in an emitting chamber of the LIDAR to detect and determine whether each emission channel or laser emitter of the LIDAR is operating normally. A detailed description will be given below with reference to the accompanying drawings.

The emitting unit of the LIDAR generally includes multiple laser emitters. The multiple laser emitters may be driven separately to emit detection beams. For example, each laser emitter corresponds to a certain detection angle or detection field of view. The normal operation of the laser emitters and related photoelectric components is very necessary to ensure the high-precision detection of the LIDAR. The inventors have conceived that a photoelectric sensor for detection may be arranged in an emitting chamber of the LIDAR to detect and determine whether each emission channel or laser emitter of the LIDAR is operating normally. A detailed description will be given below with reference to the accompanying drawings.

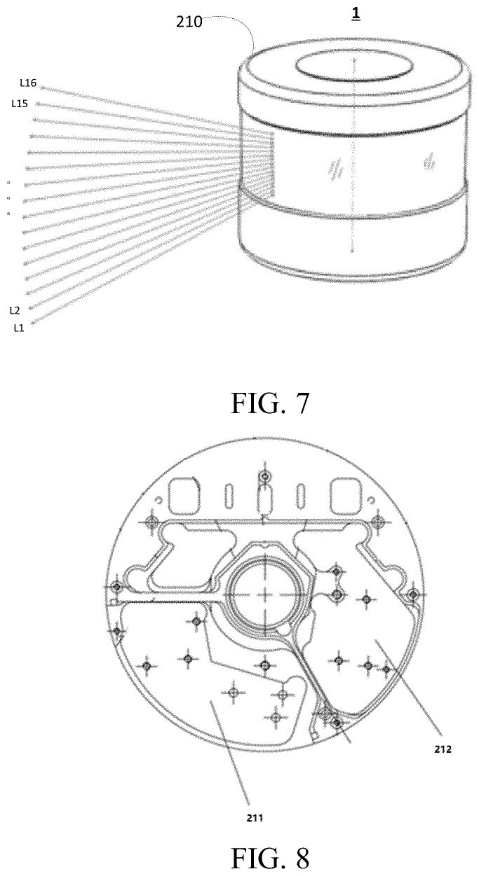

FIG. 7 illustrates an embodiment of the LIDAR 1. The LIDAR 1 includes an emitting unit and a receiving unit. The emitting unit is configured to generate and emit a detection laser beam. The detection laser beam is diffusely reflected on an object outside the LIDAR. Part of the reflected beam returns to the LIDAR, and is received and processed by the receiving unit. FIG. 7 schematically illustrates a 16-line LIDAR, which can emit a total of 16 laser beams L1, L2, . . . , L15, L16 along a vertical direction in the figure (where each laser beam corresponds to one channel, and there are a total of 16 channels), to detect an ambient environment. During the detection process, the LIDAR 100 may rotate along a vertical axis thereof. During rotation, each channel of the LIDAR emits a laser beam in turn according to a certain time interval (for example, 1 microsecond) and performs detection to complete the scanning of one line on a vertical field of view, and then is rotated by a certain angle (e.g., 0.1 degrees or 0.2 degrees) in a horizontal field of view to perform the scanning of the next line on the vertical field of view, so as to perform multiple detections during the rotation process to form point clouds. In this way, a situation of the ambient environment can be sensed.

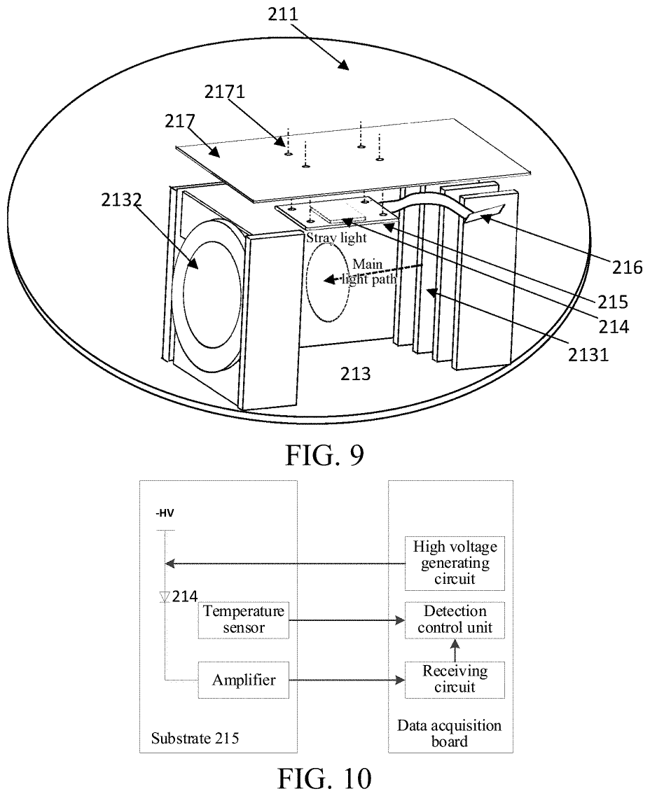

As shown in FIG. 7, the LIDAR 1 includes a housing 210 configured to accommodate or support mechanical, optical, and electronic devices of the LIDAR 1. The housing includes an emitting chamber 211 and a receiving chamber 212 therein, as shown in FIG. 8. The emitting chamber 211 is configured to accommodate an emitting unit 213 (see FIG. 9) of the LIDAR, for example, a laser emitter assembly 2131, a reflecting mirror, a laser-driven circuit, etc. The receiving chamber 212 is configured to accommodate a receiving unit of the LIDAR, for example, a reflecting mirror, a detector array, a signal processing circuit, etc. Usually, the emitting chamber 211 and the receiving chamber 212 are isolated from each other to avoid interference between laser beams emitted by laser emitters and echoes received by the LIDAR. Those skilled in the art can easily understand that the emitting chamber and the receiving chamber may be physically separated by one or more partitions, so as to better isolate the emitting unit from the receiving unit to avoid crosstalk of light between the emitting unit and the receiving unit. However, the present disclosure is not limited thereto, and the emitting chamber and the receiving chamber may not be physically separated, but are approximately distinguished by the emitting unit and the receiving unit accommodated therein, which are all within the protected scope of the present disclosure.

The present disclosure mainly relates to the emitting chamber and the emitting unit of the LIDAR, so for the sake of simplicity, the receiving unit and the receiving chamber will not be described in detail.

FIG. 9 shows an arrangement mode of the emitting unit 213 in the emitting chamber 211 of the LIDAR. As shown in FIG. 9, the emitting unit 213 arranged in the emitting chamber 211 of the LIDAR includes a laser emitter assembly 2131 and an emitting lens 2132. When required, a reflecting mirror may further be arranged between the laser emitter assembly 2131 and the emitting lens 2132, so that a laser beam emitted from the emitting assembly 2131 is reflected one or more times and then incident on the emitting lens 2132. The laser emitter assembly 2131 includes a plurality of laser emitters. Each of the laser emitters may be driven separately to emit a laser beam. The laser emitter assembly 2131 is located on a focal plane of the emitting lens 2132, so after a laser beam passes through the emitting lens 2132, the laser beam is modulated and shaped into a parallel beam and emitted to a three-dimensional space around the LIDAR to detect a target object.

As shown in FIG. 9, a photodetector 214 is arranged in the emitting chamber 211 of the LIDAR, and is installed on an inner top wall of the emitting chamber. As shown in FIG. 9, for example, the photodetector 214 is installed on a substrate 215. The substrate 215 is, for example, a printed circuit board (PCB). The photodetector 214 and the substrate 215 constitute a detection circuit. In FIG. 9, the substrate 215 is connected to the upper circuit board of the LIDAR by a flexible flat cable 216, for providing a voltage to the substrate 215 and the photodetector 214 and for unidirectional or bidirectional transmission of data signals. The emitting chamber 211 includes an upper cover plate (which is a top wall of the emitting chamber 211) 217 on which positioning holes 2171 are provided. The substrate 215 is also provided with positioning holes, which correspond to the positions of the positioning holes 2171 of the upper cover plate 217. In this way, the substrate 215 can be fixedly connected with the upper cover plate 217 of the emitting chamber by the positioning holes, so that an installation plane of the photodetector 215 is substantially parallel to a light-emitting light path of the laser emitter assembly 2131, and a photosensitive surface of the photodetector 215 is parallel to or slightly inclined to a light-emitting light path of the laser emitter assembly 2131. In addition, in the embodiment of FIG. 9, the photodetector 214 is arranged on the substrate 215 and is further connected to the upper circuit board of the LIDAR 1. Those skilled in the art can easily understand that the present disclosure is not limited thereto, and the photodetector 214 may be directly arranged on the upper circuit board of the LIDAR 1 without requiring the arrangement the substrate 215, which are all within the protected scope of the present disclosure.

As shown in FIG. 9, when the laser emitter of the laser emitter assembly 2131 is driven to emit light, the direction of its main light path is approximately toward the emitting lens 2132, as shown by an arrow denoted by “Main light path” in FIG. 9. However, in the actual light-emitting process of the laser emitter, the laser beam does not have strict directionality, so some stray light is also generated outside the main light path, e.g., a light spot denoted by a circle in FIG. 9, which has a large diffusion area, or is greatly deviated from the direction of the main light path. Therefore, according to an exemplary embodiment of the present disclosure, the photodetector 214 is installed outside the main light path of the laser emitter assembly 2131 and at a position where the stray light can irradiate, so that the stray light of the laser emitter assembly 2131 can be continuously measured to detect the operating status of the laser emitter assembly 2131 without interfering with the normal light-emitting detection of the laser emitter assembly 2131. For example, when the laser emitter emits light, the photodetector 214 on the substrate 215 may collect stray light outside the main light path emitted by the laser emitter. For a laser emitter, there is a certain correspondence relationship between the stray light and the light beam of the main light path. Such a preset relationship can be obtained through experiments, and is related to the type of laser emitter, the driving voltage, and the specific position of the photodetector 214. When the laser emitter operates normally, the correspondence relationship between the stray light and the light beam of the main light path is satisfied. When a fault occurs in the laser emitter or the drive circuit, the relationship between the stray light and the light beam of the main light path deviates from the correspondence under normal operating conditions. In this case, a stray light waveform detected by the photodetector 214 is abnormal. Therefore, based on the stray light waveform detected by the photodetector 214, it is possible to identify whether a fault occurs in the laser and optionally identify the specific fault type when a fault occurs, for example, fault states such as open circuit of the laser, an unduly high or low luminous intensity of the laser, etc. For example, according to an embodiment of the present disclosure, a light intensity range of the stray light when the laser operates normally may be preset. During the operating process of the LIDAR, the light intensity of the stray light is continuously detected. When the detected light intensity is zero, it may be determined that the laser is open-circuited. When the detected light intensity is higher than the preset light intensity range, it may be determined that the luminous intensity of the laser emitter is too high (for example, due to an unduly high driving voltage). When the detected light intensity is lower than the preset light intensity range, it may be determined that the luminous intensity of the laser is too small (for example, due to an unduly low driving voltage). Those skilled in the art can easily understand that the intensity-based detection is only an embodiment of the present disclosure, and the fault detection may also be performed according to other characteristic parameters of the waveform obtained by detecting the stray light, which are all within the protected scope of the present disclosure.

According to an embodiment of the present disclosure, the photodetector 214 is, for example, an avalanche diode (APD), which is configured to receive stray light from the emitting system. FIG. 10 is a schematic diagram of a detection circuit according to an embodiment of the present disclosure. As shown in FIG. 10, in addition to the substrate 215, the detection circuit further includes a data acquisition board, on which a high voltage generating circuit is arranged to provide a bias voltage for the photodetector 214. The photodetector 214 senses the stray light of the laser emitter and generates an electrical signal. The output electrical signal is usually weak, so an amplifier may further be provided on the substrate 215 to amplify the electrical signal output by the photodetector 214, and then the amplified electrical signal is provided to a detection control unit (or referred to as a diagnosis unit) through a receiving circuit (or reading sampling circuit) arranged on the data acquisition board. The detection control unit may determine whether the signal sensed by the photodetector 214 is within a normal range and determine a type of a fault occurring in the laser emitter assembly 2131 of the LIDAR if the signal is not within the normal range, according to a preset method. In addition, preferably, a temperature sensor may further be arranged on the substrate 215 to measure a temperature of the substrate 215. The temperature sensor is also coupled to the detection control unit to send a measured temperature value of the substrate 215 to the detection control unit. Taking the avalanche diode (APD) as an example, its photosensitive effect (magnification of photocurrent) as a photodetector is affected by temperature and negative high voltage. By acquiring the temperature of the environment where the APD is located and adjusting the negative high voltage, the magnification of the photocurrent by the APD can be kept basically the same at different temperatures, so that the influence of the temperature on the photosensitive waveform is eliminated during the diagnosis process, and the change of the APD output waveform observed in this case is only the abnormal waveform caused by the fault. In addition, the emitting end may be diagnosed using the photodetector first in the following two aspects: whether a connector is firm; and an output voltage status of the photodetector when no stray light is detected (for example, when a 1.65 V bias voltage is normally input to the photodetector, the theoretical output is also about 1.65 V in the case of no light), to check whether the photodetector itself is faulty to avoid potential faults.

When the laser emitter in the laser emitter assembly 2131 is driven to emit light, the detection control unit may read an electrical signal output by the photodetector 214 and analyze the electrical signal to determine whether the emitting unit operates normally or not according to the analysis result. Those skilled in the art can easily understand that the detection control unit may be integrated into the LIDAR 1, or may be implemented as a separate device, both of which are easy to implement under the teachings of the present disclosure, and are all within the protected scope of the present disclosure. For example, the detection control unit may be a part or a unit module of the LIDAR 1 integrated on the upper circuit board or the lower circuit board of the LIDAR, or may be a separate device arranged outside the LIDAR, and may receive the output of the photodetector 214 that has been amplified and converted and perform a diagnostic operation.

In the diagnostic process, for example, an entire link of the emitting unit may be diagnosed. Corresponding to a plurality of laser emitters, the emitting unit includes a plurality of emitting channels, and each emitting channel includes the corresponding laser emitter and a drive circuit. According to an embodiment, by diagnosing whether each channel has an output, it may be determined whether the channel is operating normally. For example, when the photodetector 214 receives stray light, the laser emitter of the corresponding channel is emitting a detection laser beam. If one of the channels has no output, it may be determined that the emitting channel is defective.

In addition, one or more of parameters including a pulse width, an amplitude, and a phase of the electrical signal of the photodetector 214 may be compared with a pulse width, an amplitude, and a phase of a normal output signal to identify an anomaly in the pulse width, amplitude, and phase of the output signal of the laser emitter of the emitting end caused by the fault. In addition, a waveform of a pulse emitted by the laser emitter can be set or known in advance. After the photodetector detects the stray light, the detection control unit compares a waveform obtained after signal acquisition and processing with the waveform of the pulse emitted by the laser emitter. If the two are identical or approximately consistent with each other, it is determined that the emitting unit is operating normally; otherwise, it is determined that the emitting unit does not operate normally, and an alarm is generated.

According to an exemplary embodiment of the present disclosure, during the normal operation of the LIDAR, the photodetector 214 continuously or periodically measures the parameters of stray light, and the detection control unit continuously or periodically performs fault detection and diagnosis based on the output of the photodetector 214.

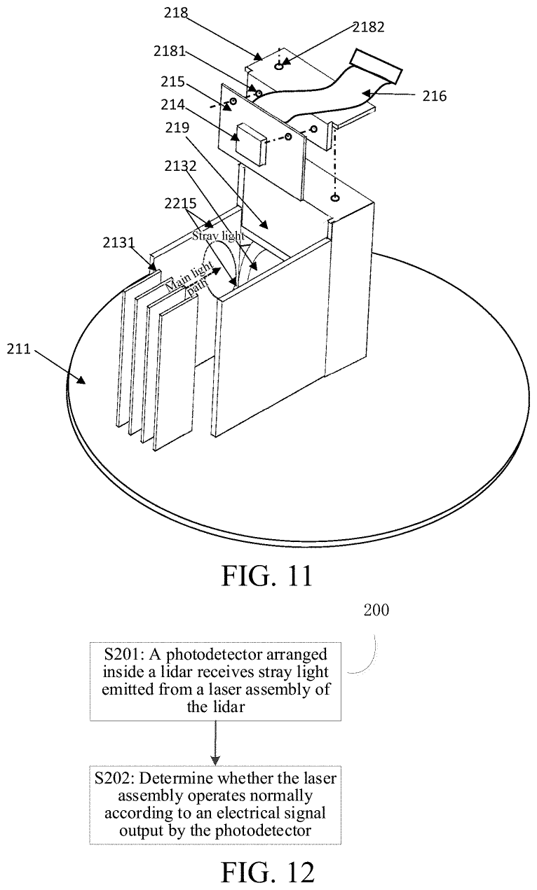

FIG. 11 illustrates another exemplary embodiment of the present disclosure, where the photodetector is arranged at a different position. A detailed description is given below with reference to FIG. 11.

As shown in FIG. 11, the substrate 215 is fixed to an inner side wall 219 above the emitting lens 2132 by a corner connector 218, a side surface of the corner connector 218 is flush and in close contact with a side surface of the inner side wall 219 above the emitting lens 2132, and a top surface of the corner connector 218 is flush and in close contact with a top surface of the inner side wall 219. As shown in FIG. 11, holes 2181 are provided on the side surface of the corner connector 218, and the substrate 215 is also provided with holes at positions corresponding to the holes 2181, so that the substrate 215 and the corner connector 218 can be fixed to the inner side wall 219 by screws. Holes 2182 are provided on an upper surface of the corner connector 218, and the top surface of the inner side wall 219 is also provided with holes at positions corresponding to the holes 2182, so that the corner connector 218 can be fixed to the top surface of the inner side wall 219 by screws. Therefore, by fixing the top surface and the side surface of the corner connector 218, the photodetector 214 can be firmly fixed on the inner side wall 219, and the photosensitive surface of the photodetector 214 is basically perpendicular to the light-emitting light path of the laser emitter assembly 2131, making it more convenient to collect and measure the stray light emitted by the laser emitter assembly 2131.

According to an exemplary embodiment of the present disclosure, at the position of the inner side wall above the emitting lens 2132, the photodetector 214 may be made exactly opposite to the laser emitter assembly 2131 as much as possible, for example, a longitudinal center axis of the photodetector 214 is approximately aligned with a longitudinal bisector of the laser emitter assembly.

According to an exemplary embodiment of the present disclosure, the LIDAR includes an upper circuit board (not shown) on which a power interface may be arranged. A groove is provided on an outer edge of the upper circuit board close to the receiving chamber. The substrate 215 is connected with the upper circuit board by a flexible flat cable 216. One end of the flexible flat cable 216 is connected to the substrate 215, and another end of the flexible flat cable 216 is connected to the groove of the upper circuit board by a coupler, i.e., connected to the power interface on the upper circuit board, for transmitting power and signals. Compared with other connection methods, the flexible flat cable may be integrally formed with a PCB, to provide reliable connection; the flexible flat cable is flat, occupies a small space, and facilitates sealing at the receiving chamber; and the flexible flat cable is easy to install.

The present disclosure also relates to a detection method of an emitting unit of a LIDAR, which may be implemented on, for example, the LIDAR described above, and will be described in detail below with reference to FIG. 12.

As shown in FIG. 12, the detection method 200 of the emitting unit includes:

step S201: receiving, by a photodetector arranged inside a LIDAR, stray light emitted from a laser emitter assembly of the LIDAR; and

step S202: determining whether the laser emitter assembly operates normally according to an electrical signal output by the photodetector.

According to an exemplary embodiment of the present disclosure, step S202 includes: determining that the laser emitter is open-circuited when a light intensity of the stray light detected by the photodetector is zero; determining that a luminous intensity of the laser emitter is too large when the light intensity of the detected stray light is higher than a preset light intensity range; and determining that a luminous intensity of the laser emitter is too small when the light intensity of the detected stray light is lower than the preset light intensity range.

According to one aspect of the present disclosure, the photodetector is configured to receive stray light from the laser emitter each time the laser emitter is driven to emit light.

According to one aspect of the present disclosure, the step of determining whether the laser emitter assembly operates normally includes: determining that the laser emitter assembly operates normally when a waveform of the electrical signal matches a pre-established waveform; and determining that the laser emitter assembly does not operate normally when the waveform of the electrical signal does not match the pre-established waveform. For example, the waveform of the electrical signal may be compared with a preset pulse width, amplitude, and phase of a normal output signal to determine whether the laser emitter assembly operates normally.

The technical solution of the embodiments of the present disclosure has broad diagnostic coverage and can cover the failure detection of the emitting end of the LIDAR. The technical solution has low complexity for implementation and low costs, because the technical solution does not require any additional special detection chip or complex circuit. The technical solution is reasonable and highly robust because the diagnostic logic circuit does not affect the normal operating circuit, and even if the diagnostic circuit is damaged, the damage can be identified by algorithms of FPGA.

This embodiment provides a LIDAR, including:

a housing, including an emitting chamber therein;

a laser emitter assembly, arranged in the emitting chamber, including a plurality of laser emitters, and configured to emit a detection laser beam;

a photodetector, arranged in the emitting chamber, and configured to receive stray light of the laser emitter and convert the stray light into an electrical signal; and

a detection control unit, coupled to the photodetector, and configured to acquire and analyze the electrical signal of the photodetector and determine whether the laser emitter assembly operates normally according to a result of the analysis.

According to one aspect of this embodiment, the photodetector is arranged on an inner top wall of the emitting chamber.

According to one aspect of this embodiment, the LIDAR further includes an emitting lens located on a surface of the housing and configured to converge the detection laser beam, where the photodetector is located on an inner side wall above the emitting lens.

According to one aspect of this embodiment, the photodetector is fixed to an inner side wall above the emitting lens by a corner connector, a side surface of the corner connector is in close contact with a side surface of the inner side wall above the emitting lens, and a top surface of the corner connector is in close contact with a top surface of the inner side wall.

According to one aspect of this embodiment, the LIDAR further includes a substrate configured to carry the photodetector.

According to one aspect of this embodiment, the LIDAR includes an upper circuit board, a groove is provided on an outer edge the upper circuit board close to the receiving chamber, the substrate is connected with the upper circuit board by a flexible flat cable, one end of the flexible flat cable is connected to the substrate, and another end of the flexible flat cable is connected to the groove of the upper circuit board.

According to one aspect of this embodiment, the photodetector is arranged above a main light path of the laser emitter assembly, and an installation plane of the photodetector is parallel to a direction of the main light path.

According to one aspect of this embodiment, the LIDAR further includes a temperature sensor arranged on the substrate, the temperature sensor is configured to sense a temperature of the substrate, and the temperature sensor is coupled to the detection control unit to transmit the temperature of the substrate to the detection control unit.

This embodiment also provides a control method for the LIDAR described above, including:

receiving, by a photodetector arranged inside a LIDAR, stray light emitted from a laser emitter assembly of the LIDAR; and

determining whether the laser emitter assembly operates normally according to an electrical signal output by the photodetector.

According to one aspect of this embodiment, the step of determining whether the laser emitter assembly operates normally includes: determining that the laser emitter is open-circuited when a light intensity of the stray light detected by the photodetector is zero; determining that a luminous intensity of the laser emitter is too large when the light intensity of the detected stray light is higher than a preset light intensity range; and determining that a luminous intensity of the laser emitter is too small when the light intensity of the detected stray light is lower than the preset light intensity range.

According to one aspect of this embodiment, the photodetector is configured to receive stray light from the laser emitter each time the laser emitter is driven to emit light.

According to one aspect of this embodiment, the step of determining whether the laser emitter assembly operates normally includes: determining that the laser emitter assembly operates normally when a waveform of the electrical signal matches a pre-established waveform; and determining that the laser emitter assembly does not operate normally when the waveform of the electrical signal does not match the pre-established waveform.

This embodiment also provides an emitting unit of a LIDAR, including:

a laser emitter assembly, arranged in an emitting chamber of the LIDAR, including a plurality of laser emitters, and configured to emit a detection laser beam;

a photodetector, arranged in the emitting chamber, and configured to receive stray light of the laser emitter and convert the stray light into an electrical signal; and

a detection control unit, coupled to the photodetector, and configured to acquire and analyze the electrical signal of the photodetector and determine whether the laser emitter assembly operates normally according to a result of the analysis.

According to one aspect of this embodiment, the photodetector is arranged on an inner top wall of the emitting chamber.

According to one aspect of this embodiment, the emitting unit further includes an emitting lens configured to converge the detection laser beam, where the photodetector is located on an inner side wall above the emitting lens.

According to one aspect of this embodiment, the photodetector is fixed to an inner side wall above the emitting lens by a corner connector, a side surface of the corner connector is in close contact with a side surface of the inner side wall above the emitting lens, and a top surface of the corner connector is in close contact with a top surface of the inner side wall.

### Embodiment 2: Emitting End Fault Diagnosis

Embodiment 2 relates to the detection of the emitting unit of the LIDAR, which may be performed by, for example, the FDU 111, and will be described in detail below. The detection of the emitting unit in this embodiment may constitute a part of the periodic fault detection or the self-diagnosis operation described above.

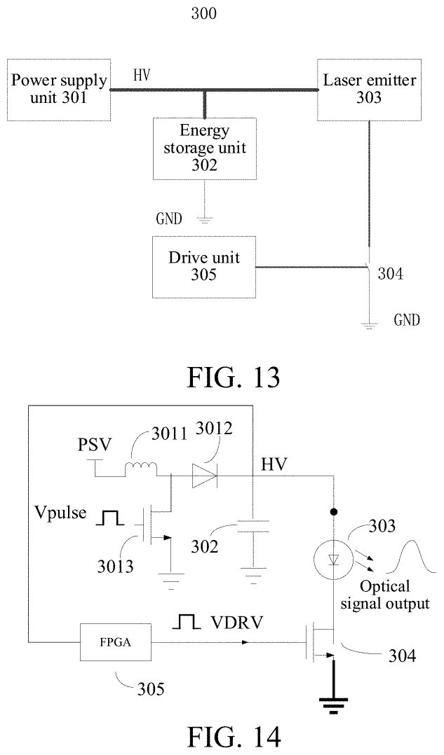

FIG. 13 illustrates an embodiment of an emitting end assembly 300 of a LIDAR. As shown in FIG. 13, the emitting end assembly 300 of the LIDAR includes a power supply unit 301, an energy storage unit 302, a laser emitter 303, and a switching device 304. The power supply unit 301 usually is configured to receive a low voltage input, e.g., 12 V, and boost an output voltage to, e.g., 60 V, through a boost circuit to provide a high voltage HV. The energy storage unit 302 is configured to receive the high voltage HV output by the power supply unit 301, and store and accumulate electrical energy. The laser emitter 303 is, for example, a laser diode (LD), one end of which is coupled to the switching device 304 and an other end of which is coupled to the energy storage unit 302. According to an implementation of the present disclosure, the power supply unit 301 supplies power to the energy storage unit 302, and the energy storage unit 302 stores electrical energy. When the switching device 304 is closed, the energy storage unit 302 drives the laser emitter 303, where a return path provided by the switching device 304 discharges, current flows through the laser emitter 303, and the laser emitter 303 emits a laser beam. The switching device 304 may be, for example, a GaN switch.

In addition, as shown in FIG. 13, the emitting end assembly 300 of the LIDAR further includes a drive unit 305. The drive unit 305 is coupled to a control terminal of the switching device 304, so that the control terminal may output a control signal to control on/off of the switching device 304 and an on/off duration, which may be controlled to, for example, 30 ns, to effect a pulse width of the laser beam emitted by the laser emitter 303. When the drive unit 305 controls the switching device 304 to be in an on state, the switching device 304 provides a discharge return path for the laser emitter 303, so that the energy storage unit 302 drives the laser emitter 303, current flows through the laser emitter 303, and the laser emitter 303 emits a laser beam. When the drive unit 305 controls the switching device 304 to be in an off state, the discharge return path is disconnected, and the laser emitter 303 stops emitting light. Therefore, by controlling the on/off duration of the switching device 304, the light-emitting duration of the laser emitter 303 can be controlled.

FIG. 14 is a schematic diagram of an exemplary circuit structure of the emitting end assembly 300 of the LIDAR shown in FIG. 13. A described description is given below with reference to FIG. 14 and FIG. 13.

FIG. 14 illustrates a detailed structure of the power supply unit 301 in FIG. 13. As shown in FIG. 14, the power supply unit 301 includes a charging inductor 3011, a diode 3012, and a switch 3013 (e.g., a field effect transistor). One end of the charging inductor 3011 is connected to an input voltage PSV, for example, an input voltage of 12 V, and an other end of the charging inductor 3011 is connected to a drain of the switch 3013 and the diode 3012. A gate of the switch 3013 receives a control voltage pulse Vpulse, and a source of the switch 3013 is grounded. The power supply unit 301 is coupled to the capacitor 302 (energy storage unit) so as to build a high voltage HV thereon, and coupled to the laser emitter 303. An other end of the laser emitter 303 is coupled to a drain of the switching device 304 (which is shown as a field effect transistor or a GaN switch in the figure), a source of the switching device 304 is grounded, and a gate of the switching device 304 is coupled to the drive unit 305 which is an FPGA. Those skilled in the art can easily understand that in addition to using an FPGA to implement the drive unit 305, a DSP or an ASIC may also be used to implement the drive unit, which are all within the protected scope of the present disclosure.

The operating principle of the present disclosure is generally described as follows. An operation process of the circuit is as follows: The energy storage unit 302 performs charging and energy storage, and when the switching device 304 is switched on, the laser emitter is driven by the high voltage HV to emit light and discharge. The cycle is repeated throughout the laser detection process.

During charging, the input voltage PSV (e.g., 12 V or 5 V) is provided, and the control voltage pulse Vpulse controls whether to turn on/off the switch 3013 and an on duration of the switch 3013. When the switch 3013 is turned on, the source of the switch 3013 is grounded to provide a return path, to charge the charging inductor 3011 under the drive of the input voltage PSV. When the switch 3013 is turned off, the inductor 3011 discharges in order to maintain the current thereon. The diode 3012 is on, thereby charging the capacitor 302. After the capacitor 302 is charged, a voltage across two ends of the capacitor 302 is the high voltage HV. The FPGA as the drive unit 305 provides a driving signal VDRV to turn on the switching device 304, so that the light-emitting path is on, the current flows through the laser emitter 303, and the laser emits measurement light. The on duration of the switch 3013 is controlled by using the pulse signal Vpulse with a different duty ratio, so as to realize the control of the high voltage HV level. By controlling the duty ratio of the driving signal VDRV output by the FPGA 305, the light-emitting time of the laser emitter 303 can be controlled. In addition, the FPGA 305 may further acquire electrical signals at one or more nodes in the emitting end of the LIDAR, and compare waveforms of the electrical signals with a pre-established waveform, to determine whether a fault exists in the emitting end of the LIDAR and determine a possible fault type. For example, the fault may be a short circuit of the laser emitter, open circuit of the laser emitter, open circuit of the power supply unit, or open circuit of the energy storage element.

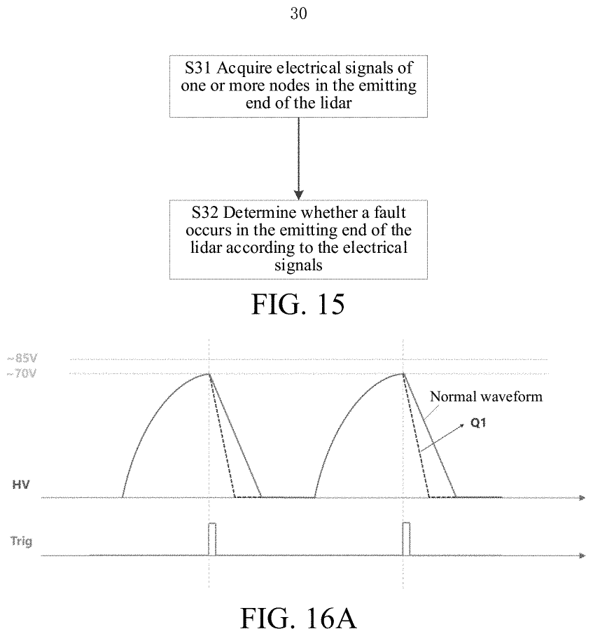

FIG. 15 illustrates a fault diagnosis method 30 according to an embodiment of the present disclosure, which may be used for, for example, the fault diagnosis of the emitting end assembly 300 of the LIDAR in FIG. 13 and FIG. 14. A detailed description will be given below with reference to FIG. 15.

As shown in FIG. 15, in step S31, electrical signals of one or more nodes in the emitting end of the LIDAR are acquired.

The inventors of the present disclosure have found that an electrical signal (i.e., the high voltage HV) at an output terminal of the power supply unit 301, that is, a voltage waveform at the output terminal of the power supply unit (or a voltage waveform on the energy storage unit), may be acquired because the voltage waveform at the output terminal of the power supply unit can characterize and identify a variety of faults. In addition, preferably, the nodes further include an output terminal of the drive unit 305, and the acquired electrical signals include a voltage waveform at the output terminal of the drive unit 305.

In step S32, it is determined whether a fault exists in the emitting end of the LIDAR according to the electrical signals.

After certain processing is performed on amplitudes and/or waveforms of the acquired electrical signals, it may be determined whether a fault exists in the emitting end assembly 300 of the LIDAR.

The fault of the emitting end assembly of the LIDAR may include one or more of the following faults: short circuit of the laser emitter, open circuit of the laser emitter, open circuit of the power supply unit, or open circuit of the energy storage element. Each type of fault is reflected by the electrical signals of one or more of the nodes. Therefore, a pre-established fault waveform or judgment criterion may be stored in a memory, and the electrical signals are compared with the pre-established waveform or judgment criterion to determine whether a fault exists in the emitting end of the LIDAR and the type of the fault.

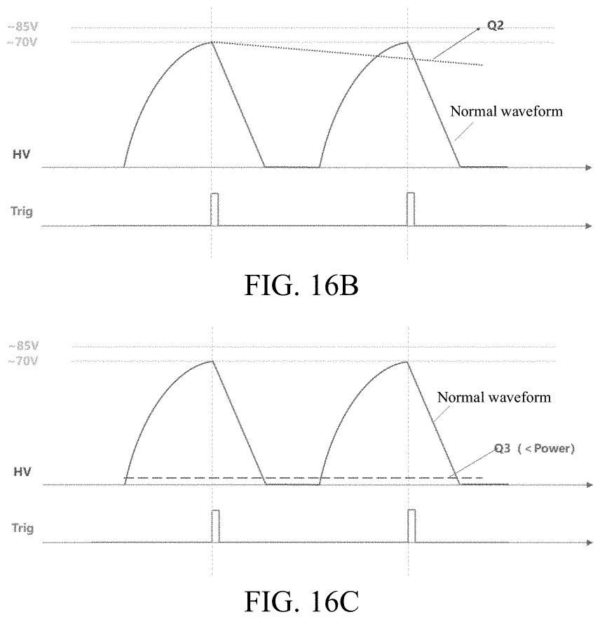

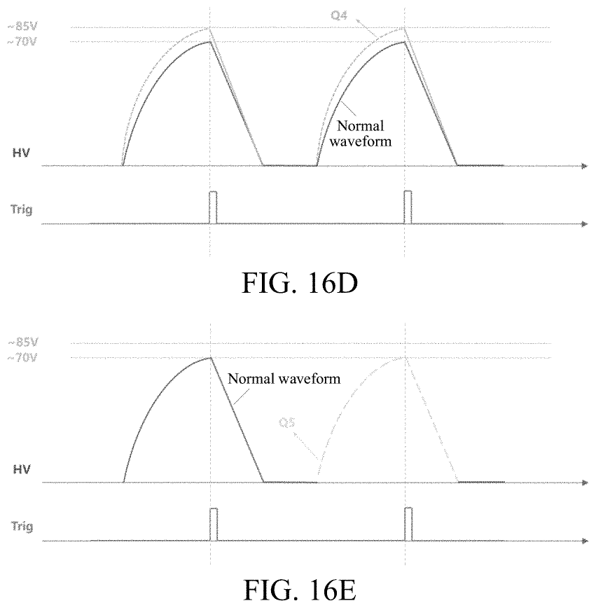

FIGS. 16A-16E illustrate pre-established waveforms for a range of faults, corresponding to electrical signals at the output terminal of the power supply unit 301. As shown in FIG. 16A, a waveform Q1 represents a waveform when the laser emitter is short-circuited. When the laser emitter 303 in FIG. 13 is short-circuited, the output voltage waveform of the power supply unit 301 quickly drops to zero, so it can be determined whether a short circuit occurs in the laser emitter according to a slope of descending of the electrical signal at the output terminal of the power supply unit 301.

As shown in FIG. 16B, a waveform Q2 represents a waveform when the laser emitter is open-circuited. When the laser emitter 303 in FIG. 13 is open-circuited, electrical energy stored in the energy storage unit 302 cannot be discharged by the laser emitter 303, so the voltage signal at the output terminal of the power supply unit 301 is relatively stable or drop at a very small rate, which is reflected by a small descending slope in the waveform graph.

As shown in FIG. 16C, a waveform Q3 represents a waveform when the power supply unit is open-circuited. When the power supply unit 301 in FIG. 13 is open-circuited, the output of the power supply unit 301 always remains at a low level, as shown by the waveform Q3.

The power supply unit includes a charging inductor, and the fault further includes open circuit of the charging inductor. As shown in FIG. 16E, a waveform Q5 represents a waveform when the charging inductor is open-circuited. A pulse for generating a high voltage is completely missing in the waveform Q5, indicating that the charging inductor may be open-circuited.

According to an embodiment of the present disclosure, an amplitude, descending slope, etc. may be calculated according to the output of the power supply unit 301, and compared with a preset threshold to determine whether a fault occurs and a specific fault type. Alternatively, a voltage waveform output by the power supply unit 301 may be compared with pre-established waveforms using, for example, an image classification algorithm, to obtain one of the pre-established waveforms closest to the voltage waveform, so as to determine whether a fault exists and a specific fault type.

According to an embodiment of the present disclosure, the energy storage unit includes a charging capacitor or a charging capacitor group, and the waveform Q4 represents a waveform when the charging capacitor is open-circuited. When the charging capacitor is open-circuited, the high voltage HV always remains at a high level and cannot drive the laser emitter to discharge electric charges, with a waveform as shown in the waveform Q4 in FIG. 16D.

In addition, those skilled in the art can easily understand that the waveforms corresponding to the faults shown in FIG. 16 are only exemplary and do not constitute a limitation on the protected scope of the present disclosure. Under the teachings of the present disclosure, those skilled in the art can set other types of fault waveforms, which are all within the scope of the present disclosure.

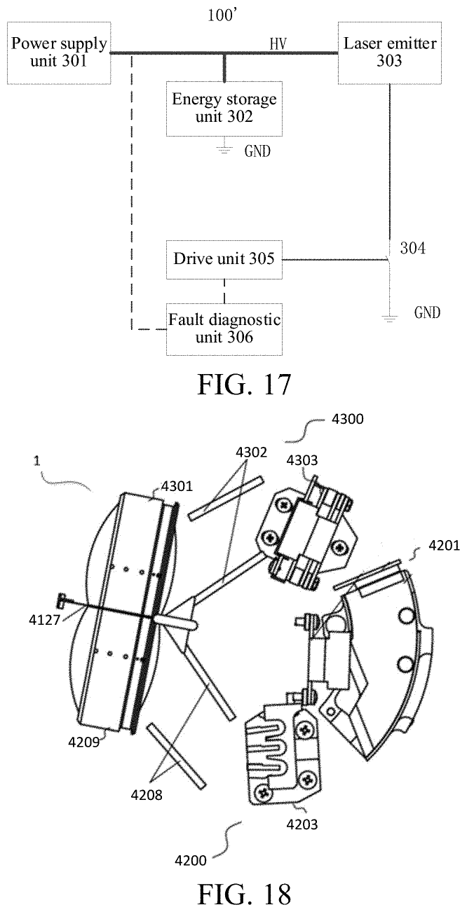

FIG. 17 illustrates an emitting end assembly 300′ of a LIDAR according to an embodiment of the present disclosure, which also include a power supply unit 301, an energy storage unit 302, a laser emitter 303, a switching device 304, and a drive unit 305. The emitting end assembly 300′ are basically the same as the emitting end assembly 300 of the LIDAR shown in FIG. 13, so the details will not be repeated herein. In addition, the components and their connection relationship and other features in the embodiment shown in FIG. 14 may also be applied to FIG. 17 without inventive efforts. The difference between the emitting end assembly 300′ and the emitting end assembly 300 of the LIDAR in FIG. 13 is described below.

As shown in FIG. 17, the emitting end assembly 300′ of the LIDAR further includes a fault diagnostic unit 106, and the fault diagnostic unit 106 is configured to acquire electrical signals at one or more nodes in the emitting end assembly 300′ of the LIDAR, and determine whether a fault exists in the emitting end assembly of the LIDAR according to the electrical signals.

As described with reference to FIG. 13 and FIG. 14, the one or more nodes may include the output terminal of the power supply unit 301, and the electrical signals include the voltage waveform of the output terminal of the power supply unit.

The fault diagnostic unit 106 may be configured to implement the fault diagnosis method 30 shown in FIG. 15, for example, compare waveforms of the electrical signals with a pre-established waveform, to determine whether a fault exists in the emitting end of the LIDAR and determine a fault type. For example, the fault includes short circuit of the laser emitter, open circuit of the laser emitter, open circuit of the power supply unit, or open circuit of the energy storage element.

The energy storage element 302 includes, for example, a charging capacitor or a charging capacitor group. The power supply unit includes a charging inductor, and the fault further includes open circuit of the charging inductor.

The present disclosure also relates to a LIDAR, including: the emitting end assembly 300 or 300′ of the LIDAR described above and a receiving end assembly. The emitting end assembly 300 or 300′ of the LIDAR is configured to emit a detection beam. The detection beam is diffusely reflected on an obstacle outside the LIDAR, and part of the reflected beam will be incident on the receiving end assembly as an echoed beam. The receiving end assembly includes, for example, an optical lens and a photoelectric sensor. The optical lens converges the echoed beams of the LIDAR onto the photoelectric sensor. The photoelectric sensor may be an APD or SiPM, which generates an electrical signal according to the received light intensity or number of photons. The electrical signal is processed by subsequent circuits and signal processing, amplified, and filtered to generate point cloud data of the LIDAR. The point cloud data can characterize the distance, orientation, reflectivity, and other information of the obstacle.

The technical solution according to the embodiments of the present disclosure has broad of fault diagnosis, and can satisfy the detection and diagnosis of failures of multiple devices at the laser receiving end. In addition, the technical solution has low complexity for implementation. In the design solution of the embodiments of the present disclosure, signals may be acquired on the output terminal of the power supply unit. Taking a 64-line LIDAR as an example, usually signals at only 5 points (which depends on the architecture, but the number of pins can be reduced by 30% or more for multi-line LIDAR) need to be acquired, with a lower complexity for implementation than that of conventional solutions. The solution can be implemented at low costs. The circuit acquisition logic has a high requirement on the real-time performance, even at the nanosecond level, but a high-speed analog-to-digital converter (ADC) at the laser receiving end can be multiplexed for acquisition without the need of an additional ADC chip. In addition, the technical solution is highly robust because the diagnostic logic circuit does not affect the normal operating circuit, and even if the diagnostic circuit is damaged, the cause can be identified by algorithms of FPGA.

A fault diagnosis method for an emitting end of a LIDAR is provided. The emitting end of the LIDAR includes a laser emitter and a switching device coupled to one end of the laser emitter, an energy storage unit coupled to an other end of the laser emitter, and a power supply unit configured to supply power to the energy storage unit. The fault diagnosis method includes:

acquiring electrical signals of one or more nodes in the emitting end of the LIDAR; and

determining whether a fault exists in the emitting end of the LIDAR according to the electrical signals.

According to one aspect of the present disclosure, the one or more nodes include an output terminal of the power supply unit, and the electrical signals include a voltage waveform of the output terminal of the power supply unit.

According to one aspect of the present disclosure, the emitting end of the LIDAR further includes a drive unit coupled to a control terminal of the switching device, the drive unit is configured to control on/off of the switching device and an on/off duration, the nodes further include an output terminal of the drive unit, and the electrical signals further include a voltage waveform at the output terminal of the drive unit.

According to one aspect of the present disclosure, the step of determining whether a fault exists in the emitting end of the LIDAR according to the electrical signals includes: comparing waveforms of the electrical signals with a pre-established waveform, to determine whether a fault exists in the emitting end of the LIDAR and determine a fault type.

According to one aspect of the present disclosure, the fault includes one or more of: short circuit of the laser emitter, open circuit of the laser emitter, open circuit of the power supply unit, or open circuit of the energy storage element.

According to one aspect of the present disclosure, the energy storage element includes a charging capacitor group and a charging inductor, and the open circuit of the energy storage element includes an open circuit of the charging capacitor and an open circuit of the charging inductor.

The present disclosure also provides an emitting end assembly of a LIDAR, including:

a laser emitter;

a switching device, coupled to one end of the laser emitter;

an energy storage unit, coupled to an other end of the laser emitter;

a power supply unit, coupled to the energy storage unit and configured to supply power to the energy storage unit; and

a fault diagnostic unit, configured to acquire electrical signals at one or more nodes in the emitting end assembly of the LIDAR, and determine whether a fault exists in the emitting end assembly of the LIDAR according to the electrical signals.

According to one aspect of the present disclosure, the one or more nodes include an output terminal of the power supply unit, and the electrical signals include a voltage waveform of the output terminal of the power supply unit.

According to one aspect of the present disclosure, the emitting end of the LIDAR further includes a drive unit coupled to a control terminal of the switching device, the drive unit is configured to control on/off of the switching device and an on/off duration, the nodes further include an output terminal of the drive unit, and the electrical signals further include a voltage waveform at the output terminal of the drive unit.

According to one aspect of the present disclosure, the fault diagnostic unit is configured to: compare waveforms of the electrical signals with a pre-established waveform, to determine whether a fault exists in the emitting end of the LIDAR and determine a fault type.

According to one aspect of the present disclosure, the fault includes one or more of: short circuit of the laser emitter, open circuit of the laser emitter, open circuit of the power supply unit, or open circuit of the energy storage element.

According to one aspect of the present disclosure, the energy storage element includes a charging capacitor group and a charging inductor, and the open circuit of the energy storage element includes an open circuit of the charging capacitor and an open circuit of the charging inductor.

The present disclosure also provides a LIDAR, including:

an emitting end assembly of the LIDAR described above, configured to emit a detection beam; and

a receiving end assembly, configured to receive an echoed beam formed by the detection beam reflected by an obstacle.

The technical solutions of the embodiments of the present disclosure have high broad of fault diagnosis and can cover all failure scenarios of the receiving end circuit of the LIDAR, and has low complexity for implementation. A conventional diagnosis scheme requires separate detection of the demultiplexer and the transimpedance amplifying unit at the front end and the two-stage multiplexer and the ADC driver at the rear end, requiring a complex circuit. In the present disclosure, by providing a test signal to the transimpedance amplifying unit, whether each channel of the receiving end of the LIDAR operates normally can be detected, and according to the output of the ADC, a possible faulty device and the fault location can be diagnosed. The technical solution of the present disclosure does not require any additional special detection chip or complex circuit, and therefore is of low costs. In addition, the technical solution is highly robust because the diagnostic logic circuit does not affect the normal operating circuit, and even if the diagnostic circuit is damaged, the cause can be identified by the controller (e.g., FPGA, DSP, or ASIC) logic.

Second Aspect: Receiving End Fault Diagnosis

An embodiment of the second aspect may constitute a part of the periodic diagnosis or self-diagnosis operation described above.

The inventors of the present disclosure have conceived that, in order to detect a fault of the receiving end of the LIDAR in a timely manner, a detection light source may be added to the receiving unit of the LIDAR, or electrical signals at nodes in the receiving unit may be acquired, to determine whether a fault exists in the receiving end of the LIDAR and optionally determine a type of the fault. A detailed description will be given below.

### Embodiment 1: Additional Provision of a LED Light Source for Detection

Embodiment 1 relates to the diagnosis of the receiving unit of the LIDAR, which may be performed by, for example, the first FDU 111, and will be described in detail below. The diagnosis of the receiving unit in this embodiment may constitute a part of the periodic fault detection described above.

FIG. 18 illustrates a LIDAR 1 according to an embodiment of the present disclosure. A detailed description will be given below with reference to FIG. 18. The LIDAR 1 mainly includes an emitting unit 4200 and a receiving unit 4300. The emitting unit 4200 is configured to generate and emit a detection laser beam. The detection laser beam is diffusely reflected on an object outside the LIDAR. Part of the reflected beam returns to the LIDAR 1, and is received and processed by the receiving unit 4300. The receiving unit 4300 converts an optical signal of the echoed beams of the LIDAR into an electrical signal, and further performs signal processing operations such as amplification, analog-to-digital conversion, and filtering on the electrical signal, to finally form a point cloud of the LIDAR, which can identify and characterize parameters such as distance and orientation of an external object.

The LIDAR 1 includes a housing (not shown) configured to accommodate or support mechanical, optical, and electronic devices of the LIDAR 1. The housing includes an emitting chamber and a receiving chamber therein, which are respectively configured to receive the emitting unit 4200 and the receiving unit 4300 of the LIDAR 1. Although the emitting chamber and the receiving chamber are not shown in FIG. 18, those skilled in the art can easily understand that the emitting chamber and the receiving chamber may be physically separated by one or more partitions, so as to better isolate the emitting unit from the receiving unit to avoid crosstalk of light between the emitting unit and the receiving unit. However, the present disclosure is not limited thereto, and the emitting chamber and the receiving chamber may not be separated, but are approximately distinguished by the emitting unit 4200 and the receiving unit 4300 accommodated therein, which are all within the protected scope of the present disclosure.

The emitting unit 4200 and the receiving unit 4300 are described below with reference to FIG. 18.

The emitting unit 4200 includes a laser-driven circuit 4201, a laser emitter assembly 4203, an emitting end reflecting mirror assembly 4208, and an emitting lens 4209. The laser emitter assembly 4203 includes one or more laser emitters, each of which may be separately controlled to emit a detection pulse. The laser assembly 4203 is coupled to the laser-driven circuit 4201, and the laser-driven circuit 4201 provides a driving voltage and an emission pulse signal to the laser emitter assembly 4203. When the laser emitter assembly 4203 receives the emission pulse signal, one of the laser emitters in the laser emitter assembly 4203 is driven to emit a detection beam. The emitting end reflecting mirror assembly 4208 and the emitting lens 4209 are sequentially arranged downstream of a light path of the laser emitter assembly 4203. The emitting end reflecting mirror assembly 4208 is configured to change a direction of the detection beam through one or more reflections, and reflect the detection beam to the emitting lens 4209. FIG. 18 illustrates the emitting end reflecting mirror assembly 4208 including two reflecting mirrors, but the present disclosure is not limited thereto, and one or more than two reflecting mirrors may be provided, which are all within the scope of the present disclosure. The emitting lens 4209 is usually located on a surface of the housing of the LIDAR 1, and is configured to collimate or perform other types of shaping processing on the detection beam incident thereon, and emit the collimated detection beam or the detection beam obtained by the other types of shaping processing to the outside of the LIDAR to detect obstacles nearby. This can be easily understood by those skilled in the art and therefore will not be described in detail here.

In the receiving unit 4300, a receiving lens 4301, a receiving end reflecting mirror assembly 4302, and a detection assembly 4303 are sequentially arranged along the direction of the light path. The receiving lens 4301 is usually located on a surface of the housing of the LIDAR 1, for example, is disposed adjacently to the emitting lens 4209 in the horizontal direction, and is configured to receive a reflected beam (or referred to as an echoed beam) from an external obstacle, and converge the reflected beam. The direction of the converged beam is changed by the receiving end reflecting mirror assembly 4302, and the converged beam is incident on the detection assembly 4303 after one or more reflections. The detection assembly may include a photoelectric sensor 43031 (as shown in FIG. 21), an amplifying circuit, an analog-to-digital converter, and some other signal processing circuits. The photoelectric sensor may include, for example, a photodiode, an APD, an SiPMs, etc., which can output an electrical signal (e.g., current signal) according to the intensity of the beam or the number of photons incident thereon. The electrical signal is usually weak, and needs to be amplified by the amplifying circuit before subsequent signal processing operations can be performed. The amplifying circuit may be, for example, a transimpedance amplifier (TIA), which is coupled to an output terminal of the photoelectric sensor 43031, and receives a current signal output by the photoelectric sensor 43031, amplifies and converts the current signal to output a voltage signal. The analog-to-digital converter is connected to the amplifying circuit and configured to sample and convert the amplified analog signal and output a digital signal for subsequent operations such as filtering and storage. The details will not be repeated herein.

According to an exemplary embodiment of the present disclosure, the detection assembly 4303 includes a substrate and an APD array detector, and the APD array detector is arranged on one side of the substrate and basically faces toward the receiving lens 4301 or the receiving end reflecting mirror assembly 4302. The APD array detector is an APD area array detector, consisting of area array avalanche photodiodes arranged in an N*N arrangement, where M≥2 and N≥2. N*N is for example, 4*4, 4*8, 8*8, etc. The N*N arrangement depends on the arrangement mode of laser emitters of the LIDAR.

In addition, as shown in FIG. 18, the emitting lens 4209 and the receiving lens 4301 are located on a surface of the housing of the LIDAR 1, and a light barrier 4127 may be arranged between the emitting lens 4209 and the receiving lens 4301 to further isolate the emitting lens 4209 from the receiving lens 4301 to reduce crosstalk of light between the emitting lens 4209 and the receiving lens 4301.

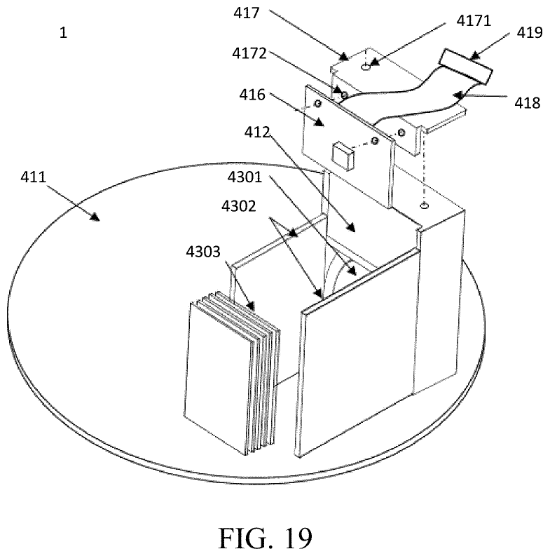

As shown in FIG. 19, the LIDAR 1 further includes a detection light source 416 and a control unit 43032 (as shown in FIG. 21, or referred to as a diagnostic unit). The detection light source 416 is arranged in the receiving chamber, and is configured to emit a detection beam. The detection beam may be received by the photodetector 43031. Those skilled in the art can easily understand that the detection beam emitted by the detection light source 416 may be directly incident on the photodetector 43031, or may be incident on the photodetector 43031 after being reflected by the receiving end reflecting mirror assembly 4302, which are all within the protected scope of the present disclosure.

As shown in FIG. 21, the LIDAR 1 further includes a control unit 43032. The control unit 43032 is coupled to the photodetector 43031 and configured to acquire and analyze an electrical signal of the photodetector 43031 when the detection light source 416 emits a detection beam, and determine whether the receiving unit 4300 operates normally according to a result of the analysis. Those skilled in the art can easily understand that the control unit 43032 may be integrated into the detection assembly 4303 of the LIDAR 1, or may be implemented as a separate device, both of which are easy to implement under the teachings of the present disclosure, and are all within the protected scope of the present disclosure. For example, the control unit 43032 may be a part or a unit module of the processing circuit of the detection assembly 4303, and may receive the output of the photodetector 43031 that has been amplified and converted and perform a diagnostic operation.

In the diagnostic process, for example, an entire link of the receiving end may be diagnosed. The receiving unit includes, for example, a plurality of receiving channels, each receiving channel including the corresponding photodetector. According to an embodiment, by diagnosing whether each channel has an output, it may be determined whether the channel is operating normally. For example, when the detection beam emitted by the detection light source 416 should theoretically be received by all the photodetectors, each receiving channel should have a corresponding output. If one of the channels has no output, it may be determined that the receiving channel is defective.

In addition, one or more of parameters including a pulse width, an amplitude, and a phase of the output signal of the receiving end may be compared with a pulse width, an amplitude, and a phase of a normal output signal to identify an anomaly in the pulse width, amplitude, and phase of the output signal of the receiving end caused by the fault. In addition, a waveform of a pulse emitted by the detection light source 416 can be set or known in advance. After the photodetector detects the beam emitted by the detection light source 416, the control unit 43032 compares a waveform obtained after signal acquisition and processing with the waveform of the pulse emitted by the detection light source 416. If the two are identical or approximately consistent with each other, it is determined that the receiving unit is operating normally; otherwise, it is determined that the receiving unit does not operate normally, and an alarm is generated.

According to an exemplary embodiment of the present disclosure, the control unit 43032 is coupled to the detection light source 416, and is configured to control the detection light source 416 to emit light when the LIDAR is powered on, perform self-diagnosis of the LIDAR, and acquire electrical signals at one or more nodes in the receiving unit, to determine whether the receiving unit operates normally. When one or more of the receiving channels are faulty, an alarm is generated for the user.

The receiving unit includes a plurality of receiving channels, each receiving channel including the corresponding photodetector. The number of detection light sources may be one or more. In a case where one detection light source is arranged, the detection light source is arranged at a preset position, where at the preset position, the detection beam of the detection light source can be detected by the photodetector corresponding to each receiving channel. In this case, the detection beam emitted by the one detection light source can cover the photodetectors of all the receiving channels, so light emitted by the one detection light source can be received by all the photoelectric sensors, thus realizing the effect of simulating the simultaneous emission of multiple laser emitters. The receiving end has multiple sampling channels, the sampling channels can operate at the same time, and each sampling channel is responsible for a certain number of photoelectric sensors. Therefore, the detection light source may be continuously driven based on a certain period, and the photoelectric sensors on each sampling channel are switched based on a certain period, to realize the identification of outputs of all the sampling channels.

In a case where multiple detection light sources are arranged, the detection beams emitted by the multiple detection light sources can cover the photodetectors of all the receiving channels. The number of the detection light sources should be determined according to the layout of the photodetectors, the intensities of the detection light sources, and a relationship between relative positions of the photodetectors and the detection light sources, and the detection beams emitted by the multiple detection light sources can cover the photodetectors of all the receiving channels.

According to an exemplary embodiment of the present disclosure, the receiving unit includes a plurality of receiving channels, each receiving channel including the corresponding photodetector, and the control unit is configured to sequentially determine whether each receiving channel operates normally.

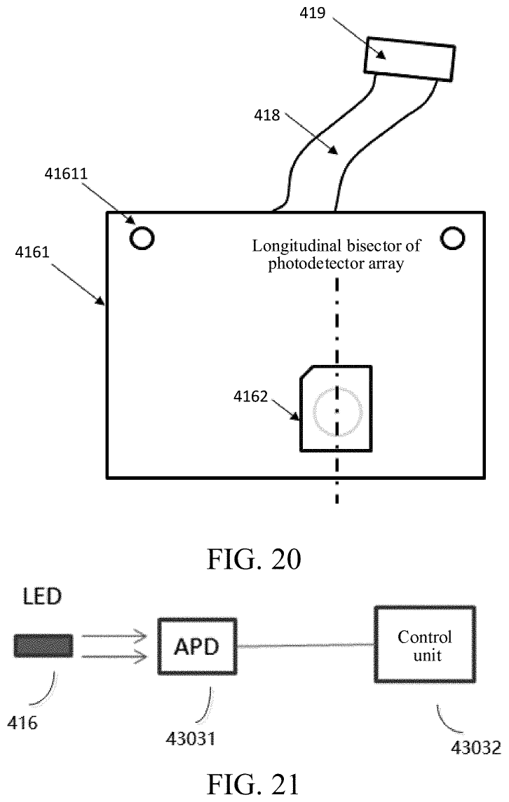

According to an exemplary embodiment of the present disclosure, as shown in FIG. 19, the detection light source 416 is arranged on a relatively upper part of an inner side wall 412 of the receiving chamber. As shown in FIG. 19 and FIG. 20, the detection light source 416 includes an LED light source 4162 and a PCB driving board 4161. The PCB driving board 4161 is connected to the LED light source 4162 to provide a driving voltage and current to the LED light source 4162. As shown in FIG. 19, the detection light source 416 may be arranged on a side surface of the inner side wall 412 above the receiving lens 301. Alternatively, the detection light source 416 includes a light emitting device configured to allow the photodetector 43031 to perceive sufficient light radiation within an operating temperature range of the LIDAR. The LED light source is small in size, low in power consumption, and low in heat generation, and therefore has little impact on the temperature of the receiving chamber. In addition, the LED light source requires a low driving voltage and a simple drive circuit, and therefore is a preferred implementation.

According to an exemplary embodiment of the present disclosure, the detection light source 416 is located on an inner side wall above the receiving lens 4301, and the receiving lens is located on a surface of the housing and configured to converge the echoed beams of the LIDAR.

According to an exemplary embodiment of the present disclosure, as shown in FIG. 19, the detection light source 416 is fixed to an inner side wall 412 above the receiving lens 4301 by a corner connector 417, a side surface of the corner connector 417 is flush and in close contact with a side surface of the inner side wall 412 above the receiving lens 4301, and a top surface of the corner connector 417 is flush and in close contact with a top surface of the inner side wall 412. As shown in FIG. 19 and FIG. 20, holes 4172 are provided on the side surface of the corner connector 417, and the PCB driving board 4161 of the light source 416 is also provided with holes 41611 at positions corresponding to the holes 4172, so that the PCB driving board 4161 and the corner connector 417 can be fixed to the inner side wall 412 by screws. Holes 4171 are provided on an upper surface of the corner connector 417, and the top surface of the inner side wall 412 is also provided with holes at positions corresponding to the holes 4171, so that the corner connector 417 can be fixed to the top surface of the inner side wall 412 by screws. Therefore, by fixing the top surface and the side surface of the corner connector 417, the light source 416 can be firmly fixed on the inner side wall 412.

According to an exemplary embodiment of the present disclosure, at the position of the inner side wall above the receiving lens, the LED may be made exactly opposite to the photodetector, so that a position with a maximum radiation energy of the light emitted by the LED is irradiated on the photodetector. As shown in FIG. 20, according to an exemplary embodiment of the present disclosure, a longitudinal center axis of the LED is approximately aligned with a longitudinal bisector of the photodetector array.

According to an exemplary embodiment of the present disclosure, the LIDAR includes an upper circuit board (not shown) on which a power interface may be arranged. A groove is provided on an outer edge the upper circuit board close to the receiving chamber. The PCB driving board 4161 is connected with the upper circuit board by a flexible flat cable 418. One end of the flexible flat cable 418 is connected to the PCB driving board 4161, and another end of the flexible flat cable 418 is connected to the groove of the upper circuit board by a coupler 419, i.e., connected to the power interface on the upper circuit board, for transmitting power and signals. Compared with other connection methods, the flexible flat cable may be integrally formed with a PCB, to provide reliable connection; the flexible flat cable is flat, occupies a small space, and facilitates sealing at the receiving chamber; and the flexible flat cable is easy to install.

According to an embodiment of the present disclosure, the LED may also be arranged at a position on the upper cover plate of the receiving chamber, which position is convenient for installation.

According to an exemplary embodiment of the present disclosure, the control unit is configured to determine whether the receiving unit operates normally in the following manner:

determining that the receiving unit operates normally when a waveform of the electrical signal matches a waveform of the detection beam; and

determining that the receiving unit does not operate normally when the waveform of the electrical signal does not match the waveform of the detection beam.

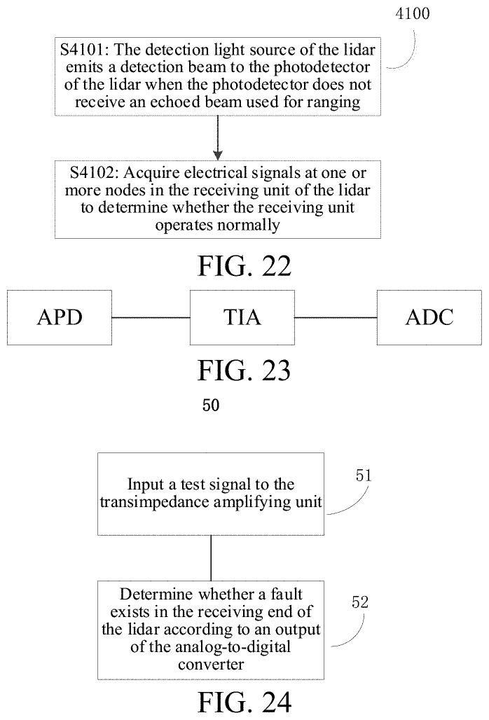

The present disclosure also relates to a control method 4100 of the LIDAR described above, which may be implemented on, for example, the LIDAR 1 described above. As shown in FIG. 22, the control method 4100 may include the following steps:

Step S4101: The detection light source of the LIDAR emits a detection beam to the photodetector of the LIDAR when the photodetector does not receive an echoed beam used for ranging.

Step S4102: Acquire electrical signals at one or more nodes in the receiving unit of the LIDAR to determine whether the receiving unit operates normally. The multiple nodes may be located at multiple positions in the receiving unit, e.g., the output terminal of the photodetector, the output terminal of the amplifier, the output terminal of the analog-to-digital converter, etc. The present disclosure is not limited to the specific positions.

According to an exemplary embodiment of the present disclosure, step S4101 includes: controlling the detection light source at intervals of a preset time to emit the detection beam.

According to an exemplary embodiment of the present disclosure, step S4101 includes: controlling the detection light source to emit the detection beam when the LIDAR is powered on.

According to an exemplary embodiment of the present disclosure, the receiving unit includes a plurality of receiving channels, each receiving channel including the corresponding photodetector, and the control method includes: respectively executing steps S4101 and S4102 for each receiving channel.

According to an exemplary embodiment of the present disclosure, the step of determining whether the receiving unit operates normally includes:

determining that the receiving unit operates normally when a waveform of the electrical signal matches a waveform of the detection beam; and

determining that the receiving unit does not operate normally when the waveform of the electrical signal does not match the waveform of the detection beam.

The technical solution of the embodiments of the present disclosure has broad diagnostic coverage and can cover all failures of the receiving end circuit of the LIDAR. The technical solution has low complexity for implementation and low costs, because the technical solution does not require any additional special detection chip or complex circuit. The technical solution is reasonable and highly robust because the diagnostic logic circuit does not affect the normal operating circuit, and even if the diagnostic circuit is damaged, the damage can be identified by algorithms of FPGA.

According to one aspect of the present disclosure, the control unit is coupled to the detection light source, and is configured to control the detection light source to emit light when the LIDAR is powered on, and acquire electrical signals at one or more nodes in the receiving unit, to determine whether the receiving unit operates normally.

According to one aspect of the present disclosure, the receiving unit includes a plurality of receiving channels, each receiving channel including the corresponding photodetector, and the control unit is configured to sequentially determine whether each receiving channel operates normally.

According to one aspect of the present disclosure, the photodetector is an avalanche photodiode, and the detection light source is arranged on an upper part of a side wall of the receiving chamber.

According to one aspect of the present disclosure, the detection light source includes an LED located on a surface of the side wall and a PCB driving board located inside the side wall, and the PCB driving board is connected to the LED.

According to one aspect of the present disclosure, the LIDAR further includes a receiving lens located on a surface of the housing and configured to converge the echoed beams of the LIDAR, where the detection light source is located above the receiving lens.

According to one aspect of the present disclosure, the detection light source is fixed to the receiving chamber by a corner connector, a side surface of the corner connector is flush with a side surface of the receiving chamber, and a top surface of the corner connector is flush with a top surface of the side wall.

According to one aspect of the present disclosure, the control unit is configured to determine whether the receiving unit operates normally in the following manner:

determining that the receiving unit operates normally when a waveform of the electrical signal matches a waveform of the detection beam; and

determining that the receiving unit does not operate normally when the waveform of the electrical signal does not match the waveform of the detection beam.

The present disclosure also relates to a control method for the LIDAR described above, including the following steps:

Step S101: The detection light source of the LIDAR emits a detection beam to the photodetector of the LIDAR.

Step S102: Acquire electrical signals at one or more nodes in the receiving unit of the LIDAR to determine whether the receiving unit operates normally.

According to one aspect of the present disclosure, step S101 includes: controlling the detection light source to emit the detection beam when the LIDAR is powered on.

According to one aspect of the present disclosure, the receiving unit includes a plurality of receiving channels, each receiving channel including the corresponding photodetector, and the control method includes: respectively executing steps S101 and S102 for each receiving channel.

According to one aspect of the present disclosure, the step of determining whether the receiving unit operates normally includes:

determining that the receiving unit operates normally when a waveform of the electrical signal matches a waveform of the detection beam; and

determining that the receiving unit does not operate normally when the waveform of the electrical signal does not match the waveform of the detection beam.

The technical solution of the embodiments of the present disclosure has broad diagnostic coverage and can cover all failures of the receiving end circuit of the LIDAR. The technical solution has low complexity for implementation and low costs, because the technical solution does not require any additional special detection chip or complex circuit. The technical solution is reasonable and highly robust because the diagnostic logic circuit does not affect the normal operating circuit, and even if the diagnostic circuit is damaged, the damage can be identified by algorithms of FPGA.

### Embodiment 2: Receiving End Fault Diagnosis

Embodiment 2 relates to the diagnosis of the receiving unit of the LIDAR, which may be performed by, for example, the first FDU 111, and will be described in detail below. The diagnosis of the receiving unit in this embodiment may constitute a part of the periodic fault detection described above.

FIG. 23 is a schematic diagram of a receiving end assembly of a LIDAR. As shown in FIG. 23, the receiving end assembly of the LIDAR includes a photoelectric sensor (e.g., avalanche photodiode (APD)), a transimpedance amplifying unit (TIA), and an analog-to-digital converter (ADC). The photoelectric sensor is configured to receive an echo signal of the LIDAR and converts an optical signal into an electrical signal. Usually, the electrical signal is a current signal and is relatively weak, so the signal may be amplified by the transimpedance amplifying unit (TIA) and converted into a voltage signal. Then, analog-to-digital conversion is performed on the voltage signal by the analog-to-digital converter (ADC) to generate a digital signal for subsequent signal processing of the LIDAR to, for example, generate point cloud data to characterize one or more of parameters including a distance, an angle, and a reflectivity of an obstacle.

FIG. 24 illustrates a fault diagnosis method 50 for a receiving end of the LIDAR according to an embodiment of the present disclosure, which will be described in detail below with reference to the accompanying drawings.

As shown in FIG. 24, the fault diagnosis method 50 includes the following steps:

In step S51, a test signal is input to the transimpedance amplifying unit.

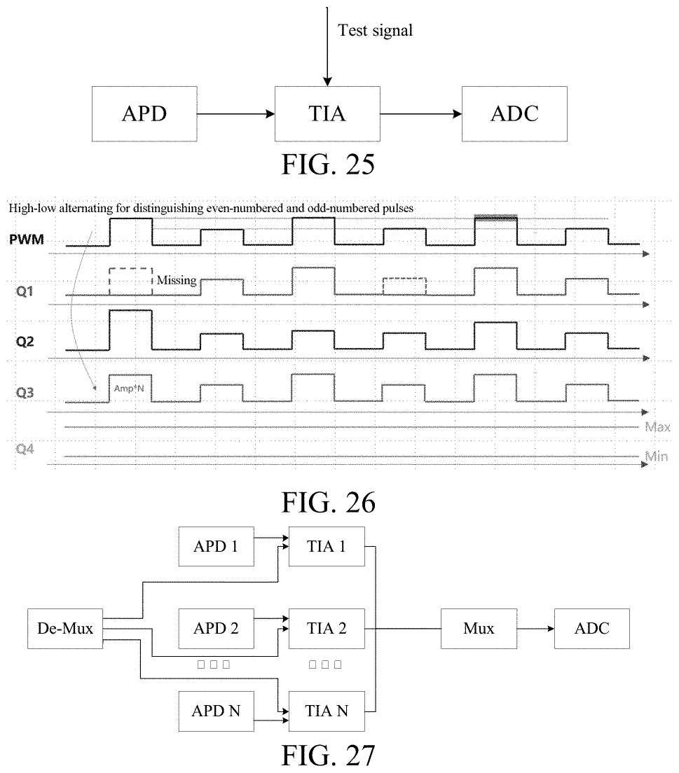

In FIG. 23, during the operating process of the LIDAR, the input signal of the transimpedance amplifying unit (TIA) comes from the photoelectric sensor. In the present disclosure, as shown in FIG. 25, to detect whether the receiving end operates normally before the LIDAR starts to operate or in a interval between LIDAR operations, a test signal is separately input to the transimpedance amplifying unit in the place of the electrical signal output of the photoelectric sensor, to test whether a link of the receiving end of the LIDAR can operate normally. According to an embodiment of the present disclosure, when the test signal is being input, the photoelectric sensor is shielded so that the photoelectric sensor does not generate a signal output, or a signal generated by the photoelectric sensor cannot be provided to the transimpedance amplifying unit (TIA), so that the test signal and the signal of the photoelectric sensor do not interfere with each other.

In step S52, according to an output of the analog-to-digital converter, it is determined whether a fault exists in the receiving end of the LIDAR.

After the test signal is input in step S51, the transimpedance amplifying unit amplifies the test signal as the input signal, and then the analog-to-digital converter (ADC) performs analog-to-digital conversion on the test signal for output. By acquiring and analyzing the output of the analog-to-digital converter, it can be determined whether the link of the receiving end of the LIDAR operates normally.

For example, the output of the analog-to-digital converter (ADC) may be compared with a pre-established waveform, to determine whether a fault exists in the receiving end of the LIDAR and determine a fault type. Commonly known faults of the receiving end of the LIDAR include: open circuit of the transimpedance amplifying unit, short circuit of the power supply, an anomaly related to the linear amplification of the transimpedance amplifying unit, etc.

In addition, according to an exemplary embodiment of the present disclosure, the test signal includes a high-low alternating pulse signal. A PWM waveform in FIG. 26 shows a waveform of the test signal according to this embodiment. The test signal includes a plurality of continuous square wave pulses, and adjacent pulses have different amplitudes, so that even-numbered and odd-numbered pulses can be distinguished from each other, thereby further improving the accuracy of fault diagnosis.

Waveforms Q1, Q2, Q3, and Q4 in FIG. 26 show waveforms output by the analog-to-digital converter (ADC) when various possible faults occur, respectively.

As shown by the waveform Q1, corresponding to one or more pulses in the test signal, the lack of corresponding output pulses in the waveform Q1 indicates that a fault exists in the receiving end of the LIDAR. The possible fault is, for example, open circuit of the transimpedance amplifying unit.

As shown by the waveform Q2, the amplitude of the first pulse is too high, and the amplitude of the third pulse is clamped to be basically equal to the second pulse, which also indicates that a fault exists in the receiving end of the LIDAR. The possible fault is, for example, a bias voltage fault (for example, the APD bias voltage is unstable), leading to an output offset.

As shown by the waveform Q3, although the ratios between the pulses are normal, each pulse is abnormally amplified compared with the test signal PWM. For example, it is assumed that the normal amplitudes of the high pulse and low pulse output by the analog-to-digital converter (ADC) are 1 and 0.8 respectively, but the amplitudes of high pulse and low pulse currently output are 2 and 1.6 respectively, which are twice the normal amplitudes. It also indicates that a fault exists in the receiving end of the LIDAR. The possible fault is, for example, a fault in the transimpedance amplifying unit.

As shown by the waveform Q4, if there is a primary operational amplification, the pulses change in equal proportion, so there is a maximum value Max and a minimum value Min.

FIG. 27 illustrates an embodiment of a receiving end of a LIDAR, including a demultiplexer De-Mux, a plurality of photoelectric sensors APD 1, APD 2, . . . , APD N, a plurality of transimpedance amplifying units TIA 1, TIA 2, . . . , TIA N corresponding to and coupled to the plurality of photoelectric sensors, a multiplexer Mux, and an analog-to-digital converter ADC. The demultiplexer De-Mux is coupled to the plurality of transimpedance amplifying units and is configured to selectively gate one of the transimpedance amplifying units, and the plurality of transimpedance amplifying units are coupled to the analog-to-digital converter by the multiplexer. Each photoelectric sensor and the transimpedance amplifying unit connected thereto constitute one channel.

The demultiplexer De-Mux may, for example, output an activation signal to the transimpedance amplifying units in sequence, to activate the transimpedance amplifying units in sequence. When one of the transimpedance amplifying units is activated, the test signal is provided to the activated transimpedance amplifying unit to test whether the channel and the downstream analog-to-digital converter operate normally.

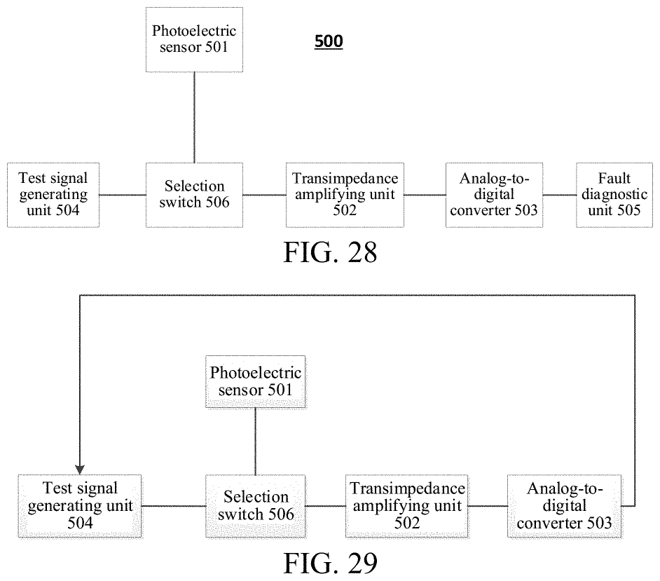

FIG. 28 illustrates a receiving end assembly 500 of a LIDAR according to an embodiment of the present disclosure, which is described in detail below with reference to FIG. 28.

As shown in FIG. 28, the receiving end assembly 500 of the LIDAR includes a photoelectric sensor 501, a transimpedance amplifying unit 502, an analog-to-digital converter 503, a test signal generating unit 504, and a fault diagnostic unit 505. The photoelectric sensor 501 is configured to convert an incident optical signal into an electrical signal. The transimpedance amplifying unit 502 is coupled to the photoelectric sensor 501 and configured to amplify the electrical signal output by the photoelectric sensor 501. The analog-to-digital converter 503 is coupled to the transimpedance amplifying unit 502 and configured to receive an output of the transimpedance amplifying unit and perform analog-to-digital conversion. The test signal generating unit 504 is coupled to the transimpedance amplifying unit 502 and configured to generate a test signal and provide the test signal to the transimpedance amplifying unit. As shown in FIG. 28, the photoelectric sensor 501 and the test signal generating unit 504 may be coupled to the transimpedance amplifying unit 502 by a selection switch 506. The selection switch 506 may, for example, have a first position and a second position. When in the first position, the selection switch 506 may couple the output signal of the photoelectric sensor 501 to the transimpedance amplifying unit 502. When in the second position, the selection switch 506 may couple the test signal generated by the test signal generating unit 504 to the transimpedance amplifying unit 502. The selection switch 506 allows the output signal of only one of the test signal generating unit 504 and the photoelectric sensor 501 to be coupled to the transimpedance amplifying unit at a same time. Therefore, interference between the test signal and the output signal of the photoelectric sensor 501 is avoided.

The fault diagnostic unit 505 is coupled to an output terminal of the analog-to-digital converter, and is configured to determine whether a fault exists in the receiving end of the LIDAR according to an output of the analog-to-digital converter in response to the test signal. The fault diagnostic unit 505 may, for example, execute the fault diagnosis method 50 described above to determine whether a fault exists and a specific location and a type of the fault. Those skilled in the art can easily understand that the features described above with reference to FIG. 23-FIG. 27 can also be applied in the technical solution of FIG. 28 without inventive efforts, which are all within the protected scope of the present disclosure.

According to an embodiment of the present disclosure, the fault diagnostic unit 505 is configured to compare the output of the analog-to-digital converter 503 with a pre-established waveform to determine whether a fault exists in the receiving end of the LIDAR and a type of the fault, for example, as described in detail above with reference to FIG. 25. The details will not be repeated here.

Commonly known faults may include one or more of: open circuit of the transimpedance amplifying unit, short circuit of the power supply, or an anomaly related to the linear amplification of the transimpedance amplifying unit. In addition, the test signal may include a high-low alternating pulse signal, so that a more accurate fault diagnosis can be performed on the link of the receiving end of the LIDAR.

In addition, the receiving end assembly of the LIDAR may include a plurality of channels, each channel includes a photoelectric sensor and a transimpedance amplifying unit corresponding to and coupled to the photoelectric sensor. The receiving end assembly of the LIDAR further includes a demultiplexer and a multiplexer. The demultiplexer is coupled to the plurality of transimpedance amplifying units and configured to selectively gate one of the transimpedance amplifying units. The plurality of transimpedance amplifying units are coupled to the analog-to-digital converter by the multiplexer. A schematic structural diagram of the receiving end assembly is shown in FIG. 27. In this case, the test signal generating unit 504 may sequentially input the test signal to the plurality of transimpedance amplifying units.

In addition, according to an exemplary embodiment of the present disclosure, the test signal generating unit 504 and the fault diagnostic unit 505 are integrated together to form an integrated controller, which is, for example, implemented by an FPGA, a DSP, or an ASIC, as shown in FIG. 29. The test signal generating unit 504 may integrate a fault diagnosis module, which may be implemented by software, hardware, or a combination of software and hardware. The output of the analog-to-digital converter 503 is directly coupled to the test signal generating unit 504, and the fault diagnosis module integrated in the test signal generating unit 504 performs fault diagnosis. In this way, the entire receiving end assembly of the LIDAR is made more compact and consumes less power.

The present disclosure also relates to a LIDAR, including an emitting end assembly and the above-mentioned receiving end assembly of the LIDAR. The emitting end assembly is configured to emit a detection beam. The receiving end assembly of the LIDAR is configured to receive an echoed beam formed by the detection beam reflected by an obstacle.

The present disclosure provides a fault diagnosis method for a receiving end of a LIDAR. The receiving end assembly of the LIDAR includes a photoelectric sensor, a transimpedance amplifying unit, and an analog-to-digital converter. The transimpedance amplifying unit is configured to amplify an output of the photoelectric sensor. The analog-to-digital converter is configured to perform analog-to-digital conversion on an output of the transimpedance amplifying unit. The fault diagnosis method includes:

inputting a test signal to the transimpedance amplifying unit; and

determining whether a fault exists in the receiving end of the LIDAR according to an output of the analog-to-digital converter.

According to one aspect of the present disclosure, the step of determining whether a fault exists in the receiving end of the LIDAR according to an output of the analog-to-digital converter includes: comparing the output of the analog-to-digital converter with a pre-established waveform, to determine whether a fault exists in the receiving end of the LIDAR and determine a fault type.

According to one aspect of the present disclosure, the fault includes one or more of: open circuit of the transimpedance amplifying unit, short circuit of the power supply, or an anomaly related to the linear amplification of the transimpedance amplifying unit.

According to one aspect of the present disclosure, the test signal includes a high-low alternating pulse signal.

According to one aspect of the present disclosure, the receiving end assembly of the LIDAR includes a demultiplexer, a plurality of photoelectric sensors, a plurality of transimpedance amplifying units corresponding to and coupled to the plurality of photoelectric sensors, and a multiplexer. The demultiplexer is coupled to the plurality of transimpedance amplifying units and configured to selectively gate one of the transimpedance amplifying units. The plurality of transimpedance amplifying units are coupled to the analog-to-digital converter by the multiplexer.

The step of inputting a test signal to the transimpedance amplifying unit includes: sequentially inputting the test signal to the plurality of transimpedance amplifying units.

The present disclosure also relates to a receiving end assembly of a LIDAR, including:

a photoelectric sensor, configured to convert an incident optical signal into an electrical signal;

a transimpedance amplifying unit, coupled to the photoelectric sensor and configured to amplify the electrical signal output by the photoelectric sensor;

an analog-to-digital converter, coupled to the transimpedance amplifying unit and configured to receive an output of the transimpedance amplifying unit and perform analog-to-digital conversion;

a test signal generating unit, coupled to the transimpedance amplifying unit and configured to provide a test signal to the transimpedance amplifying unit; and

a fault diagnostic unit, configured to: determine whether a fault exists in the receiving end of the LIDAR according to an output of the analog-to-digital converter in response to the test signal.

According to one aspect of the present disclosure, the fault diagnostic unit is configured to compare the output of the analog-to-digital converter with a pre-established waveform, to determine whether a fault exists in the receiving end of the LIDAR and determine a fault type.

According to one aspect of the present disclosure, the fault includes one or more of: open circuit of the transimpedance amplifying unit, short circuit of the power supply, or an anomaly related to the linear amplification of the transimpedance amplifying unit.

According to one aspect of the present disclosure, the test signal includes a high-low alternating pulse signal.

According to one aspect of the present disclosure, the receiving end assembly of the LIDAR includes a demultiplexer, a plurality of photoelectric sensors, a plurality of transimpedance amplifying units corresponding to and coupled to the plurality of photoelectric sensors, and a multiplexer. The demultiplexer is coupled to the plurality of transimpedance amplifying units and configured to selectively gate one of the transimpedance amplifying units. The plurality of transimpedance amplifying units are coupled to the analog-to-digital converter by the multiplexer.

The test signal generating unit 504 is configured to sequentially input the test signal to the plurality of transimpedance amplifying units.

According to one aspect of the present disclosure, the receiving end assembly of the LIDAR further includes a selection switch, and the test signal generating unit and the photoelectric sensor are both coupled to the transimpedance amplifying unit by the selection switch. The selection switch is configured to allow the output signal of only one of the test signal generating unit and the photoelectric sensor to be coupled to the transimpedance amplifying unit at a same time.

According to one aspect of the present disclosure, the test signal generating unit and the fault diagnostic unit are integrated together.

The present disclosure also relates to a LIDAR, including:

an emitting end assembly, configured to emit a detection beam; and

a receiving end assembly of the LIDAR described above, configured to receive an echoed beam formed by the detection beam reflected by an obstacle.

The technical solutions of the embodiments of the present disclosure have broad coverage of fault diagnosis and can cover all failure scenarios of the receiving end circuit of the LIDAR, and has low complexity for implementation. A conventional diagnosis scheme requires separate detection of the demultiplexer and the transimpedance amplifying unit at the front end and the two-stage multiplexer and the ADC driver at the rear end, requiring a complex circuit. In the present disclosure, by providing a test signal to the transimpedance amplifying unit, whether each channel of the receiving end of the LIDAR operates normally can be detected, and according to the output of the ADC, a possible faulty device and the fault location can be diagnosed. The technical solution of the present disclosure does not require any additional special detection chip or complex circuit, and therefore is of low costs. In addition, the technical solution is highly robust because the diagnostic logic circuit does not affect the normal operating circuit, and even if the diagnostic circuit is damaged, the cause can be identified by algorithms of FPGA.

Third Aspect: Determination of Reasonableness of Point Cloud

This embodiment relates to the diagnosis of point cloud data of the LIDAR, which may be performed by, for example, the point cloud reasonableness diagnosis unit PCR 133 shown in FIG. 1B, and will be described in detail below. The point cloud reasonableness diagnosis in this embodiment may be a part of the periodic fault detection or the self-diagnosis operation described above.

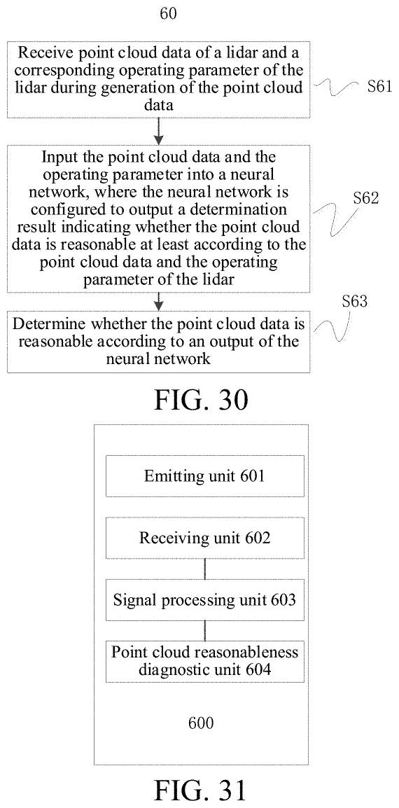

FIG. 30 illustrates a method for diagnosis of reasonableness of a point cloud 60 for a LIDAR according to an embodiment of the present disclosure, which will be described in detail below with reference to the accompanying drawings.

In step S61, point cloud data of a LIDAR and a corresponding operating parameter of the LIDAR during generation of the point cloud data are received.

The LIDAR generally may be rotated around a vertical axis to acquire point cloud data in a 360-degree range in a horizontal plane. Taking a 16-line LIDAR as an example, it can emit a total of 16 laser beams L1, L2, . . . , L15, L16 along a vertical direction (where each laser beam corresponds to one channel, and there are 16 channels in total), to detect an ambient environment.

During the detection process, the LIDAR may rotate around a vertical axis thereof. During rotation, each channel of the LIDAR emits a laser beam in turn according to a certain time interval (for example, 1 microsecond) and performs detection to complete the scanning of one line on a vertical field of view, and then is rotated by a certain angle (e.g., 0.1 degrees or 0.2 degrees) in a horizontal field of view direction to perform the scanning of the next line on the vertical field of view, so as to perform multiple detections during the rotation process to form point clouds. In this way, a situation of the ambient environment can be sensed.

During operation of the LIDAR, many operating parameters can be adjusted. For example, if it is intended only to detect obstacles at a relatively short distance (e.g., 100 m), a power or pulse intensity of an emitter may be reduced (compared with that required in a case where an expected detection distance is 200 m). In another example, if the detection frame rate of the LIDAR is expected to be high, the LIDAR may be controlled to rotate 360 degrees at 20 Hz; if the expected detection frame rate is not very high, the LIDAR may be controlled to scan on a horizontal field of view at 10 Hz. In still another example, at present, most of LIDARs are multi-line LIDARs (where the so-called multi-line means that multiple emitters or a device configured to divide a single beam of exiting light into multiple beams is arranged on a vertical field of view). If the LIDAR itself has 64 lines, a point cloud of up to 64 lines on the vertical field of view can be realized. However, according to the detection requirements, the LIDAR may also be controlled to use only 32 lines for scanning. In addition, the LIDAR may be rotated 360 degrees to achieve 360-degree omnidirectional scanning of obstacles nearby. However, in some application scenarios such as that where the LIDAR is used as a forward-looking LIDAR, the user may only expect the LIDAR to provide scanning within a range of ±70 degrees in a forward direction (which is a traveling direction of the vehicle). In this case, the LIDAR may be controlled to detect obstacles only within the range of ±70 degrees.

In step S62, the point cloud data and the operating parameter are input into a neural network, where the neural network is configured to output a determination result indicating whether the point cloud data is reasonable at least according to the point cloud data and the operating parameter of the LIDAR.

It should be noted that a point cloud being unreasonable or a point cloud being abnormal means that the point cloud data generated through detection by the LIDAR does not quite match the current operating parameter, indicating that the point cloud data is in a certain unreasonable state, and correspondingly, it is possible that the LIDAR does not operate normally or is faulty. Therefore, the neural network may further determine whether the LIDAR is faulty or does not operate normally according to the determination result indicating whether the point cloud data is reasonable.

The neural network is, for example, a pre-trained neural network or deep learning module, an input terminal of which is configured to receive the point cloud data and the operating parameter of the LIDAR. The neural network is configured to at least identify whether the point cloud data is reasonable or normal.

In addition, preferably, after identifying that the point cloud data is abnormal, a specific abnormality status of the point cloud data and a corresponding fault of the LIDAR may be determined. The neural network includes one or more of a back propagation (BP) network, a multi-layer neural network, a fuzzy neural network, or a wavelet neural network, but the present disclosure is not limited to the specific types of neural networks.

In another embodiment of the present disclosure, the point cloud data detected by the LIDAR may be preprocessed and then input into the neural network for subsequent identification processing.

In step S63, it is determined whether the point cloud data is reasonable according to an output of the neural network.

After being trained, the neural network or deep learning module can output an indication of whether the point cloud data is reasonable according to the point cloud data and the operating parameter of the LIDAR. For example, the LIDAR itself is a 64-line radar, but its operating parameter is 40 lines. When the neural network receives point cloud data of 40 lines obtained by the LIDAR, the neural network determines that the point cloud data is reasonable. However, if the point cloud data received by the neural network in this case is of 38 lines, the neural network may determine that the point cloud data is unreasonable or abnormal, or at least there is a certain unreasonable situation.

In another example, the LIDAR may achieve 360-degree omnidirectional scanning of obstacles nearby, but within a certain period of time, the controlled operating parameter of the LIDAR is only to provide scanning within a range of ±50 degrees in the forward direction. In this case, after the detection by the LIDAR, no matter whether the input to the neural network is point cloud data obtained by scanning within a range of ±90 degrees in the forward direction, or by scanning within a range of ±30 degrees in the forward direction, or by scanning within a range of ±50 degrees in a backward direction (which is reverse of the traveling direction of the vehicle), the point cloud data indicates to a certain extent that the point cloud of the LIDAR is not reasonable, and that the entire LIDAR may be faulty or operate abnormally.

According to the output of the neural network, it can be determined whether the point cloud data is reasonable. In addition, preferably, after it is determined that the point cloud data is unreasonable, a fault type of the LIDAR and a specific location of the fault may further be determined. The fault includes one or more of an optical component fault, a mechanical structural fault, or an electrical fault. After determining that the LIDAR is faulty or not and optionally determining the fault type of the LIDAR and the specific location of the fault, an alarm or a prompt may be generated for the user of the LIDAR.

According to an exemplary embodiment of the present disclosure, the method for diagnosis of reasonableness of a point cloud 100 further includes training the neural network to identify abnormal point cloud data, including, for example: inputting abnormal point cloud data and a corresponding operating parameter of the LIDAR during generation of the abnormal point cloud data into the neural network, to train the neural network to identify the abnormal point cloud data.

For example, according to an embodiment of the present disclosure, the parameter of the LIDAR includes, for example, a number of valid lines of the LIDAR at a certain moment. Take a 64-line LIDAR as an example. Under normal operating conditions, the 64 lines need to operate at the same time for obstacle detection. Therefore, if the number of lines in the generated point cloud is less than 64, it indicates that the point cloud is abnormal or a fault occurs in the LIDAR.

In some operating conditions, it is not necessary to perform very fine detection of remote obstacles, and only half of the 64 lines (32 lines) need to be used for detection. Therefore, only 32 lines are included in the generated point cloud data. In this case, the point cloud data of 32 lines is normal, and point cloud data of more than or less than 32 lines is abnormal or unreasonable.

In addition, according to an exemplary embodiment of the present disclosure, the neural network provides a certain margin for determining the reasonableness of point cloud data. For example, when a 64-line LIDAR operates in a state of 64 lines, but one of the laser emitters is faulty, data in the point cloud is of only 63 lines. Although this is also a fault of the LIDAR, the deviation between the current state and the normal state is small, so the point cloud of the LIDAR is still credible. The LIDAR can still be used as a reliable sensor. This case may be regarded as an anomaly in operation.

In addition, the neural network is configured to determine whether one or more frames of point cloud data is reasonable according to one or more previous frames of point cloud data. For example, if a point cloud of a 20th frame shows an object at a certain location, and a point cloud of a 21st frame also shows the object, a movement speed and direction of the object may be deduced according to a time interval between the 20th frame and the 21st frame, so it can be predicted that the object should be at a certain position in a 22nd frame or a 23rd frame. If a point cloud detected in the 22nd frame or the 23rd frame differs greatly from the prediction, it indicates that the point cloud detected in the 22nd frame or the 23rd frame is abnormal.

During the training of the neural network, faults corresponding to abnormal point cloud data may be input into the neural network, to train the neural network to identify the corresponding faults. For example, various faults of the LIDAR and abnormal states of point clouds corresponding to the faults may be obtained in advance through statistics, and abnormal point cloud data and a corresponding parameter of the LIDAR during generation of the abnormal point cloud data are input into the neural network, and the fault corresponding to the abnormal point cloud data is also input into the neural network at the same time, for the neural network to learn to determine the fault status of the LIDAR. The fault includes, for example, one or more of an optical component fault, a mechanical structural fault, or an electrical fault.

According to an embodiment of the present disclosure, the output of the neural network includes one or more of whether the point cloud is abnormal, a name or probability of a possible fault of the LIDAR. In addition, according to an exemplary embodiment of the present disclosure, the neural network is configured to output multiple faults and probabilities corresponding to the multiple faults. For example, first a model of the neural network is trained so that it can identify point cloud map forms corresponding different faults 1, 2, . . . , n (e.g., establish a mapping relationship between abnormal point cloud maps and fault causes). Then, the neural network is used in an actual scenario to analyze a point cloud output by a LIDAR, to discover a potential fault type, faulty component, or fault cause of the LIDAR. For example, in current point cloud data, a probability of fault 1 is 90%, a probability of fault 2 is 40%, a probability of fault 3 is 10%, and all the faults corresponding to probabilities higher than a preset value are output for user reference.

According to an exemplary embodiment of the present disclosure, the LIDAR is installed on a vehicle, and the control unit of the LIDAR is coupled to an electronic control unit (ECU) of the vehicle, so that when determining that the LIDAR is faulty or does not operate normally, the control unit of the LIDAR may send information about the fault to the electronic control unit of the vehicle in which the LIDAR is installed. The fault information may include an indication indicating that the LIDAR is faulty, and/or a specific fault type and fault location. After receiving the fault information, the electronic control unit may make a decision based on the fault information, for example, generating a sound and light prompt for the driver of the vehicle, or ending the autonomous driving state of the vehicle, and prompting the driver to take over the driving operation of the vehicle. It should be noted that the fault information mentioned above may be whether the point cloud is abnormal, whether the LIDAR operates normally, whether the LIDAR is faulty, a possible fault type, and an approximate probability of the fault.

According to an embodiment of the present disclosure, when receiving the fault information, the electronic control unit may determine whether to continue to trust the LIDAR and maintain the autonomous driving state according to the severity of the fault. For example, as mentioned earlier, when a 64-line LIDAR operates in a state of 64 lines, but one of the laser emitters is faulty, data in the point cloud is of only 63 lines. Although this is also a fault of the LIDAR, the deviation between the current state and the normal state is small, so the point cloud of the LIDAR is still credible, and the LIDAR can still be used as a reliable sensor for unmanned driving. The electronic control unit may maintain the autonomous driving state, and prompt the current state to the operator.

FIG. 31 illustrates a LIDAR 600 according to an embodiment of the present disclosure. A detailed description will be given below with reference to FIG. 24.

As shown in FIG. 31, the LIDAR 600 includes an emitting unit 601, a receiving unit 602, a signal processing unit 603, and a point cloud reasonableness diagnosis unit 604. The emitting unit 601 usually includes a plurality of laser emitters and an emitting lens. The laser emitter is configured to emit a laser beam. The laser beam is incident on the emitting lens and shaped into a detection beam. The detection beam is emitted into a three-dimensional space around the LIDAR. The receiving unit 602 generally includes a receiving lens and a detector. The receiving lens receives a reflected light beam (or referred to as a LIDAR echo) from outside the LIDAR and converges the reflected light beam on the detector. The detector may include, for example, an APD or SiPM, and is configured to convert the optical signal incident thereon into an electrical signal. The signal processing unit 603 is coupled to the receiving unit 602 and is configured to generate point cloud data of the LIDAR according to the electrical signal. The signal processing unit 603 may generally include signal processing circuits at various stages, including but not limited to an amplifying circuit (e.g., a transimpedance amplifier), a filtering circuit, an analog-to-digital conversion circuit, etc., and may calculate parameters such as a distance and orientation of an obstacle according to the optical signal and other related information, and generate point cloud data.

The point cloud reasonableness diagnosis unit 604 is coupled to the signal processing unit 603 to receive the point cloud data, and is configured to execute the method for diagnosis of reasonableness of a point cloud 60 described above, and output determination information indicating whether the point cloud data is reasonable.

According to an exemplary embodiment of the present disclosure, the point cloud reasonableness diagnosis unit 604 is further configured to output fault information of the LIDAR. On the basis of a determination that the point cloud data is unreasonable, the point cloud reasonableness diagnosis unit 604 may further determine detailed fault information of the LIDAR according to the point cloud data.

According to an exemplary embodiment of the present disclosure, the signal processing unit 603 and the point cloud reasonableness diagnosis unit 604 may be integrated together, for example, a diagnosis module is integrated in an FPGA or ASIC of the signal processing unit 603, to determine whether there is a problem with hardware of the LIDAR, in addition to performing signal processing. If there is a problem, an error message is output. If there is no problem, the point cloud is input to the neural network, and the neural network outputs information about whether a fault exists. According to an embodiment, the signal processing unit 603 and the point cloud reasonableness diagnosis unit 604 are both integrated on the lower circuit board of the LIDAR.

The present disclosure also relates to a vehicle on which the LIDAR described above is mounted.

An electronic control unit (ECU) of the vehicle may be coupled to the LIDAR, and is configured to receive fault information output by the point cloud reasonableness diagnosis unit of the LIDAR. In addition, a reminder unit, such as a sound reminder unit or a light reminder unit, may be installed on the vehicle, and the reminder unit is coupled to the ECU and may be triggered by the ECU. When receiving the fault information output by the point cloud reasonableness diagnosis unit, the electronic control unit triggers the reminder unit to generate an alarm for the driver.

In an embodiment of the present disclosure, by using the neural network to analyze a point cloud output by a LIDAR, a potential fault of the LIDAR can be discovered. The technical solution of the embodiments of the present disclosure can assist LIDAR technicians to quickly locate the root cause of the fault of the LIDAR. In addition, a neural network module may be integrated into the LIDAR. After purchasing the LIDAR, the user connects the LIDAR to an ECU on a vehicle. When the LIDAR is in use, the neural network module inside the LIDAR may detect a point cloud output by the LIDAR at any time, and remind the customer when the point cloud is found abnormal.

The present disclosure provides a method for diagnosis of reasonableness of a point cloud for a LIDAR, including:

receiving point cloud data of a LIDAR and a corresponding operating parameter of the LIDAR during generation of the point cloud data;

inputting the point cloud data and the operating parameter of the LIDAR into a neural network, where the neural network is configured to output a determination result indicating whether the point cloud data is reasonable at least according to the point cloud data and the operating parameter of the LIDAR; and

determining whether the point cloud data is reasonable according to an output of the neural network.

According to one aspect of the present disclosure, the method for diagnosis of reasonableness of a point cloud further includes: determining whether the LIDAR is faulty or does not operate normally according to an output of the neural network.

According to one aspect of the present disclosure, the method for diagnosis of reasonableness of a point cloud further includes: training the neural network to identify abnormal point cloud data, including:

inputting abnormal point cloud data and a corresponding operating parameter of the LIDAR during generation of the abnormal point cloud data into the neural network, to train the neural network to identify the abnormal point cloud data.

According to one aspect of the present disclosure, the method for diagnosis of reasonableness of a point cloud further includes: inputting faults corresponding to abnormal point cloud data into the neural network, to train the neural network to identify the corresponding faults.

According to one aspect of the present disclosure, the method for diagnosis of reasonableness of a point cloud further includes: sending, when determining that the LIDAR is faulty or does not operate normally, information about the fault to the electronic control unit of the vehicle on which the LIDAR is installed.

According to one aspect of the present disclosure, the fault includes one or more of an optical component fault, a mechanical structural fault, or an electrical fault.

According to one aspect of the present disclosure, the output of the neural network includes one or more of whether the point cloud is abnormal, a name or probability of a possible fault of the LIDAR.

The present disclosure also relates to a LIDAR, including:

an emitting unit, configured to emit a detection beam to outside of the LIDAR;

a receiving unit, configured to receive a reflected light beam from the outside of the LIDAR and convert the reflected light beam into an electrical signal;

a signal processing unit, coupled to the receiving unit and configured to generate point cloud data of the LIDAR according to the electrical signal; and

a point cloud reasonableness diagnosis unit, configured to execute the method for diagnosis of reasonableness of a point cloud described above, and configured to receive the point cloud data and output determination information indicating whether the point cloud data is reasonable.

According to one aspect of the present disclosure, the point cloud reasonableness diagnosis unit is further configured to output fault information of the LIDAR.

According to one aspect of the present disclosure, the signal processing unit and the point cloud reasonableness diagnosis unit are integrated together.

According to one aspect of the present disclosure, the fault information includes at least one of: whether the point cloud is abnormal, a name or probability of a possible fault of the LIDAR.

The present disclosure also relates to a vehicle including the LIDAR described above.

According to one aspect of the present disclosure, the vehicle further includes an electronic control unit, and the electronic control unit is coupled to the LIDAR and is configured to receive fault information output by the point cloud reasonableness diagnosis unit of the LIDAR.

According to one aspect of the present disclosure, the vehicle further includes a reminder unit, where the reminder unit is coupled to the electronic control unit, and the electronic control unit is configured to trigger the reminder unit, when the fault information output by the point cloud reasonableness diagnosis unit is received.

According to one aspect of the present disclosure, the electronic control unit is further configured to control the vehicle to perform a corresponding driving operation according to the fault information.

In an embodiment of the present disclosure, by using the neural network to analyze a point cloud output by a LIDAR, a potential fault of the LIDAR can be discovered. The technical solution of the embodiments of the present disclosure can assist LIDAR technicians to quickly locate the root cause of the fault of the LIDAR. In addition, a neural network module may be integrated into the LIDAR. After purchasing the LIDAR, the customer connects the LIDAR to an ECU on a vehicle. When the LIDAR is in use, the neural network module inside the LIDAR may detect a point cloud output by the LIDAR at any time, and remind the customer when the point cloud is found abnormal. In this way, the vehicle can be controlled to perform a corresponding driving operation to deal with a possible fault or anomaly, thereby improving the safety performance of the LIDAR.

Fourth Aspect: Diagnosis of Abnormality of Power Supply

This embodiment relates to the diagnosis of abnormality of power supply of the LIDAR, which may be performed by, for example, the second fault diagnostic unit, and will be described in detail below. The diagnosis of abnormality of power supply in this embodiment may be a part of the periodic fault detection or the self-diagnosis operation described above.

With the continuous improvement of vehicle safety standards and autonomous driving technologies, currently advanced driver assistance system (ADAS) is rapidly gaining popularity, and the industry also enters the stage of L3 autonomous driving (that is, conditional autonomous driving). Either for ADAS or autonomous driving, to achieve accurate perception of the 360° environment around the vehicle, the vehicle is equipped with a variety of sensors, including a millimeter-wave radar, a LIDAR, a camera, an inertial measurement unit (IMU), and a global navigation satellite system (GNSS).

The LIDAR emits laser pulses rapidly (usually up to 150,000 pulses per second), and upon reaching the obstacle, the laser signal is reflected back to the LIDAR sensor. The LIDAR accurately calculates the distance between the sensor and the obstacle by measuring a time interval from the emission to the return of the laser signal, and can also detect an accurate size of the target object. In addition, the LIDAR usually can also be used for drawing high-resolution maps.

In applications such as an advanced driver assistance system described above, the LIDAR is usually powered by the vehicle (e.g., an in-vehicle power supply). In such an in-vehicle LIDAR application, an anomaly occurs from time to time in the supply of power to the LIDAR by the vehicle as an external power supply, resulting in poor user experience. In addition, in the case of abnormal power supply, the user usually considers that the LIDAR is faulty, and is not aware of the power supply abnormality of the external power supply.

Therefore, there is a need for a solution that can determine whether the abnormal operation of the LIDAR is caused by the abnormality of the external power supply, and record information related to the abnormality of the external power supply to find out the reason why the LIDAR stops operating.

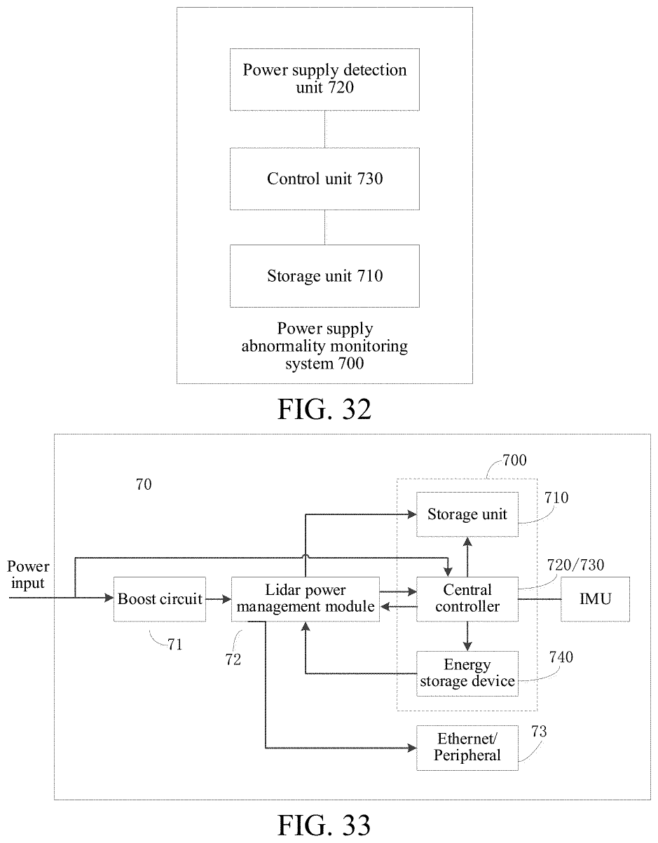

FIG. 32 illustrates a power supply abnormality monitoring system 700 for a LIDAR according to an embodiment of the present disclosure. The power supply abnormality monitoring system 700 for a LIDAR according to the embodiments of the present disclosure may be integrated with a LIDAR system, or be constructed as an independent system, which are all within the scope of the present disclosure.

As shown in FIG. 32, the power supply abnormality monitoring system 700 includes a storage unit 710, a power supply monitoring unit 720, and a control unit 730. The power supply monitoring unit 720 is coupled to a power input of the LIDAR and configured to monitor whether the power input is normal.

To be specific, the power input of the LIDAR comes from an external power supply source of the LIDAR, and can provide power for the operation of the LIDAR, communication with external devices, and other functions. Typically, the power input of the LIDAR provides a voltage of 12 V or 48 V. In some applications of the present disclosure (for example, the LIDAR is applied in a vehicle, for example, as a functional unit/module to implement an advanced driver assistance system), the power input of the LIDAR comes from an in-vehicle power supply. For example, the vehicle provides a 5 V or 12 V power input for the LIDAR. Alternatively, the LIDAR itself includes a battery to provide the power input for devices on the LIDAR. In this case, the power supply monitoring unit 720 may detect whether the power input from the battery is normal.

In the present disclosure, for the power supply monitoring unit 720 coupled to the power input of the LIDAR and configured to monitor whether the power input is normal, “monitoring whether the power input is normal” refers to monitoring/judging/determining whether a certain physical property of the power input meets (or does not meet) a predetermined requirement. In an exemplary embodiment of the present disclosure, the physical property refers to voltage, and “monitoring whether the power input is normal” refers to monitoring/judging/determining whether the voltage of the power input meets (or does not meet) the predetermined requirement. In an exemplary embodiment of the present disclosure, “monitoring whether the power input is normal” refers to monitoring whether the voltage of the power input is lower than a predetermined threshold, in which case the power supply monitoring unit 710 may be implemented as or as including a voltage comparator to monitor/judge/determine whether the voltage of the power input is lower than the predetermined threshold.

In some other embodiments, whether the power input is normal may be determined by monitoring other physical properties (e.g., current) of the power input. Particularly, in an exemplary embodiment of the present disclosure, if a certain physical property (voltage, current, etc.) of the power input is less than a predetermined threshold, it is determined that the power input is in an abnormal state (or in other words, an abnormal event of the power input is detected). In some other embodiments of the present disclosure, if a certain physical property (voltage, current, etc.) of the power input is greater than a predetermined threshold, it is determined that the monitoring power input is abnormal (or in other words, an abnormal event of the power input is detected). It should be noted that physical properties of the power input not only include voltage, current, etc., but also include derived properties that characterize these physical properties, such as voltage jitter, frequency fluctuation, and the like. For example, when a fluctuation range of the voltage or current of the power input exceeds a certain threshold, it is determined that the power input is in an abnormal state. The present disclosure encompasses monitoring of any physical property of the power input and derived properties characterizing the physical property. Accordingly, the present disclosure encompasses the arrangement of other devices/mechanisms/modules in the power supply monitoring unit 720 to monitor/compare corresponding properties.

The power supply monitoring unit 720 is coupled to the control unit 730. The control unit 730 is configured to record, when the power supply monitoring unit 720 detects an abnormal event of the power input, information related to the abnormal event in the storage unit 710.

In some embodiments, the control unit 730 is implemented as a part of a LIDAR module (e.g., FPGA). In some other embodiments, the control unit 730 is implemented as a separate unit/module. In general, the control unit 730 may be implemented as any control unit that executes a control function, e.g., a processor, a microprocessor, a controller, a microcontroller, a logic device (e.g., a programmable logic device such as an FPGA), an application-specific integrated circuit (ASIC), etc.

As mentioned above, the “abnormal event” of the power input may mean that one or more physical properties of the power input meet or do not meet a predetermined requirement. The control unit 730 is configured to record, when the power supply monitoring unit 720 detects an abnormal event of the power input, information related to the abnormal event in the storage unit 710. The information related to the abnormal event may include one or more of information indicating the occurrence of the abnormal event (for example, abnormal event flag), information indicating which type of abnormal event occurs (for example, the type of the abnormal event), an attribute of the abnormal event (for example, measured value of a physical quantity (voltage, current)), or a time (e.g., timestamp) of the occurrence of the abnormal event. The storage unit 710 may include any non-volatile memory/device (e.g., various types of memories and flash memories, etc.) that can record/store the information related to the abnormal event.

FIG. 33 illustrates a LIDAR system 70 according to an embodiment of the present disclosure, which includes the power supply abnormality monitoring system 700 (as shown by a dashed box in FIG. 33), and will be described in detail below with reference to FIG. 33.

As shown in FIG. 33, the LIDAR system 70 includes a boost circuit 71, a LIDAR power management module 72, and an FPGA. The boost circuit 71 may be connected to an external power supply, for example, connected to an in-vehicle power supply of a vehicle. The term “external” means outside of the LIDAR. After the vehicle is started, the in-vehicle power supply automatically provides a power input, such as a 5 V voltage input, to the boost circuit 71. The boost circuit 71 includes, for example, an LTO booster, which is configured to receive the power input and convert the power input into a high voltage of, for example, 60 V, required for driving the LIDAR. The LIDAR power management module 72 is coupled to the boost circuit 71 to receive the high voltage, and is configured to provide an electrical power to devices in the LIDAR system 70 that require electrical power. For example, as shown in FIG. 33, the LIDAR power management module 72 provides an electrical power to various unit components in the power supply abnormality monitoring system 700 and an Ethernet/peripheral 73 (described below).

The LIDAR system 70 may also include the Ethernet/peripheral 73, such as an Ethernet interface/peripheral interface, which is configured to send the point cloud data of the LIDAR to an external controller (not shown), or receive a control signal input from an external controller.

As shown in FIG. 33, the LIDAR system 70 includes a central controller, which is implemented by, for example, an FPGA, and the central controller integrates the power supply monitoring unit 720 and the control unit 730 in the power supply abnormality monitoring system 700. The FPGA is coupled to the storage unit 710 to write the information related to the abnormal event into the storage unit 710, and is also coupled to the power input, i.e., coupled to an input terminal of the boost circuit 71, to monitor whether the power input is normal (e.g., whether the power input is equal to 12 V or lower than 12 V, where a power input voltage of lower than 12 V indicates insufficient voltage, and a power input voltage of 0 V indicates power failure/power off). When the power supply monitoring unit 720 integrated in the FPGA detects an abnormal event (e.g., lower than 12 V) of the power input, the control unit 730 integrated in the FPGA records information related to the abnormal event into the storage unit 710. In addition, the central controller shown in FIG. 33 may also be implemented by other types of electronic devices, such as a digital signal processor (DSP) or an application-specific integrated circuit (ASIC), which are all within the protected scope of the present disclosure.

In addition, as shown in FIG. 33, the power supply abnormality monitoring system 700 may further include an energy storage device 740 (or referred to as an auxiliary power supply unit), and the energy storage device 740 is coupled to the FPGA and the LIDAR power management module 72 and can be controlled by the FPGA. The FPGA may enable the energy storage device 740 to power the LIDAR when an abnormal event of the power input is detected. For example, when the FPGA detects an abnormal event of the power input, the FPGA sends a start instruction to the energy storage device 740 to start the energy storage device 740 to provide backup power to the LIDAR power management module 72.

In some embodiments, the FPGA further controls the LIDAR power management module to stop supplying power to the Ethernet/peripheral 73 of the LIDAR system when an abnormal event of the power input is detected. That is to say, in this case, the control unit 730 further controls the LIDAR power management module (not shown) to supply power to only core modules/units of the LIDAR system to ensure basic functions, and at the same time, to stop supplying power to non-core modules/units of the LIDAR (e.g., a network communication module and/or a peripheral), when the power supply monitoring unit 720 detects an abnormal event of the power input. FIG. 33 also illustrates an inertial measurement unit (IMU) connected to the FPGA of the LIDAR system 70 to assist in implementing the functions of the advanced driver assistance system.

Those skilled in the art can understand that the schematic diagram of the power supply abnormality monitoring system 700 for a LIDAR shown in FIG. 32 and the schematic diagram of the LIDAR system shown in FIG. 33 are merely block diagrams of a partial structure related to the solution of the present disclosure and do not constitute any limitation on devices/units/modules to which the solution of the present disclosure applies. A specific system may include more or fewer devices/units/modules than those shown in the figures, or some devices/units/module may be combined, or different arrangements of units/units/modules may be adopted.

The energy storage device shown in FIG. 33 may be any type of energy storage device, such as a capacitor, a battery (e.g., a button cell), a battery pack, etc. In some other embodiments, the auxiliary power supply unit may be another external power supply source. The phrase of “Enabling the auxiliary power supply unit to power the LIDAR system” may include using the auxiliary power supply unit to power the LIDAR system while stopping the power input of the LIDAR, or using the auxiliary power supply unit as an auxiliary to power the LIDAR system without stopping the power input of the LIDAR. The auxiliary power supply unit/energy storage device may be located outside the LIDAR, for example, may be an energy storage device (e.g., a button cell) of the vehicle itself or of a driving assistance device arranged in the vehicle. For example, generally a drive recorder includes a button cell, and the button cell may be connected to the LIDAR (to replace or assist the external power supply). Alternatively, the energy storage device may be a capacitor, and a capacitor may be additionally provided as the energy storage device to provide an electrical power to the LIDAR system when the power input is abnormal.

In some embodiments of the present disclosure, the power supply abnormality monitoring system 700 for a LIDAR further includes a diagnostic unit (not shown). The diagnostic unit may be configured to provide a diagnostic report based on the information related to the abnormal event recorded in the storage unit 710. The diagnostic unit may be configured as a stand-alone unit or as part of the control unit 730. To be specific, the diagnostic unit may output the diagnostic report including the recorded information related to the abnormal event in response to a user's request, so that the user can review the diagnostic report to determine the cause of the fault.

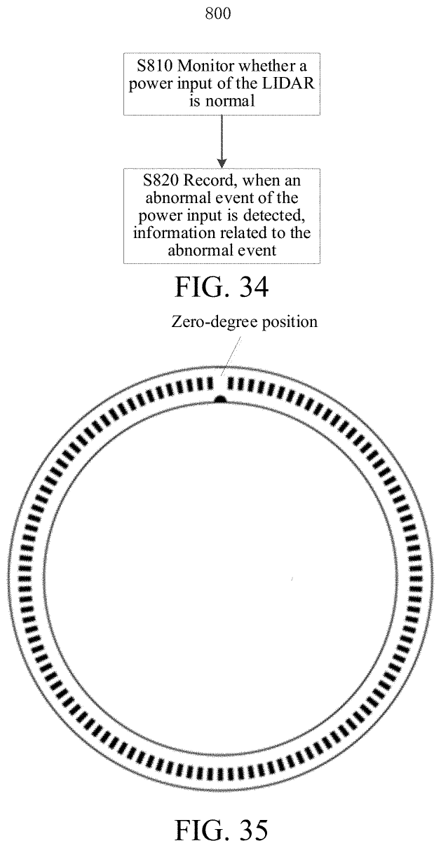

According to another aspect of the present disclosure, as shown in FIG. 34, the present disclosure also provides a power supply abnormality monitoring method 800 for a LIDAR. The power supply abnormality monitoring method 800 includes:

S810: monitoring whether a power input of the LIDAR is normal; and

S820: recording, when an abnormal event of the power input is detected, information related to the abnormal event.

The power supply abnormality monitoring method 800 may be implemented by, for example, the power supply abnormality monitoring system 700 described above. The abnormal event of the power input may include insufficient voltage of the power input or power failure. The method may further include: arranging an auxiliary power supply unit, and enabling the auxiliary power supply unit to power the LIDAR when an abnormal event of the power input is detected. The method may further include controlling the LIDAR power management module to stop supplying power to the network communication module and/or the peripheral of the LIDAR when an abnormal event of the power input is detected. The auxiliary power supply unit may be arranged inside and/or outside the LIDAR. The auxiliary power supply unit may include a battery and/or a capacitor. The method may further include: providing a diagnostic report based on the information related to the abnormal event recorded in the storage unit. The diagnosis system of the present disclosure may store and record all data related to faults or abnormal events, statistically analyzes on each piece of data (for example, continuous detection data of a same component), and adjust thresholds based on the result of the statistical analysis or predict a failure time of a component or a failure time of the system based on a change trend of test data.

Another aspect of the present disclosure also provides a computer-readable storage medium, storing a computer program, the computer program, when executed by a processor, implementing the method according to any one of the above aspects. For example, the computer program, when executed by the processor, can instruct the processor and/or a corresponding component to implement the following steps: monitoring whether a power input of the LIDAR is normal; and recording, when an abnormal event of the power input is detected, information related to the abnormal event. In addition, it should be understood that the units in the power supply abnormality monitoring system 700 for a LIDAR may be implemented entirely or partly by software, hardware, or a combination thereof. The units may be embedded in or independent of a processor in a computer device in the form of hardware, or may be stored in the memory of the computer device in the form of software, for the processor to invoke and execute operations corresponding to the units.

In one embodiment, a computer device is provided, including a memory and a processor. The memory stores a computer program executable on the processor. The processor is configured to execute the computer program to implement the steps of the method in any one of the foregoing embodiments. The computer device may be a server or an in-vehicle terminal. The computer device includes a processor, a memory, a network interface, and a database, which are connected by a system bus. The processor of the computer device is configured to provide computing and control capabilities. The memory of the computer device includes a non-volatile storage medium and an internal memory. The non-volatile storage medium stores an operating system, a computer program, and a database. The internal memory provides an environment for running of the operating system and the computer program in the non-volatile storage medium. The network interface of the computer device is configured to communicate with an external terminal through a network connection. The computer program is executed by the processor to implement the method of the present disclosure.

Those of ordinary skill in the art can understand that all or some of the steps of the methods according to the embodiments of the present disclosure may be implemented by a computer program instructing relevant hardware. The computer program may be stored in a non-volatile computer-readable storage medium. When the computer program is executed, the steps of the foregoing method embodiments are performed. Any reference to a memory, storage, database, or other medium used in the embodiments provided in the present disclosure may include non-volatile and/or volatile memories. The non-volatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache memory.

According to a first aspect, the present disclosure proposes a power supply abnormality monitoring system for a LIDAR. The power supply abnormality monitoring system includes: a storage unit; a power supply monitoring unit, coupled to a power input of the LIDAR and configured to monitor whether the power input is normal; a control unit, configured to record, when the power supply monitoring unit detects an abnormal event of the power input, information related to the abnormal event in the storage unit.

In some embodiments of the first aspect, the abnormal event of the power input includes insufficient voltage of the power input or power failure.

In some embodiments of the first aspect, the system further includes an auxiliary power supply unit, and the control unit is further configured to enable the auxiliary power supply unit to power the LIDAR when the power supply monitoring unit detects an abnormal event of the power input.

In some embodiments of the first aspect, the control unit is further configured to control the LIDAR power management module to stop supplying power to a network communication module and/or a peripheral of the LIDAR when the power supply monitoring unit detects an abnormal event of the power input.

In some embodiments of the first aspect, the auxiliary power supply unit is arranged inside and/or outside the LIDAR.

In some embodiments of the first aspect, the auxiliary power supply unit includes a battery and/or a capacitor.

In some embodiments of the first aspect, the system further includes a diagnostic unit, which is configured to provide a diagnostic report based on the information related to the abnormal event recorded in the storage unit.

According to a second aspect, the present disclosure proposes a LIDAR system including the power supply abnormality monitoring system according to the first aspect of the present disclosure.

In some embodiments of the second aspect, the power input comes from an in-vehicle power supply.

According to a third aspect, the present disclosure proposes a power supply abnormality monitoring method for a LIDAR. The power supply abnormality monitoring method includes: monitoring whether a power input of the LIDAR is normal; and recording, when an abnormal event of the power input is detected, information related to the abnormal event.

In some embodiments of the third aspect, the abnormal event of the power input includes insufficient voltage of the power input or power failure.

In some embodiments of the third aspect, the method further includes: arranging an auxiliary power supply unit, and enabling the auxiliary power supply unit to power the LIDAR when an abnormal event of the power input is detected.

In some embodiments of the third aspect, the method further includes controlling the lidar power management module to stop supplying power to a network communication module and/or a peripheral of the LIDAR when an abnormal event of the power input is detected.

In some embodiments of the third aspect, the auxiliary power supply unit is arranged inside and/or outside the LIDAR.

In some embodiments of the third aspect, the auxiliary power supply unit includes a battery and/or a capacitor.

In some embodiments of the third aspect, the method further includes: providing a diagnostic report based on the information related to the abnormal event recorded in the storage unit.

According to a fourth aspect of the present disclosure, a computer-readable storage medium is provided, storing a computer program, the computer program, when executed by a processor, implementing the method according to the third aspect of the present disclosure.

With the solution of the present disclosure, abnormal events of the power input of the LIDAR can be monitored and information related to the abnormal events can be recorded, thereby providing an objective basis for subsequent troubleshooting. In addition, according to some exemplary embodiments of the present disclosure, when an abnormal event of the power input is detected, a countermeasure is further initiated to ensure that the LIDAR operates normally (or provides basic functions). The present disclosure provides objective reference information for troubleshooting of the system, and allows for the quick determination of the source of the fault. The present disclosure also improves user experience.

Fifth Aspect: Diagnosis of an Encoder

Optoelectronic encoding devices are widely used in various angle measurement and control schemes. An optoelectronic encoding device usually includes a light source (e.g., light-emitting diode), an encoder, and a photoelectric sensor. Usually, small perforations are evenly arranged on the encoder. A light beam emitted by the light source passes through the small perforations on the encoder and irradiates the photoelectric sensor to generate an electrical pulse signal. According to the pulse signal of the photoelectric sensor, a data processing device can determine a rotational speed and a current angular orientation of the encoder. Usually a zero-degree position is arranged on the encoder, as shown in FIG. 35, serving as a reference for the angular orientation of the encoder. However, if the zero-degree position is stained or damaged by wear and cannot provide a marking function, the accuracy of angle measurement is affected.

LIDAR system is currently widely used in the field of unmanned driving, including laser emission system and detection and reception system. A laser beam emitted is reflected by a target and received by the detection system. A distance to a corresponding target point can be measured by measuring a round-trip time of the laser beam (e.g., by a time-of-flight method). After the entire target area is scanned and detected, three-dimensional imaging can finally be achieved. A mechanical LIDAR refers to a product with a motor or other rotary components, which can be rotated 360 degrees to detect surrounding objects. In order to determine the rotation angle of the LIDAR in real time, it is necessary to use an encoder for angle measurement to determine emitting and receiving directions of the laser beam. FIG. 35 illustrates an encoder, which usually has a zero-degree position, for determining the angular orientation of the encoder. However, in practice, after the zero-degree position of the encoder is stained or damaged by wear, the quality of point clouds of the LIDAR drops sharply, degrading the safety performance of the LIDAR.

With respect to the existing encoder shown in FIG. 35, the present disclosure provides an improved encoder having a first zero-degree mark and a second zero-degree mark spaced apart by a preset angle. The appearance of the first zero-degree mark is different from that of the second zero-degree mark, so that a rotation angle indicated by the second zero-degree mark can be read in place of or in addition to that indicated by the first zero-degree mark for positioning. A detailed description will be given below with reference to the accompanying drawings.

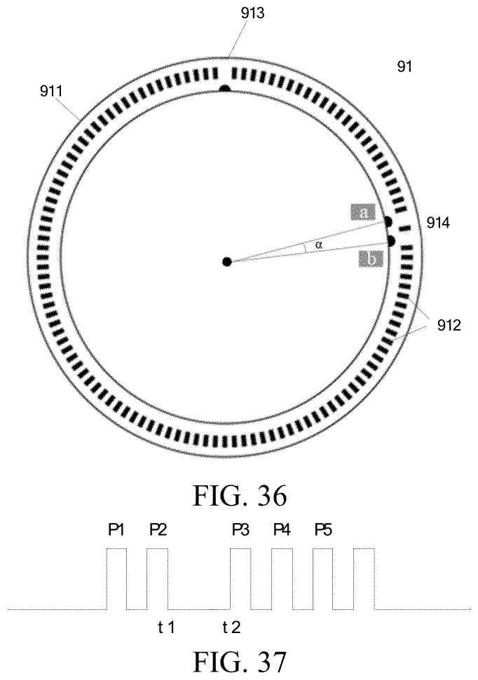

As shown in FIG. 36, the encoder 91 according to the embodiments of the present disclosure includes a disc body 911 which is substantially circular, and a plurality of coding perforations 912 evenly distributed on an edge of the disc body 911. The number, interval, and width of the coding perforations 912 may be set according to actual situations, for example, according to parameters such as a diameter of the encoder and a required measurement precision, but the protected scope of the present disclosure is not limited thereto. The disc body 911 is further provided with a first zero-degree mark 913 and a second zero-degree mark 914, which are separated by a preset angle, and the preset angle is known. The first zero-degree mark 913 is used in the angle measurement as a measurement starting point or reference point, for measuring the angles of other coding perforations and the current angular orientation of the encoder 91. The appearance of the first zero-degree mark 913 is different from that of the second zero-degree mark 914, so that when the first zero-degree mark 913 is, for example, stained or damaged by wear, the second zero-degree mark 914 can be used to obtain the position of the first zero-degree mark 913, and/or can be used directly to obtain the angular orientation of the encoder 91.

Those skilled in the art can easily understand that the coding perforations 912 may be configured to allow a light beam to pass through, while parts between adjacent coding perforations 912 do not allow a light beam to pass through. For example, the light source and the photoelectric sensor are respectively arranged on two sides of the encoder 91, and are located on a circumference where the coding perforations 912 are arranged. When light is incident on the photoelectric sensor, the photoelectric sensor generates a pulse. Therefore, when the encoder 91 rotates around its center axis, the light beam emitted by the light source is continuously blocked, transmitted, blocked, and transmitted by the encoder, thereby generating a pulse sequence on the photoelectric sensor. According to the pulse sequence, the data processing device may obtain parameters such as the rotational speed and current angular orientation of the encoder 91, which will not be repeated herein.

As shown in FIG. 36, according to an exemplary embodiment of the present disclosure, the first zero-degree mark 913 includes, for example, a wide blocking area between two coding perforations 912. In the present disclosure, the phrase of “wide blocking area” means that the width of the non-apertured area exceeds a spacing between normal coding perforations 912, and therefore this area can be used to identify the zero-degree position. In FIG. 36, the first zero-degree mark 913 is located between two coding perforations 912, and the wide blocking area of the first zero-degree mark 913 is significantly wider than the spacing area between the coding perforations 912 at other positions. Therefore, when the first zero-degree mark 913 passes the light source and the photoelectric sensor, the light beam is blocked for a significantly longer period of time, during which time a pulse cannot be generated on the photoelectric sensor. Take FIG. 37 as an example for illustration. In FIG. 37, P1, P2, P3, P4, and P5 represent pulse sequences generated by the coding perforations 912. A period of the pulse sequence is T. The period T depends on the rotational speed of the encoder 91 and the distribution density of the coding perforations 912, and may be determined in advance. When no pulse generated on the photoelectric sensor is detected in a duration from time t1 to time t2, and the length between t1 and t2 is greater than the period T, it may be determined that the first zero-degree mark 913 has been detected. At this moment, the encoder is at the zero-degree position, i.e., its initial position.

However, if a “false” pulse is generated in the duration from time t1 to time t2 because the first zero-degree mark 913 is stained or due to other reasons, the position of the first zero-degree mark 913 cannot be distinguished, and consequently the zero-degree position of the encoder 91 cannot be determined. According to the present disclosure, in this case, the zero-degree position of the encoder 91 can be determined according to the second zero-degree mark 914.

As shown in FIG. 36, the second zero-degree mark 914 includes a first point a and a second point b. There are wide blocking areas at the first point a and the second point b respectively, and the two wide blocking areas may be separated by a coding perforation 912. The wide blocking areas at the first point a and the second point b are, for example, the same as the wide blocking area of the first zero-degree mark. However, the protected scope of the present disclosure is not limited thereto, and the wide blocking areas at the first point a and the second point b may also be different from the wide blocking area of the first zero-degree mark.

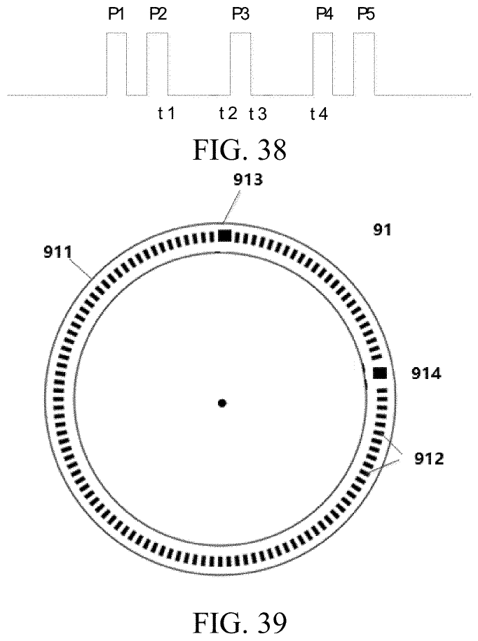

As shown in FIG. 38, during the rotation of the encoder 91, when a special pulse pattern is detected, it may be determined that the encoder 91 is currently rotated to the second zero-degree position 914. As shown in FIG. 38, P1, P2, P4, and P5 are all pulse sequences generated by the normal coding perforations 912. The pulse P3 has a significantly longer time period (t1-t2 and t3-t4) on both sides, during which no pulse generated on the photoelectric sensor is detected. Because this time period is longer than the period T, it may be determined that the current position of the encoder 91 is the second zero-degree position. Alternatively, more precisely, the position of the encoder corresponding to the pulse P3 is regarded as the second zero-degree position.

Since the first zero-degree mark 913 and the second zero-degree mark 914 are separated by a preset angle, the position of the first zero-degree mark 913 can be obtained by identifying the second zero-degree mark 914, or the second zero-degree mark 913 can be directly used for determining the angular orientation of the encoder 91. These are all within the protected scope of the present disclosure.

The first point a and the second point b shown in FIG. 36 are separated by one coding perforation 912, but the present disclosure is not limited thereto, and the first point a and the second point b may be separated by one to five coding perforations 912, which are all within the protected scope of the present disclosure. Compared with the solution of FIG. 35, in this embodiment, a second zero-degree position is further additionally provided, which specifically includes a point a and a point b, and an angle between the point a and the point b is a, which generally has a relatively small value. The point a and the point b jointly form a zero-degree position 2, which functions as another mark position.

According to an exemplary embodiment of the present disclosure, the second zero-degree mark 914 and the first zero-degree mark 913 may be separated by 90 degrees. For example, the second point b and the first zero-degree mark 913 are separated by 90 degrees, that is, a line connecting the second point b and a center of circle and a line connecting the first zero-degree mark and the center of circle form an angle of 90 degrees.

In the embodiment of FIG. 36, a wide blocking area is arranged between the coding perforations 912, so that the normal pulse sequence pattern is changed, and the first zero-degree mark and the second zero-degree mark can be identified. FIG. 39 illustrates another embodiment of the present disclosure, where the first zero-degree mark 913 includes a first zero-degree perforation, a width of the first zero-degree perforation being different from the width of the coding perforation 912; and the second zero-degree mark 914 includes a second zero-degree perforation, a width of the second zero-degree perforation being different from the width of the coding perforation 912 and different from the width of the first zero-degree perforation. Therefore, during the rotation of the encoder 91, in addition to the normal pulses generated by the coding perforations 912, two different pulses are also generated by the first zero-degree perforation and the second zero-degree perforation respectively. The widths of the pulses depend on the widths of the first and second zero-degree perforations, respectively. According to an exemplary embodiment of the present disclosure, the width of the first zero-degree perforation is greater than the width of the second zero-degree perforation, and the width of the second zero-degree perforation is greater than the width of the coding perforation 13. Therefore, when a maximum pulse width is detected during the rotation of the encoder 91, it may be determined that the encoder 91 currently has been rotated to the zero-degree position. If the first zero-degree mark cannot be identified due to some reason, the position of the first zero-degree mark 913 can be obtained and/or the angular orientation of the encoder 91 can be directly obtained by identifying the second zero-degree perforation of the second zero-degree mark 914.

In the embodiment of FIG. 39, perforations with different widths are respectively arranged at the positions of the first zero-degree mark and the second zero-degree mark. Alternatively, the first zero-degree mark 913 and the second zero-degree mark 914 may each include a wide blocking area between the two coding perforations, where a width of the wide blocking area of the second zero-degree mark is different from a width of the wide blocking area of the first zero-degree mark. Therefore, the positions of the first zero-degree mark and the second zero-degree mark may be identified according to the length of the time period in which no pulse is generated.

Under the teachings and guidance of the present disclosure, those skilled in the art can conceive of various ways to realize the first zero-degree mark and the second zero-degree mark. In the foregoing embodiments, the first zero-degree mark and the second zero-degree mark are arranged on the same circumference as the coding perforations, and those skilled in the art can also conceive of that the first zero-degree mark and the second zero-degree mark are arranged on a different circumference from the coding perforations.

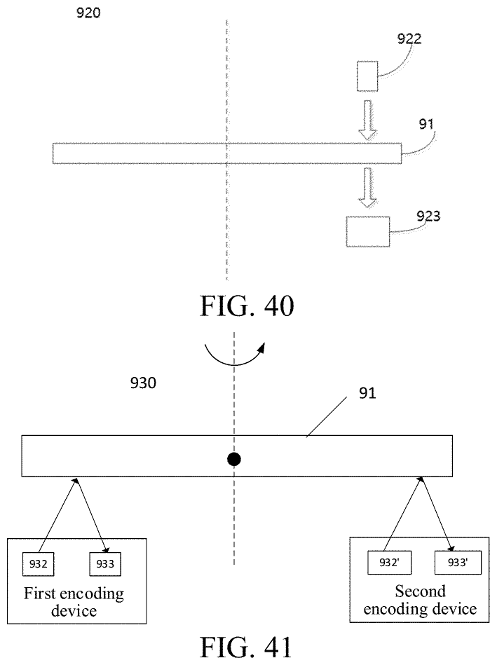

Another aspect of the present disclosure also relates to an optoelectronic encoding device, as shown in FIG. 40. A detailed description will be given below with reference to FIG. 40.

FIG. 40 illustrates a transmissive optoelectronic encoder 920. The optoelectronic encoder 920 includes an encoder 91 and an encoding device. The encoding device includes a light source 922 and an optoelectronic code reader 923, which are respectively arranged on two sides of the encoder 91 as described above. The light source 922 emits a light beam toward the encoder 91. The light beam is, for example, a light beam with high collimation and directivity. The encoder 91 rotates around the axis through the center of circle. The light source 922 is located on a circumference where the coding perforations 912 of the encoder 91 are arranged. Therefore, with the rotation of the encoder 91, the light beam emitted by the light source 922 periodically passes through the coding perforations 912 and is blocked by the areas between the coding perforations 912. The optoelectronic code reader 923 is located on a side of the encoder 91 opposite to the light source 922, and includes a photoelectric sensor, such as a photodiode or an avalanche photodiode. When the light beam from the light source 922 passes through the coding perforations 912 of the encoder 91, the light beam irradiates the photoelectric sensor of the optoelectronic code reader 923 to generate a pulse. When the light beam of the light source 922 is blocked by the encoder 91, the photoelectric sensor does not generate a pulse. In addition, the optoelectronic code reader 923 may further include, for example, a signal processing circuit configured to receive pulses from the photoelectric sensor to determine the angular orientation of the encoder 91. Those skilled in the art can easily understand that the signal processing circuit and the photoelectric sensor may be integrated together, or may be separate circuit components, which are all within the protected scope of the present disclosure.

According to an exemplary embodiment of the present disclosure, the optoelectronic code reader 923 is configured to: determine that the encoder is at the zero-degree position when the first zero-degree mark is detected; and detect the second zero-degree mark when the first zero-degree mark cannot be detected, and determine a position of the first zero-degree mark and/or determine an angular orientation of the encoder according to the preset angle between the first zero-degree mark and the second zero-degree mark.

In addition, FIG. 40 illustrates that the light source 922 and the optoelectronic code reader 923 are located on two sides of the encoder 91, respectively, but the present disclosure is not limited thereto, and those skilled in the art can also conceive of an arrangement of the light source 922 and the optoelectronic code reader 923 on the on the same side of the encoder 91. FIG. 41 illustrates a reflective optoelectronic encoder 930 according to an embodiment of the present disclosure. The optoelectronic encoder 930 includes an encoder 91, a first encoding device, and a second encoding device. The first encoding device and the second encoding device are, for example, reflective encoding devices. Taking the first encoding device as an example, the first encoding device includes a light source 932 and an optoelectronic code reader 933, which are respectively arranged on the same side of the encoder 91 as described above, for example, a lower side of the encoder 91 shown in FIG. 41. As shown in FIG. 41, when the light beam emitted by the light source 932 passes through the coding perforations 912 of the encoder 91, the optoelectronic code reader 933 cannot receive the light beam, and does not generate a pulse. When a pulse emitted by the light source 932 is reflected by the parts between the coding perforations 912, the reflected light beam can irradiate on the optoelectronic code reader 933, thereby generating a pulse. In addition to the first encoding device, the optoelectronic encoder also includes the second encoding device. The second encoding device is structurally the same as the first encoding device, for example, also includes a light source 932′ and an optoelectronic code reader 933′, but the second encoding device is arranged at a different position on the encoder. Preferably, the first encoding device and the second encoding device may be opposite to each other along the diameter of the encoder. In addition, according to an embodiment of the present disclosure, the second encoding device may also be arranged on the other side of the encoder, that is, an upper side in FIG. 35. In addition, optionally, the first encoding device and the second encoding device may be encoding devices of different types, for example, one of them is a transmissive encoding device and the other is a reflective encoding device, which are all within the protected scope of the present disclosure.

The present disclosure also relates to a LIDAR, including the optoelectronic encoder 920 or 930 described above. By the arrangement of the optoelectronic encoding device of the present disclosure in the LIDAR, it can be ensured that during the rotation of the LIDAR, even if the first zero-degree position is stained or damaged by wear and cannot be identified, the second zero-degree position can be used in place of the first zero-degree position, so as not to affect the quality of the point cloud of the LIDAR, thereby improving the safety of the LIDAR. The LIDAR may be, for example, a rotary mechanical LIDAR, the rotor of which rotates around the axis of the LIDAR. The axis through the center of circle of the encoder coincides with the axis of the LIDAR. The optoelectronic encoding device is arranged at the bottom of the LIDAR and configured to rotate along with the rotor of the LIDAR to detect the rotation angle of the LIDAR.

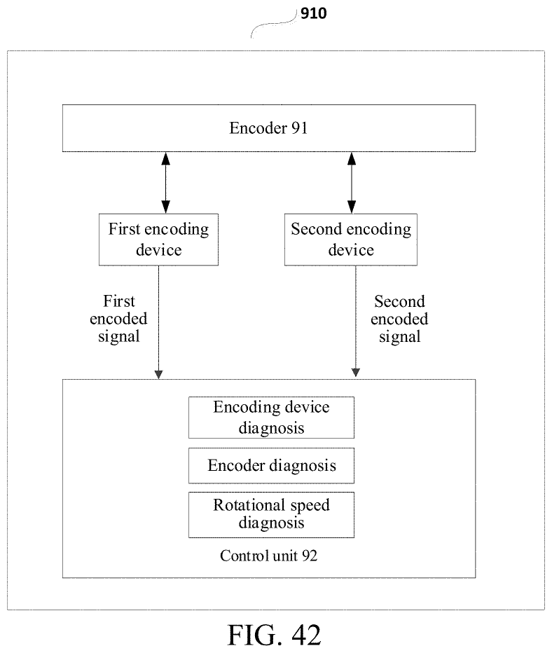

FIG. 42 illustrates a LIDAR 910 including the optoelectronic encoder 930 shown in FIG. 41, that is, including the encoder 91, the first encoding device, and the second encoding device. In addition, the LIDAR further includes a control unit 92. The control unit 92 is coupled to the first encoding device and the second encoding device, and is configured to receive a first encoded signal output by the first encoding device and a second encoded signal output by the second encoding device, and perform various diagnosis and operations based on the first encoded signal and the second encoded signal.

According to an embodiment of the present disclosure, the control unit 92 may determine whether the first encoding device and the second encoding device are faulty according to the first encoded signal and the second encoded signal, respectively. For example, when the encoder 91 including two zero-degree marks of the present disclosure is used, both the first encoded signal and the second encoded signal should include signals corresponding to the two zero-degree marks. If the control unit finds the signals corresponding to the two zero-degree marks in the first encoded signal, but does not find the signals corresponding to the two zero-degree marks in the second encoded signal, the control unit may determine that a fault occurs in the second encoding device. If the control unit finds the signals corresponding to the two zero-degree marks in the second encoded signal, but does not find the signals corresponding to the two zero-degree marks in the first encoded signal, the control unit may determine that a fault occurs in the first encoding device.

According to an embodiment of the present disclosure, the control unit 92 is configured to perform a diagnosis of the encoder. For example, as described above, the encoder 91 of the present disclosure includes two zero-degree marks. Then if the control unit does not find the signals corresponding to the two zero-degree marks or finds only the signal corresponding to one of the zero-degree marks in the first encoded signal and the second encoded signal, it means that the encoder 91 may be faulty.

According to an embodiment of the present disclosure, the control unit 92 is configured to perform a rotational speed diagnosis. The control unit 92 may calculate the rotational speed of the encoder based on the first encoded signal or the second encoded signal. The encoder usually has a preset rotational speed, and the preset rotational speed is compared with the calculated rotational speed to determine whether the encoder rotates at the preset rotational speed. When a deviation between the preset rotational speed and the calculated rotational speed is determined, or a deviation higher than a threshold is determined, an alarm is generated.

According to an embodiment of the present disclosure, the control unit 92 may perform fault detection on the encoder after diagnosing and determining that the encoding devices are free of faults, and perform the rotational speed diagnosis on the motor after determining that the encoder is free of faults.

It can be known from the embodiment shown in FIG. 42 that the LIDAR in the embodiments of the present disclosure adopts an encoder with two zero-degree positions and two encoding devices, i.e., either for the encoder or the encoding device, there is a backup for each device. In addition, by further using the control unit to perform fault detection according to the output signals of the two encoding devices and the encoder, the LIDAR in the present disclosure can provide a safe and reliable solution for angle testing and speed measurement.

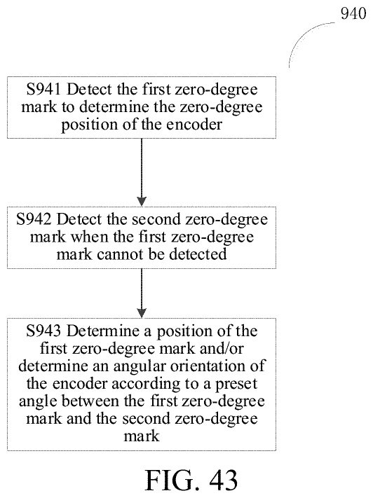

The present disclosure also relates to a method 940 for determining an angular orientation using the encoder described above. As shown in FIG. 43, the method 940 includes:

step S941: detecting the first zero-degree mark to determine the zero-degree position of the encoder;

step S942: detecting the second zero-degree mark when the first zero-degree mark cannot be detected; and

step S943: determining a position of the first zero-degree mark and/or determine an angular orientation of the encoder according to a preset angle between the first zero-degree mark and the second zero-degree mark.

Through the technical solutions of the embodiments of the present disclosure, even if a zero-degree position of the encoder is stained or damaged by wear or cannot be identified due to other reasons, the encoder can still be used to accurately measure the angle. The staining of the zero-degree position does not affect the startup operation. In the case of presence of an interference signal not caused by staining of the zero-degree positions, the signal measurement system of the rotor can continue to operate, providing strong robustness.

The present disclosure provides an encoder including a disc body which is substantially circular. A plurality of evenly distributed coding perforations are arranged on an edge of the disc body. The disc body is further provided with a first zero-degree mark and a second zero-degree mark separated by a preset angle. The appearance of the first zero-degree mark is different from that of the second zero-degree mark.

According to one aspect of the present disclosure, the first zero-degree mark and the second zero-degree mark are arranged on the same circumference as the coding perforations.

According to one aspect of the present disclosure, the first zero-degree mark includes a wide blocking area between the two coding perforations, and the second zero-degree mark 914 includes a first point and a second point. At positions on the circumference that correspond to the first point and the second point, wide blocking areas the same as that of the first zero-degree mark are respectively arranged.

According to one aspect of the present disclosure, the first point and the second point are separated by one to five coding perforations, and the second point and the first zero-degree mark are separated by 90 degrees.

According to one aspect of the present disclosure, the first zero-degree mark includes a first zero-degree perforation, a width of the first zero-degree perforation being different from the width of the coding perforation; and the second zero-degree mark includes a second zero-degree perforation, a width of the second zero-degree perforation being different from the width of the coding perforation and different from the width of the first zero-degree perforation.

According to one aspect of the present disclosure, the first zero-degree mark and the second zero-degree mark each include a wide blocking area between the two coding perforations, where a width of the wide blocking area of the second zero-degree mark is different from a width of the wide blocking area of the first zero-degree mark.

The present disclosure also provides an optoelectronic encoder, including:

the encoder described above, which is rotatable about an axis through its center of circle; and

a first encoding device, where the first encoding device includes:

a first light source, where a light beam emitted by the first light source passes through the coding perforations on the encoder, or is blocked by the parts between the coding perforations; and

a first optoelectronic code reader, configured to receive the light beam from the first light source to determine an angular orientation of the encoder.

According to one aspect of the present disclosure, the first optoelectronic code reader is configured to determine that the encoder is at the zero-degree position when the first zero-degree mark is detected; and detect the second zero-degree mark when the first zero-degree mark cannot be detected, and determine a position of the first zero-degree mark and/or determine an angular orientation of the encoder according to the preset angle between the first zero-degree mark and the second zero-degree mark.

According to one aspect of the present disclosure, the optoelectronic encoder further includes a second encoding device, and the second encoding device includes:

a second light source, where a light beam emitted by the second light source passes through the coding perforations on the encoder, or is blocked by the parts between the coding perforations; and

a second optoelectronic code reader, configured to receive the light beam from the second light source to determine an angular orientation of the encoder.

The present disclosure also provides a method for determining an angular orientation using the encoder described above, including:

detecting the first zero-degree mark to determine the zero-degree position of the encoder;

detecting the second zero-degree mark when the first zero-degree mark cannot be detected; and

determining a position of the first zero-degree mark and/or determine an angular orientation of the encoder according to a preset angle between the first zero-degree mark and the second zero-degree mark.

The present disclosure also provides a LIDAR, including the optoelectronic encoder described above. The axis through the center of circle of the encoder coincides with the axis of the LIDAR. The optoelectronic encoder is arranged at the bottom of the LIDAR and configured to rotate along with the rotor of the LIDAR to detect the rotation angle of the LIDAR.

According to one aspect of the present disclosure, the first optoelectronic code reader is configured to determine that the encoder is at the zero-degree position when the first zero-degree mark is detected; and detect the second zero-degree mark when the first zero-degree mark cannot be detected, and determine a position of the first zero-degree mark and/or determine an angular orientation of the encoder according to the preset angle between the first zero-degree mark and the second zero-degree mark.

According to one aspect of the present disclosure, the optoelectronic encoder further includes a second encoding device, and the second encoding device includes:

a second light source, where a light beam emitted by the second light source passes through the coding perforations on the encoder, or is blocked by the parts between the coding perforations; and

a second optoelectronic code reader, configured to receive the light beam from the second light source to determine an angular orientation of the encoder.

According to one aspect of the present disclosure, the LIDAR further includes a control unit. The control unit is coupled to the first encoding device and the second encoding device, and is configured to perform an encoding device diagnosis according to a first encoded signal output by the first encoding device and a second encoded signal output by the second encoding device.

According to one aspect of the present disclosure, the control unit is further configured to perform a diagnosis on the encoder after determining that the encoding devices are free of faults.

According to one aspect of the present disclosure, the control unit is further configured to perform a rotational speed diagnosis after determining that the encoder is free of faults.

Through the technical solutions of the embodiments of the present disclosure, even if a zero-degree position of the encoder is stained or damaged by wear or cannot be identified due to other reasons, the encoder can still be used to accurately measure the angle. The staining of the zero-degree position does not affect the startup operation. In the case of presence of an interference signal not caused by staining of the zero-degree positions, the signal measurement system of the rotor can continue to operate, providing strong robustness.

The overall architecture of the diagnosis system for a LIDAR, the diagnostic units according to various aspects of the present disclosure, and specific embodiments have been described above. Those skilled in the art easily understand that the foregoing aspects and the technical solutions in each embodiment all may be freely combined without inventive work, which all falls within the protected scope of the present disclosure.

Finally, it should be noted that: the foregoing descriptions are merely exemplary embodiments of the present disclosure, but are not intended to limit the present disclosure. Although the present disclosure has been described in detail with reference to the foregoing embodiments, for those of ordinary skill in the art, modifications can be made to the technical solutions described in the foregoing embodiments, or equivalent replacements can be made to some technical features in the technical solutions. Any modification, equivalent replacement, or improvement made within the spirit and principle of the present disclosure shall fall within the protected scope of the present disclosure.

What is claimed is:

1. A state detection device for a LIDAR, comprising:
a processor; and
a memory coupled to the processor and having processor-executable instructions stored thereon, which are executed by the processor and cause the processor to:
perform a fault diagnosis on a component of the LIDAR, and in response to a fault being diagnosed, output a fault diagnosis signal; and
determine a state of the LIDAR according to the fault diagnosis signal.

2. The state detection device according to claim 1, wherein the LIDAR comprises an upper circuit board and a lower circuit board, and the processor is further configured to:
perform a fault diagnosis on a component of the LIDAR installed on or connected to the upper circuit board, and in response to a fault being diagnosed, output a first fault diagnosis signal;
perform a fault diagnosis on a component of the LIDAR installed on or connected to the lower circuit board, and in response to a fault being diagnosed, output a second fault diagnosis signal; and
determine the state of the LIDAR according to the first fault diagnosis signal and the second fault diagnosis signal.

3. The state detection device according to claim 2, wherein the LIDAR comprises an emitter, a receiver, and a point cloud generator arranged on the upper circuit board, wherein the emitter is configured to emit a detection laser beam to outside of the LIDAR, the receiver is configured to receive an echo of the detection laser beam reflected on a target object and convert the echo into an electrical signal, and the point cloud generator is configured to generate point cloud data of the LIDAR based on the electrical signal; and wherein the device is coupled to the point cloud generator, and is configured to receive point cloud data corresponding to the first fault diagnosis signal.

4. The state detection device according to claim 2, wherein the LIDAR comprises a motor, a power supply, an encoding device, and a communication component arranged on the lower circuit board, and the states of the LIDAR comprise: an initialization state, a normal state, a deterioration state, and a shutdown state,
wherein, in the initialization state, the LIDAR performs a self-diagnosis operation and a motor startup operation;
wherein, in the normal state, the processor is configured to perform periodic diagnosis;
wherein, in the deterioration state, the processor is configured to perform periodic diagnosis, and at least part of data of the LIDAR is recorded; and
wherein, in the shutdown state, the LIDAR is powered off, and at least part of data of the LIDAR is recorded.

5. The state detection device according to claim 4, wherein the faults of the LIDAR comprise a pre-set first-tier fault and a pre-set second-tier fault, wherein, in response to the device detecting a first-tier fault, the processor is configured to switch the state of the LIDAR to the deterioration state; and wherein in response to the device detecting a second-tier fault, the processor is configured to switch the state of the LIDAR to the shutdown state.

6. The state detection device according to claim 5, wherein in response to the device detecting that no fault exists in the deterioration state, the processor is configured to switch the state of the LIDAR from the deterioration state to the normal state.

7. The state detection device according to claim 4, wherein the self-diagnosis operation comprises: self-diagnosis of both the power supply and a clock of the LIDAR; self-diagnosis of both the upper circuit board and the lower circuit board; self-diagnosis of internal power supply; and self-diagnosis of the emitter and the receiver;
wherein, in response to the self-diagnosis operation being successful, the motor startup operation is performed; and
wherein, in response to the self-diagnosis operation in the initialization state being successful and the motor being successfully started, the processor is configured to switch the state of the LIDAR from the initialization state to the normal state;
wherein in response to a failure of the self-diagnosis of both the power supply and the clock or a failure of the self-diagnosis of both the upper circuit board and the lower circuit board, the processor is configured to switch the state of the LIDAR from the initialization state to the shutdown state; and
wherein in response to a failure of the motor startup operation, the processor is configured to switch the state of the LIDAR from the initialization state to the shutdown state.

8. The state detection device according to claim 5, further comprising a first buffer, a second buffer, and a fault memory, wherein the processor is configured to trigger to buffer fault data to the first buffer and/or the second buffer in response to a fault being diagnosed; and
wherein the fault memory is coupled to the first buffer and the second buffer and is configured to receive the fault data.

9. The state detection device according to claim 8, wherein the processor communicates with the fault memory, and is configured to output the fault data stored in the fault memory according to an external request.

10. The state detection device according to claim 3, wherein the processor is further configured to receive the point cloud data and output determination information indicating whether the point cloud data is reasonable.

11. A LIDAR, comprising a state detection device, the state detection device comprising:
a processor; and
a memory coupled to the processor and having processor-executable instructions stored thereon, which are executed by the processor and cause the processor to:
perform a fault diagnosis on a component of the LIDAR, and in response to a fault being diagnosed, output a fault diagnosis signal; and
determine a state of the LIDAR according to the fault diagnosis signal.

12. The LIDAR according to claim 11, further comprising an upper circuit board and a lower circuit board, wherein components of the LIDAR are respectively installed on or connected to the upper circuit board and the lower circuit board, and the upper circuit board and the lower circuit board are each implemented by a field-programmable gate array (FPGA) and/or a microcontroller.

13. A state detection method for a LIDAR, wherein the method is applied to a state detection device and comprises:
performing, a fault diagnosis on a component of the LIDAR, and in response to a fault being diagnosed, outputting a fault diagnosis signal; and
determining a state of the LIDAR according to the fault diagnosis signal.

14. The state detection method according to claim 12, wherein the LIDAR comprises an upper circuit board and a lower circuit board, and wherein, the performing the fault diagnosis on the component of the LIDAR in response to the fault being diagnosed, and outputting the fault diagnosis signal comprises:
performing, a fault diagnosis on a component of the LIDAR installed on or connected to the upper circuit board, and in response to a fault being diagnosed, outputting a first fault diagnosis signal; and
performing, a fault diagnosis on a component of the LIDAR installed on or connected to the lower circuit board, and in response to a fault being diagnosed, outputting a second fault diagnosis signal; and
wherein the determining the state of the LIDAR according to the fault diagnosis signal comprises: determining the state of the LIDAR according to the first fault diagnosis signal and the second fault diagnosis signal.

15. The state detection method according to claim 14, wherein the LIDAR comprises an emitter, a receiver, and a point cloud generator arranged on the upper circuit board, wherein the emitter is configured to emit a detection laser beam to outside of the LIDAR, the receiver is configured to receive an echo of the detection laser beam reflected on a target object and convert the echo into an electrical signal, and the point cloud generator is configured to generate point cloud data of the LIDAR based on the electrical signal; and
wherein the state detection method further comprises: receiving point cloud data corresponding to the first fault diagnosis signal.

16. The state detection method according to claim 14, wherein the LIDAR comprises a motor, a power supply, an encoding device, and a communication component arranged on the lower circuit board, the states of the LIDAR comprise: an initialization state, a normal state, a deterioration state, and a shutdown state, and the state detection method comprises:
performing a self-diagnosis operation and a motor startup operation for the LIDAR in the initialization state;
performing, periodic diagnosis in the normal state;
performing, periodic diagnosis in the deterioration state, and recording at least part of data of the LIDAR; and
powering off the LIDAR in the shutdown state, and recording at least part of data of the LIDAR.

17. The state detection method according to claim 16, wherein the faults of the LIDAR comprise a first-tier fault and a second-tier fault; and wherein the state detection method further comprises:
switching the state of the LIDAR to the deterioration state in response to detecting a first-tier fault; and
switching the state of the LIDAR to the shutdown state in response to detecting a second-tier fault.

18. The state detection method according to claim 17, further comprising: switching the state of the LIDAR from the deterioration state to the normal state in response to no fault being detected in the deterioration state.

19. The state detection method according to claim 16, wherein the self-diagnosis operation comprises:
self-diagnosis of the power supply and a clock of the LIDAR;
self-diagnosis of the upper circuit board and the lower circuit board;
self-diagnosis of internal power supply; and
self-diagnosis of the emitter and the receiver;
wherein, in response to the self-diagnosis operation being successful, the motor startup operation is performed; and
wherein the state detection method further comprises:
switching the state of the LIDAR from the initialization state to the normal state in response to the self-diagnosis operation in the initialization state being successful and the motor being successfully started;
switching the state of the LIDAR from the initialization state to the shutdown state in response to a failure of the self-diagnosis of both the power supply and the clock or a failure of the self-diagnosis of both the upper circuit board and the lower circuit board; and
switching the state of the LIDAR from the initialization state to the shutdown state in response to a failure of the motor startup operation.

20. The state detection method according to claim 17, further comprising: buffering fault data to the first buffer and/or the second buffer in response to a fault being determined; and
receiving, by a fault memory of the state detection device, the fault data from the first buffer and the second buffer.

21. The state detection method according to claim 20, further comprising: outputting, fault data stored in the fault memory in response to an external request being received.

22. The state detection method according to claim 13, further comprising: determining whether the point cloud data is reasonable and outputting determination information indicating whether the point cloud data is reasonable.
